(19) United States
(12) Patent Application Publication
(10) Pub. No.: US 2018/0177665 A1
(43) Pub. Date: Jun. 28, 2018

(54) DEVICES ENABLING THE DISABLED TO STAND, WALK AND ACTIVATE ONE'S BODY

(71) Applicant: Joseph Rogozinski, Ramat Gan (IL)

(72) Inventor: Joseph Rogozinski, Ramat Gan (IL)

(21) Appl. No.: 15/759,308

(22) PCT Filed: Sep. 13, 2016
(86) PCT No.: PCT/IB2016/055446

§ 371 Date: Mar. 12, 2018

Related U.S. Application Data
(60) Provisional application No. 62/217,891, filed on Sep. 13, 2015.

(51) Int. Cl. A61H 1/02; A61H 3/04

(52) U.S. Cl. CPC A61H 1/0262; A61H 3/04; A61H 2201/5058; A61H 2201/165; A61H 2201/1642

(57) ABSTRACT

Systems intended to aid disabled, people undertaking physical fitness exercises and handicapped persons, in introducing additional movements to those customarily used in such activities, thus achieving better results.

### FIELD OF THE INVENTION

The present invention relates generally to systems intended to aid disabled, people undertaking physical fitness exercises and handicapped persons, in introducing additional movements to those customarily used in such activities, thus achieving better results.

### BACKGROUND OF THE INVENTION

### Description of the Prior Art

On patent searching, we found one confirmed patent (number U.S. Pat. No. 5,282,468), and two patent applications (number US 20140251397 and US 20130199586). The patent applications were both written by the same inventor. They relate to a single crutch, which can be electrically lengthened and shortened. This crutch is not intended to help a disabled person sit down or stand up. In addition, the crutch can't bear powers above 20 Newton, a number which is about 20 times smaller than the amount required to help a disabled person rise up or sit down. In fact, the patent applications define a linear actuator, which is aimed to shorten and lengthen a crutch.

The patent system U.S. Pat. No. 5,282,468

The U.S. Pat. No. 5,282,468 defines a crutch, when two such crutches are intended to help a disabled person sit down and stand up. An old disabled person will have to use two crutches containing 4 open loops' drivers in order to sit, stand or walk. Due to the system's disability to synchronize the right crutch with the left one, the disabled person might be dangerously tilted, especially while standing or sitting. In particular, the lack of synchronization and feedback will cause unbalanced lift between the sides, exerting an exaggerated force to one shoulder, risking its dislocation. Every mistake in manipulating the four drivers will risk dangerous and uncontrollable results. During an emergency, it will be impossible for another person to help the disabled person, because it's not clear which of the 4 drivers is activated by each “button”, and because balancing the disabled person and preventing damage requires pushing at least two “correct” buttons simultaneously.

### Our System

Our system provides safe and practical solutions for all of the problems in U.S. Pat. No. 5,282,468. The system and its operation are described elsewhere in this document. The following paragraph will focus on advantages and disadvantages of the system.

First, our system contains only two drivers, one for each crutch (instead of 4 drivers used at U.S. Pat. No. 5,282,468). This fact makes the system much simpler, easier to use and more reliable (reliability is highly important in a system of this kind).

Both of the crutches are controlled in a closed loop, simultaneously and symmetrically, by one crutch. Thanks to this fact, a disabled person using our system is not in danger of harming his shoulders or tilting to one side.

Operating the system may be very simple—the actual design should consider ergonomics and safety. For example, the controls may consist only of an on/off switch and two momentary 3-position switches. The momentary switches are accessible one for each hand, and have symmetric functions. Pressing them both up will lift, pressing both down shall descend, and any other combination shall halt the motors.

The closed loop in system will overcome many problems, such as drivers with different frictions, different drivers, unsymmetrical forces applied on the crutches, etc. This will remove the possibility of over-tilting, or of exaggerated application of shoulder forces.

During an emergency, even a person not familiar with the system will easily understand how to keep the disabled person safe, thanks to its simple buttons and operation.

### SUMMARY OF INVENTION

Background: Everything that has been submitted in the provisional, the contents and the drawings 1A up to 164B relies mainly on my knowledge in engineering as well as some knowledge about paraplegics and the different types of disabilities. During the period between submission of the provisional up until the period prior to submitting the PCT, I have worked closely with Ronen D.—a paraplegic person T4 who is paralyzed from his chest down. I also worked with experts in this field. I developed and built an electric system that helped Ronen D. going using a walker. It is described in Drawings 165-176. The cost of the existing robotic electric walking systems is approximately $100,000. The estimated cost of the system that I have developed is approximately $7,000. Due to this very low cost, the system would make it possible for a very large population of people with various disabilities to purchase it. The various disabilities are described in Drawings 33-33D, starting from the slightest disability up to people who had both their legs amputated up to their pelvis.

Ronen D. is a paraplegic T4, paralyzed from his chest down (strong arms). I worked with him on the development and building the device for over a year. I would like to add a few words (at the end of this document) regarding the way he feels about the Rogo-Way (on two wheels) for the disabled that are unable to stand/walk, and for the disabled that are presented in this document.
0.1. The first system for activating force on at least one first leg of the person during the stage of helping that leg for the purpose of walking as this first force is activated on the lower part of the first leg. This first force is activated in the direction intended for walking. The first rotation axis is the one in the pelvis area, whether it is the axis of the person himself at the pelvis or a mechanical axis connected to the person in proximity to the pelvis. When the extent of the second force is such that when the lower part of the first leg does not touch the ground, it is greater than the force required for the angular rotation of the first leg, and what is connected to it, around the first rotation axis, in the direction intended for walking for the purpose of taking at least one step. The system is such that it is impossible to have the first leg make a step due to the first force while half of the person's weight or a substantial part of his weight is transferred through the first leg to the ground. The step of the floating leg as the first leg will occur even when the person's leg is in contact with the ground and when the first force is greater than the sum of forces of the second force and the friction force of the lower part of the leg with the ground, which is the third force. When this condition of having the floating leg make a step, the stepping of the leg will take place in the direction that is close to the one of activating the first force.
0.2. When the first leg straightening or close to straightening, from the area that is close to the pelvis up to the edge of the leg that is close to the ground, it helps the first leg to be able to bear the person's weight.
0.3. The leg straightening makes it possible to walk under the following conditions as well: a dragging weak leg, a leg that all of its muscles or some of them cannot be activated, a “leg” that all of it or part of it is missing up to the pelvis, or two legs are missing, and are replaced by an artificial leg, a “wooden leg” or similar in the quantity of one or two, depending on the case.
0.4. For a person that at least one of his legs needs assistance in walking. In the transfer of the person's weight from one leg to the other, and when the condition of—the stepping of the floating leg—on the leg requiring the assistance, the stepping will be made possible.
0.5. For a person whose both legs require assistance in walking in the transfer of the person's weight from one leg to the other, and when the position of the stepping of the floating foot in the transfer from one leg to the other, the stepping will be achieved.
0.6. Regarding a person with both legs amputated up to his pelvis will walk.
0.7. The transfer of weight from one leg to the other is assisted by the force activated by the hands on the auxiliary device for walking.
0.8. The force is activated by an element exerting force on the ground, wheel, chain etc for walking.
0.9. The force for walking is activated by an element that exerts direct force on the bottom of the leg or in proximity to it, such as a rigid or flexible cable in the direction of exerting the force on the bottom of the leg.
0.10. The force for walking is exerted according to the logic and control that had been determined, with or without assisting sensors.
0.11. The force for walking is exerted according to the logic and control that had been determined, with assisting sensors.
0.12. When there is no stepping, there is no consumption of electrical power for initiating the walking.
0.13. The electrical moving system can be electrical, hydraulic or pneumatic, or a partial combination of them.
0.14. The propulsion (moving) system is available as a modular option, and the moving module can be connected to a system that will help the disabled person walk, as a module rather than an integral part of the system that helps the disabled person the batteries are in the same device as an option.
0.15. The system includes a component for the potential energy accumulation (a spring or otherwise) that is “recharged” by the disabled person (especially his arms), and is later on utilized as generating the power for walking.
0.16. The disabled person's arms invest the potential energy when helped by a walker, crutches or the like, serving as the base for the element from which the force is exerted.
0.17. The addition to the existing systems creates, jointly with these systems, comfortable walking for the disabled person.
0.18. The coordination of both legs during walking can be independently achieved by the devices or as an option—in coordination of the devices with the help of an electrical cable or wireless communication of any known type.
0.19. Person's activity for walking, in the identification of logic with the help of sensors the conditions of “the stepping of the floating leg”, stepping will be achieved with the help of the control and drive.
0.20. The disabled person's activity intended for walking, in the exertion of at least some of the power on his arms, with the help of his arms and with the help of a walker or another assistive device, and when the condition of “stepping of the floating leg” will be achieved.
0.21. A wheel or a “tank chain” or similar, with a spring system makes contact with the ground as well as when the leg is lifted off the ground.
0.22. The wheel or a “tank chain” with a spring system causes the activation of force from the ground on the edge of the leg in the direction of walking.
0.23. The “tank chain” with a spring system causes the activation of power from the ground to the lower edge of the leg.
0.24. The spring system exerts force on the edge of the leg—force that is significantly lower than half the weight of the person, and when the person is with some of his weight on that leg, the spring on the lower edge of the leg surrenders and contact is established with the ground.
0.25. The disabled person can use a walker, as part of the exertion of force for the purpose of stepping.
0.26. The disabled person uses crutch/crutches as part of the exertion of forces for the purpose of stepping.
0.27. The disabled person can use one of the options of a walker, crutch/crutches or another person for the purpose of balancing himself.
0.28. The disabled person can use the options of a walker or crutch/crutches as assisting in the generation and activation of at least part of the first force.
0.29. The disabled person can use charging systems that make it possible to continue walking even when the batteries are completely depleted. This ability is mainly due to the low consumption of the system during walking.
0.30. The disabled person can use a charging system which is electro-mechanical, and in which the person activates a rotational handle for the purpose of recharging.screw
0.31. During standing or lying down, the electrical consumption of the system is negligible, almost zero, and there is an option to have it neutralized.
0.32. The RGO system according to drawings 119-124 provides support for the back in the forward and backward motion and it can enter additional motions that had been determined in advance.
0.33. RGO system according to Drawings 119-124 that does not require adjustment between a close axis to the pelvis and leg. The system will operate without an adjustment for major differences in the person's height of 20 cm and greater.

As an option, after measuring the distance in standing and seating position the distance between the close axis to the pelvis and leg is fixed to prevent changing of the distance.
0.34. The RGO system according to Drawings 125-138 is detachable and enables the disabled person make the transition from lying down to standing up without requiring the help of others.

The RGO system according to Drawings 125-138 is detachable and it makes it easier for the disabled person to move from the position of lying down to standing up, even when he is with friends so that the only assistance he would need is to be seated. Later on, assistance to stand up will enable the disabled person reach his bed, and once he gets there—get into the position of lying down, as the reverse process of the one mentioned earlier.

When the disabled person is sitting down, it is possible to pull apart all of the RGO system parts at his own choice. This way, people that do not know him and are unaware of his disability would be unable to notice that he is disabled, since his body above the pelvis would seem normal.
0.101. A mechanical walker with drives that assist in walking through the activation of force on legs
0.201. A walker in which the two upper handles are two-axes drive systems—up-down Z and forward-backward Y. The systems are electrically activated with help of control drives and the customary motion-dictation enable extremely handicapped to walk
0.301. A walker suitable for the disabled and the quadriplegics in walking.
0.401. A crutch/crutches which are a single physical unit. The upper part is activated by both arms leaning and activation, and on the lower part, there are two contact endings with the ground. Due to the nature of the system, during regular activity, one ending always touches the ground.
0.501. A short telescopic auxiliary device that is not a crutch, and the end of which is under the armpit and its other end is at a location that is substantially high above the ground, and when it goes through elongation and shortening positions, it helps the disabled person stand up and sit.
0.601. Crutches that are stopped skidding when one or both start skidding.
0.701. System that are mainly intended for sitting—for the integrated motion of the foot rotationally and the motion of the leg part around the knee rotational axis. This integrated motion generates the activation of the leg, providing better results than the single motions (to muscles/joints).
0.901. A system intended to help the disabled with a system including algorithms. The algorithms that will be carried out will be the ones that will lead to the optimization of dictating the continuation of future practice

### BRIEF DESCRIPTION OF THE DRAWINGS

FIG. 1A presents schematic descriptions of the disabled person tilting his body such that his COG is just above his “leg bottom”.

FIGS. 1B to 1D are schematic descriptions of a disabled person loading his left leg as a “weight supporting leg”. The right leg is “free” and performs a whole walking motion.

FIG. 1E presents schematic side view descriptions of the arch movement of the disabled person's right leg heel.

FIGS. 2A to 2C present schematic descriptions of a disabled person standing on his left leg, which functions as a “weight supporting leg”.

FIG. 3A presents schematic side view descriptions of a disabled person standing on his both legs,

FIG. 3B presents schematic back view of the disabled person

FIG. 4A presents schematic side view of the disabled person

FIG. 4B presents schematic back view descriptions of the disabled man standing on his left leg.

FIGS. 5A and 5B present schematic descriptions of a disabled person walking forward.

FIGS. 6A and 6B present schematic descriptions of a disabled person which had stabilized on both his legs.

FIGS. 7A and 7B present schematic descriptions of a disabled person beginning to walk when his right leg functions as a “weight support leg”.

FIGS. 8A and 8B present schematic descriptions of a disabled person in an additional walking state.

FIGS. 9A and 9B present schematic descriptions of a disabled person in an additional walking stage.

FIGS. 10A and 10B present schematic descriptions of a disabled person in a terminal walking stage.

FIG. 11A presents schematic descriptions of a foot drive mechanism.

FIG. 11B presents schematic descriptions of a foot drive mechanism.

FIG. 12A presents schematic descriptions of an internal foot drive mechanism

FIG. 12B presents schematic descriptions of an internal foot drive mechanism when the driving wheel is located at the medial part of the leg, connected to the leg's bottom, and practically lies between the legs. In this example, the “leg bottom” of the “′free leg” is above the ground and the drive wheel is touching the ground thanks to the spring system. The drive wheel rotates.

FIG. 13 presents schematic descriptions of a foot drive mechanism

FIG. 14 presents schematic descriptions of a foot drive mechanism

FIG. 15 presents schematic descriptions of an internal foot drive mechanism.

FIG. 16 presents schematic descriptions of an internal foot drive mechanism.

FIG. 17 presents schematic exploded view of a foot drive mechanism

FIG. 18 is a schematic of an isometric view of the cable drum's revolutions limiting mechanism

FIGS. 19 to 22 present schematic descriptions of the traces created by a disabled person using a walker. The walking process begins and ends with the disabled person's legs standing near to each other.

FIG. 23 presents schematic descriptions of the traces created by a disabled person using a walker. As the walking process begins, the disabled person's left leg functions as a “weight support leg” (labeled in the footprint by crossed lines), while his right leg functions as a “free leg” (labeled in the footprint as an empty area) and is outstretched forward.

FIG. 24 presents schematic descriptions of the traces created by a disabled person using a walker.”.

FIG. 25 presents schematic descriptions of the disabled person's right leg traces, during a dynamic stage of his walking process with a walker.

FIG. 26 presents schematic descriptions the traces created by a disabled person using a walker.

FIG. 27 is a schematic isometric front view of a disabled person with a walker.

FIG. 28 presents schematic isometric front view of a disabled person with a walker.

FIG. 29 presents schematic isometric front view of a disabled person using two stilts.

FIG. 30A is schematic side view of the component in charge of the stilt's elongation

FIG. 30B is schematic partial top view of the telescopic mechanism driving system.

FIG. 30C is schematic partial Top view of the driving system of the telescopic mechanism.

FIG. 30D presents schematic isometric front view of a disabled person using two stilts,

FIG. 31A is schematic side view of a disabled person standing and sitting on a standard chair,

FIG. 31B is schematic top view of the situation described in figure

FIG. 31C is schematic side view of a disabled person sitting on a standard chair and bending forward,

FIG. 31D is schematic side view of a chair and a disabled person who had reached to standing position.

FIG. 32A is schematic side view of a disabled person sitting on a lavatory seat

FIG. 32B is schematic top Section view of the situation presented in FIG. 32A.

FIG. 32C is schematic side view of a disabled person sitting on a lavatory seat

FIG. 32D is schematic side view of a disabled person who had reached to standing position

FIGS. 33 to 36 is schematic side view of the person walking ability will by the help of a foot drive mechanisms or force by cable or others mentioned in this document.

FIG. 33 is schematic side view of a disabled person which cannot walk, but has an ability to stand.

FIG. 34 is schematic side view of a disabled person whose legs are paralyzed (typical for poliomyelitis).

FIG. 35A is schematic side view of a disabled or paraplegic person. The disabled person will be able to walk, stand up or sit down.

FIG. 35B is schematic side view of a disabled or Quadriplegic person.

FIG. 35C is schematic side view of a disabled person.

FIG. 35D is schematic side view of a disabled person

FIG. 36 is schematic Isometric view of an auxiliary device which fixates the leg in a straightened position for walking or standing,

FIG. 37A is schematic back view of a disabled person whose legs are amputated to his pelvis.

FIG. 37B is schematic back view of a disabled person whose legs are amputated to his pelvis, with a adapter attached to the bottom part of his body.

FIG. 37C is schematic back view of a disabled person whose legs are amputated to his pelvis, with a adapter attached to the bottom part of his body.

FIG. 37D is schematic side view of a disabled person whose legs are amputated to his pelvis, with a adapter attached to the bottom part of his body.

FIGS. 37E to 37H is understood from FIGS. 37A to 37D

FIG. 38A is schematic front view of a telescopic “double handled stilt”

FIG. 38B is schematic side view of the telescopic “double handled stilt”

FIGS. 39A to 39D are schematic descriptions of the traces of a disabled person using a walker of FIG. 38A.

FIG. 40A presents schematic descriptions of the traces created by a disabled person using a “double handled stilt”

FIG. 40B presents schematic descriptions of the traces created by a disabled person using a “double handled stilt”

FIG. 40C presents schematic descriptions of the disabled persons, during a dynamic stage of his walking process with a “double handled stilt”

FIG. 40D presents schematic descriptions the traces created by a disabled person using a “double handled stilt” with a clockwise (CW) advanced rotary motion.

FIG. 41 is schematic Isometric view of a disabled person with a telescopic walker

FIG. 42 presents schematic isometric front view of a disabled person with none telescopic walker

FIG. 43A presents schematic side view for a disabled person using the telescopic walker.

FIG. 43B presents schematic front view for a disabled person using the telescopic walker

FIG. 44 is schematic side view of a disabled person who stands in front of the lavatory seat

FIG. 45 is schematic top view of the situation presented in FIG. 44.

FIG. 46 is schematic top view of a disabled person's traces at the beginning of his sitting process

FIG. 47 is schematic top view of a disabled person's traces while the person stands,

FIG. 48 is schematic top view of a disabled person's traces while the person stands,

FIG. 49 is schematic top view of a disabled person's traces while both his legs function as “weight support legs”.

FIGS. 50 to 55 present schematic descriptions of an auxiliary system for disabled people of varying disability levels, which assist them to stand up and sit down

FIG. 50 presents schematic side view descriptions of a disabled man standing on his legs

FIG. 51 presents schematic side view descriptions of a disabled man standing on his legs, his back turns to the lavatory seat.

FIG. 52 is schematic top view of the situation described in FIG. 45.

FIG. 53 is schematic top view of a disabled person's traces, when the person stands, his right leg functions as a “weight support leg”

FIG. 54 is schematic top view of a disabled person's traces while the person stands and his right leg

FIG. 55 is schematic top view of a disabled person's traces while the person stands and both of his legs function as “weight support legs”.

FIG. 56A is schematic side view of a disabled person standing and sitting on a wheel chair.

FIG. 56B is schematic top view of the situation described in FIG. 56A.

FIG. 56C is a schematic side view of a disabled person sitting on a wheel chair

FIG. 56D is schematic side view of a wheel chair and a disabled person,

FIG. 57A presents schematic side view of a disabled person using high crutches.

FIG. 57B presents schematic side view of a disabled person using high crutches.

FIGS. 58 and 59 present schematic isometric front view of a care taking walker for kids.

FIGS. 60A to 64 are schematic side view descriptions of a system aimed to practice a disabled person's walking with a walker.

FIG. 60A presents schematic side view descriptions of a chair whose bottom part is attached with an arm containing a strongly stressed spring.

FIG. 60B presents schematic side view descriptions of a walker joined with rods

FIGS. 61A and 62B presents schematic side view descriptions of a disabled person sitting on the chair after a “fall” or a volitional sitting.

FIGS. 62A and 62B present schematic side view descriptions of a disabled person standing, causing the chair to rise up

FIG. 63 presents schematic top view descriptions of the system. The figure presents the trails of a disabled person entering the walker.

FIG. 64 presents schematic top view descriptions of the walker system, FIGS. 65A to 67B presents schematic side view of a disabled person transiting from sitting position to standing position. When the person arrives to standing position, he needs to “lock” his leg/legs straight, using an electric or a mechanic lock.

FIG. 65B presents schematic side view descriptions of the mechanism when the disabled person is in sitting position. Locker slot

FIG. 66 presents schematic side view descriptions of the mechanism when the disabled person is transiting from sitting position to standing position.

FIG. 67A presents schematic side view descriptions of a disabled person in standing position.

FIG. 67B presents schematic side view descriptions of a disabled person in standing position.

FIG. 67C presents schematic side view descriptions of a disabled person in standing position. The lock had reached to its destined position and is sliding into the locking slot 18/67C and a full lock results. The width of slot 18/67C is more than slit 10/67B. This enable rotation relative of the two parts of the knee in direction 19/67C. This relative motion prevents “sticking” of the knee when walking or other motion of the disable.

FIGS. 68A to 70 are schematic side view descriptions of a disabled person using a crutch/two crutches preventing him from skidding.

FIG. 69 presents schematic side view descriptions of a disabled person on ice after the system with ST. ICE as per detail of FIG. 70 had stopped his skidding and prevented him from falling.

FIG. 70 presents' schematic enlarged side view descriptions of the system described in FIG. 69. It is seen that the angle between the back support component and the ground is almost two times smaller than the angle between the frontal support component and the ground. A physical analysis validates the sufficiency of this to stop the skidding. Some experiments exhibited that disabled people get quickly familiar to the back support, especially for safe ice walk.

FIGS. 71 to 73 are schematic descriptions of a disabled person transiting form sitting position to standing position, using a lavatory seat adapted to disabled people. The figures present the advantages of this lavatory seat.

FIG. 71 presents schematic side view descriptions of a disabled person rising up to standing position from an lavatory seat adapted to disabled people.

FIG. 72 presents schematic side view descriptions of the disabled person's ability to move backwards,

FIG. 73 presents schematic top view descriptions of a lavatory seat adapted to disabled people.

FIGS. 74 to 76 are schematic descriptions of a disabled person transiting from sitting position to standing position with the help of crutches

FIGS. 77 to 84 are schematic descriptions of a disabled person using a banister for each hand.

In FIG. 83, show one actuator drives the ascending or the descending

FIGS. 85 to 87B are schematic side view descriptions of a disabled person moving from a sitting position in a wheelchair to a standing position,

FIGS. 86A to 86B Present the automatic locking causing the lock to reach the locking slot

FIG. 86A Presents one of the options for disconnecting the lock,

FIGS. 88 to 93 Are schematic view descriptions, comparing a regular seat to the innovative seat,

FIGS. 90 and 91 Are schematic side view and top view descriptions presenting (in the example) the disabled person's ability to move backwards

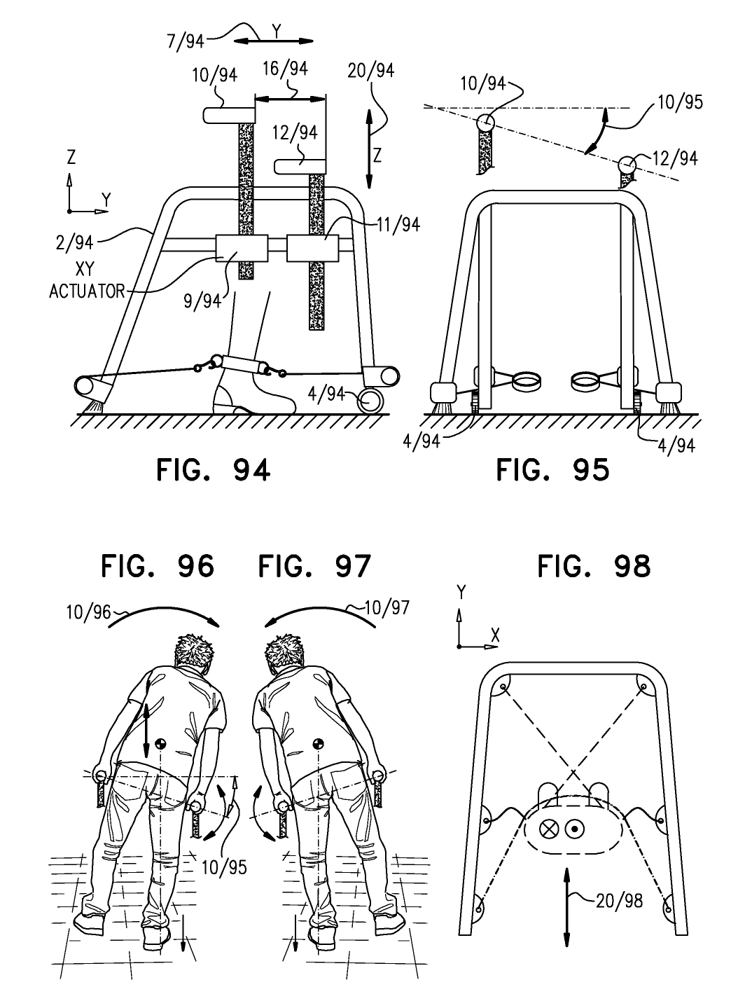

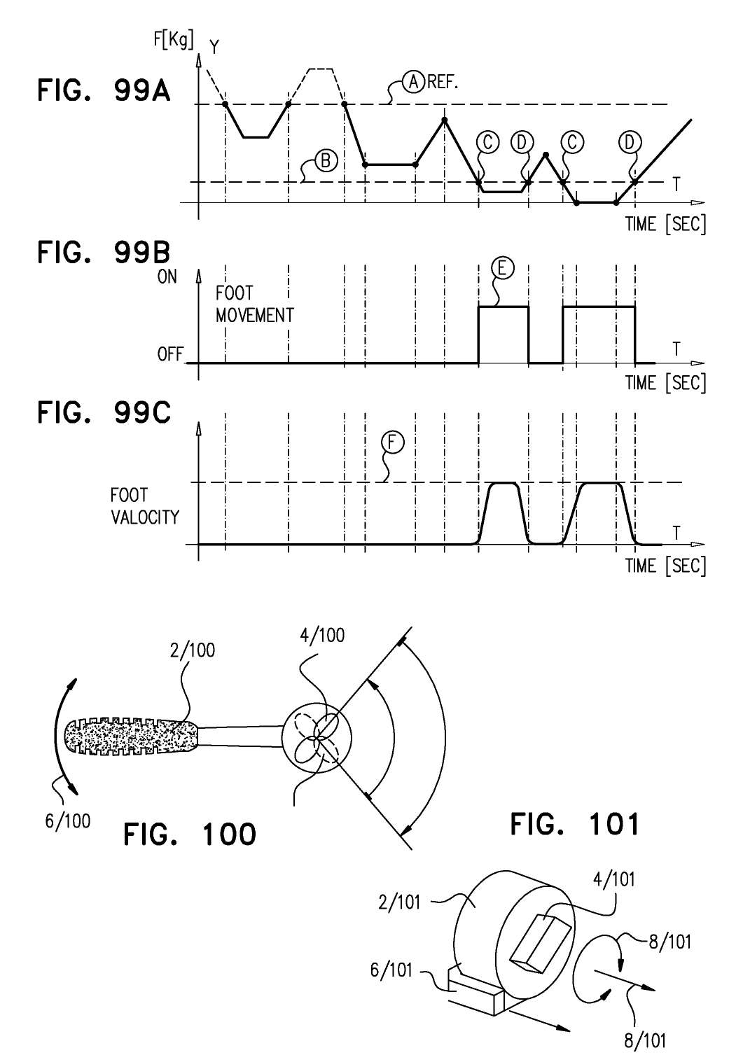

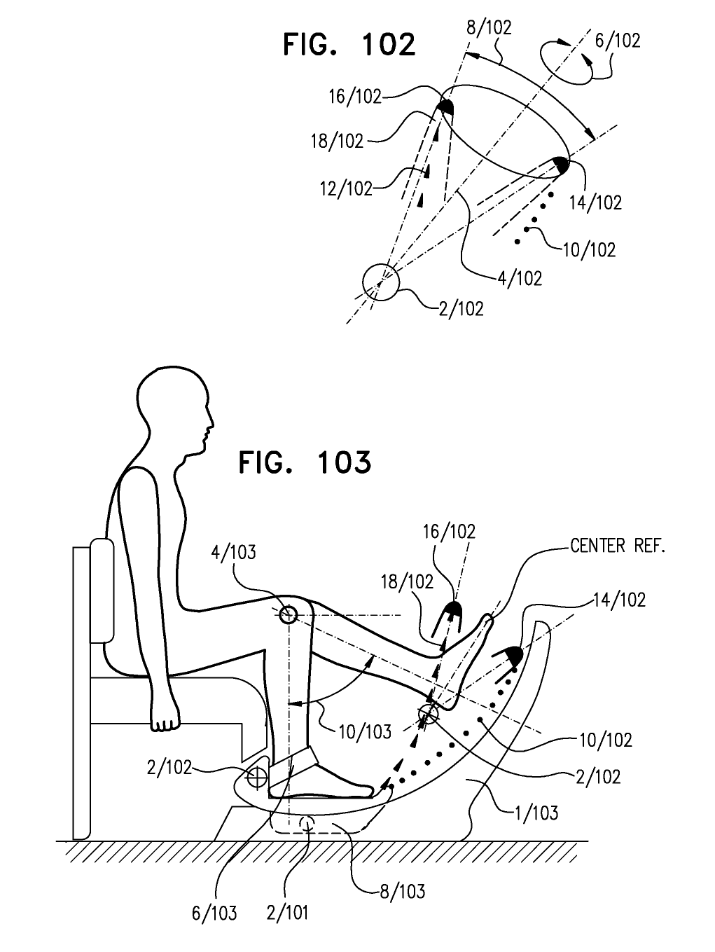

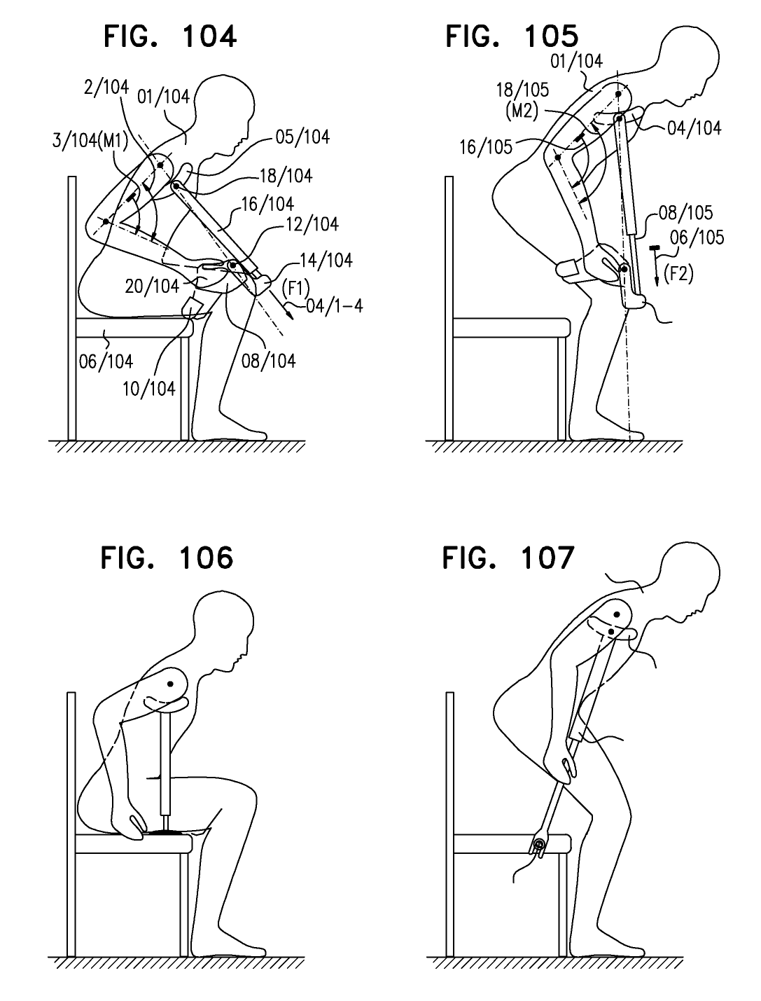

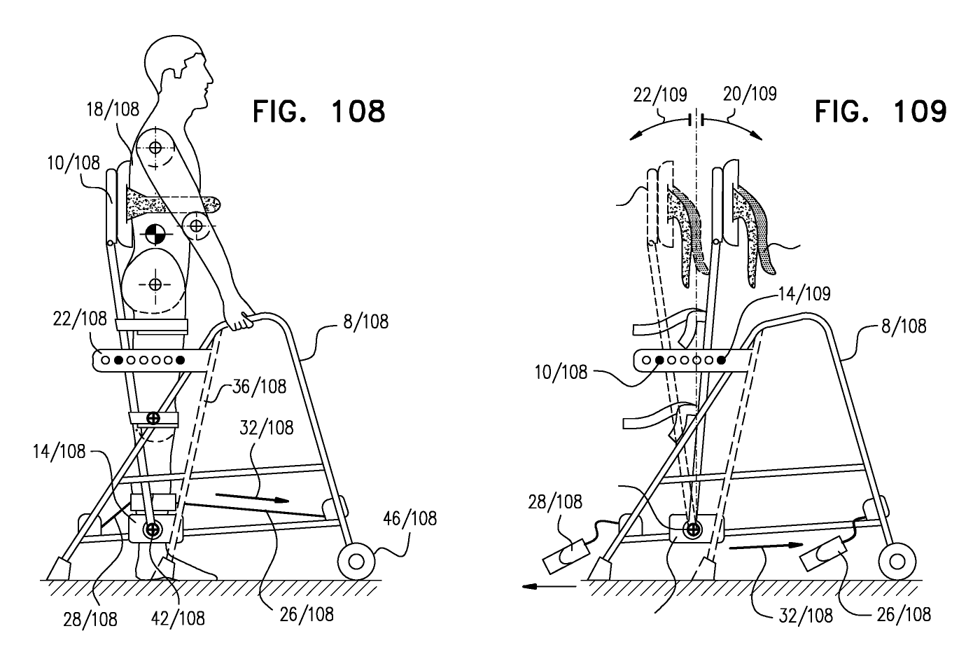

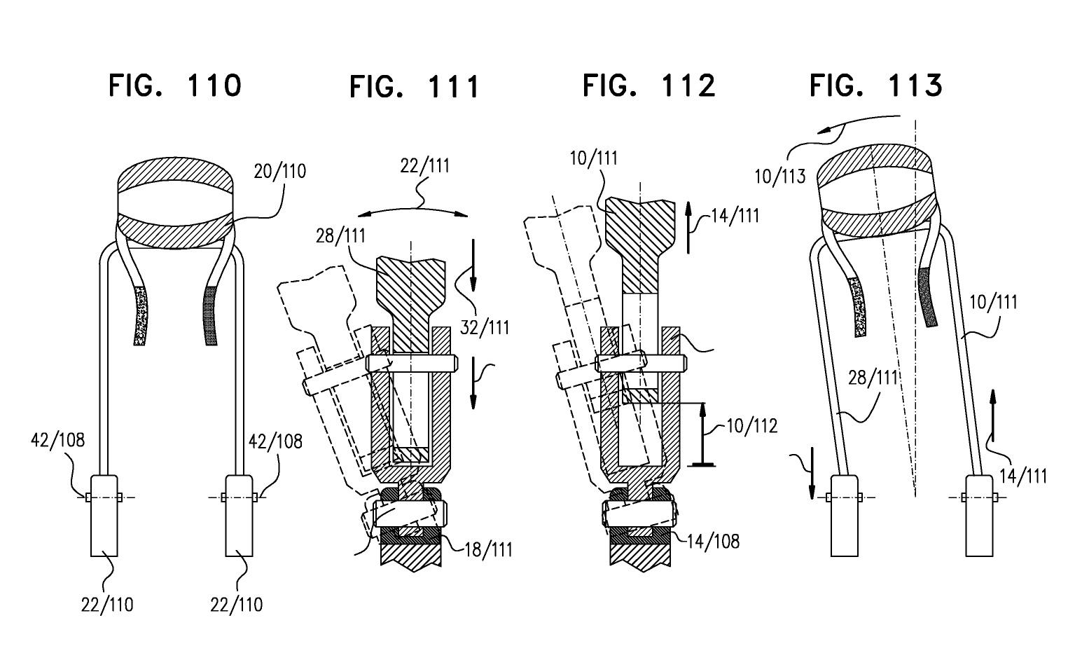

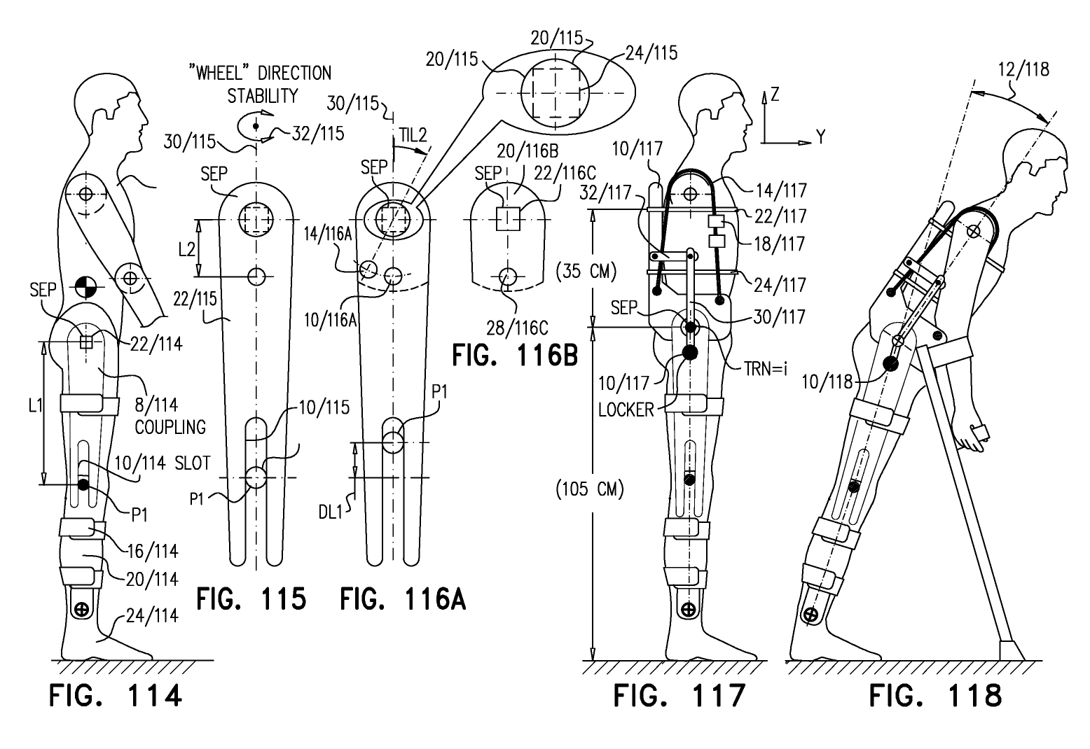

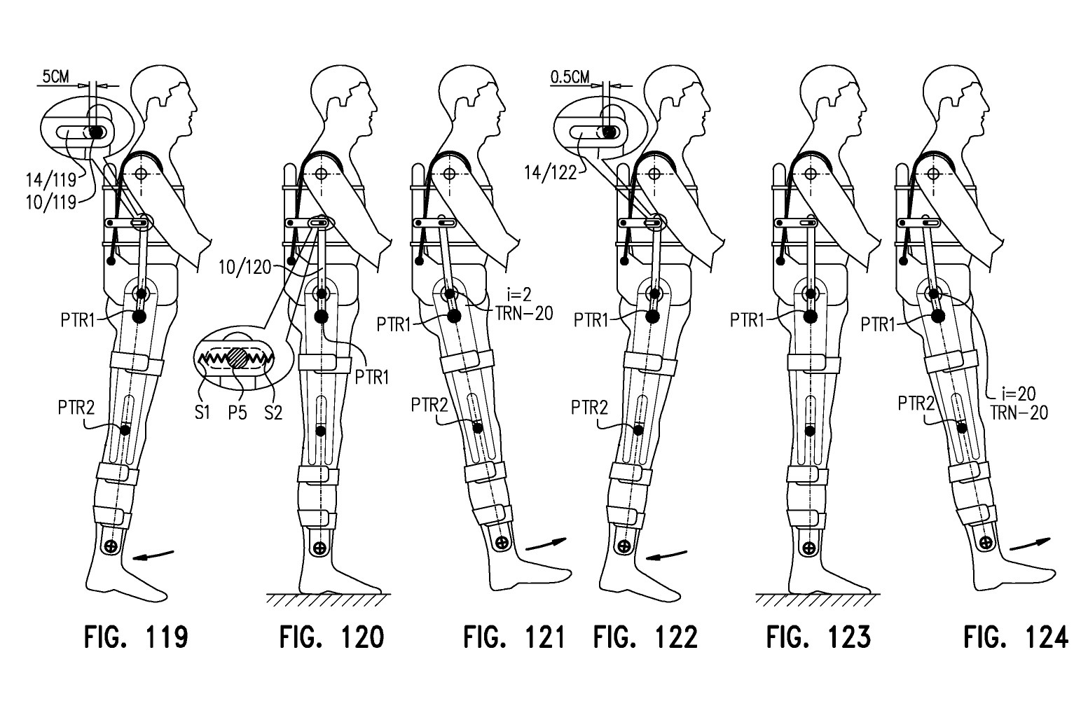

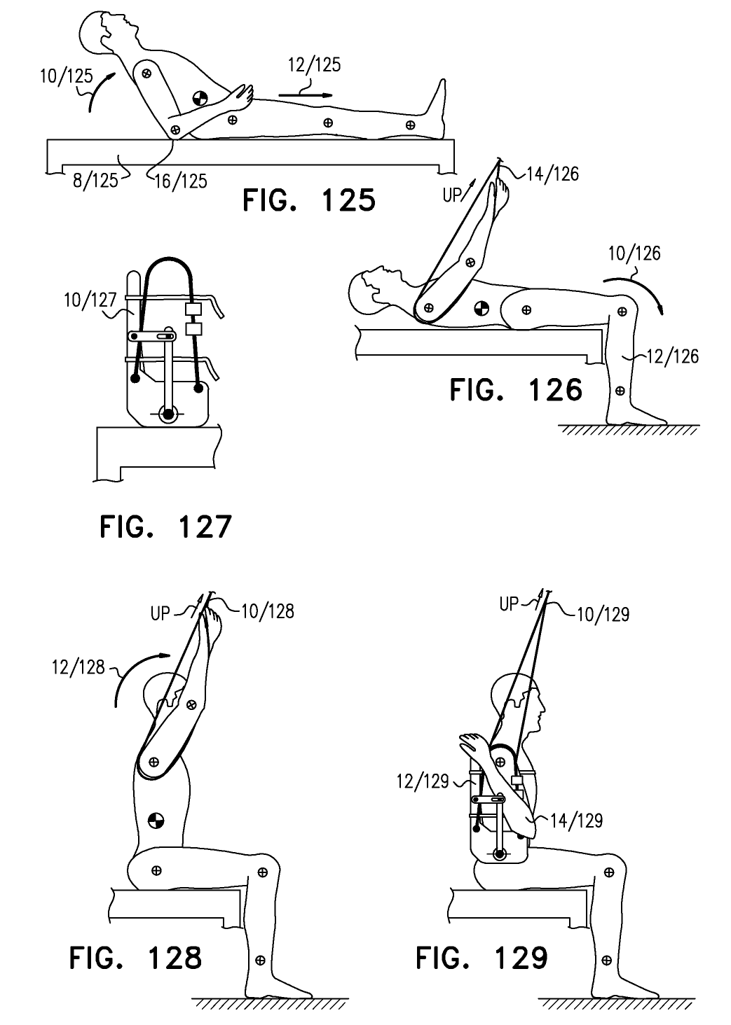

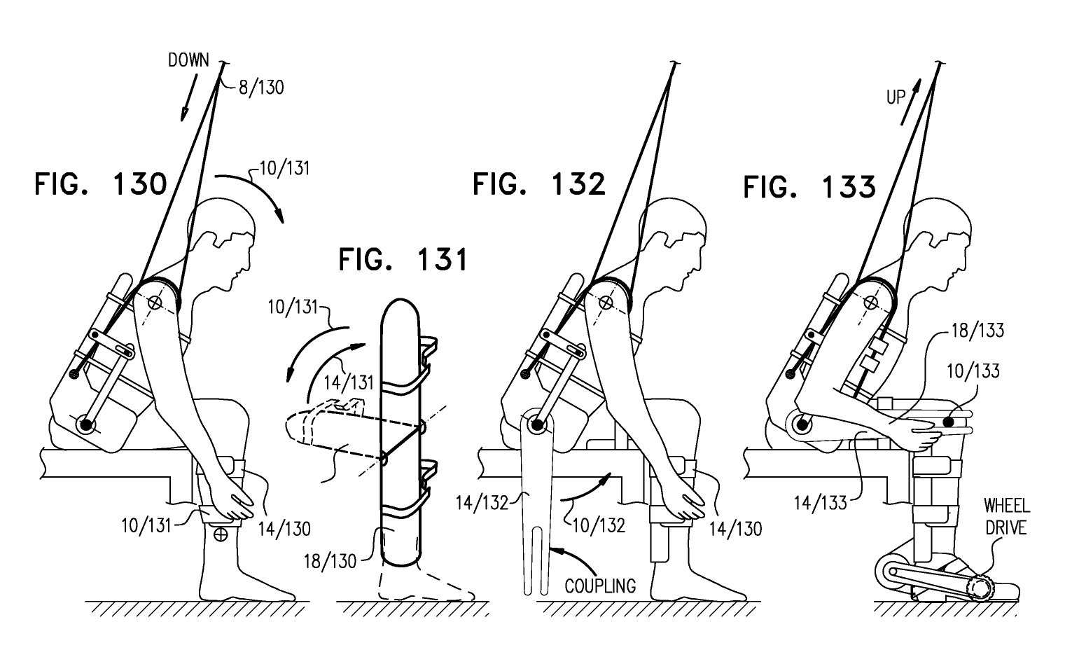

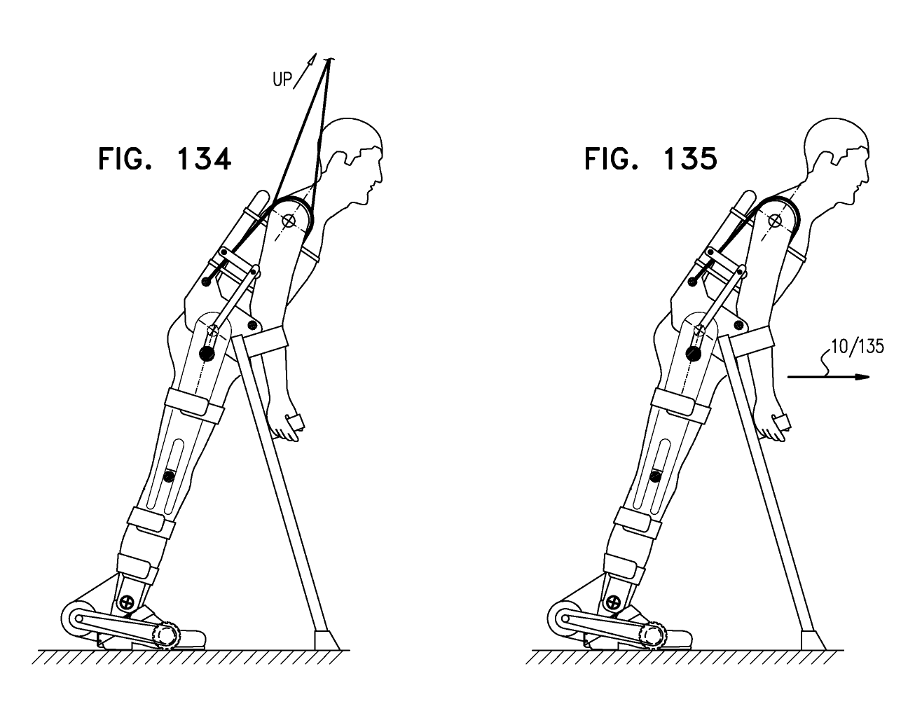

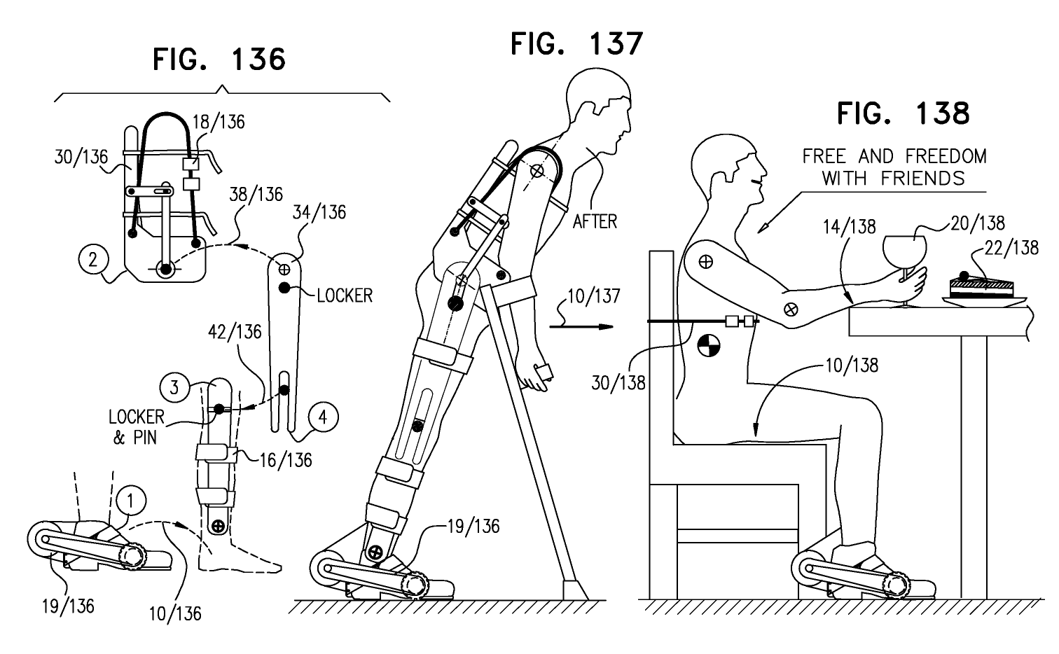

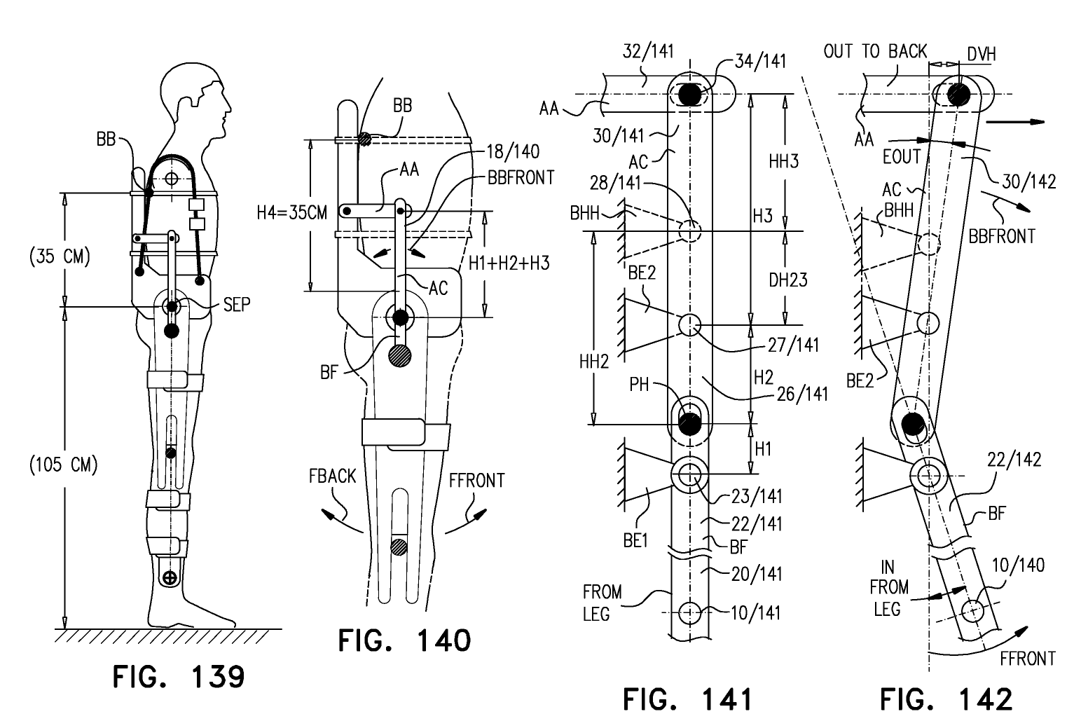

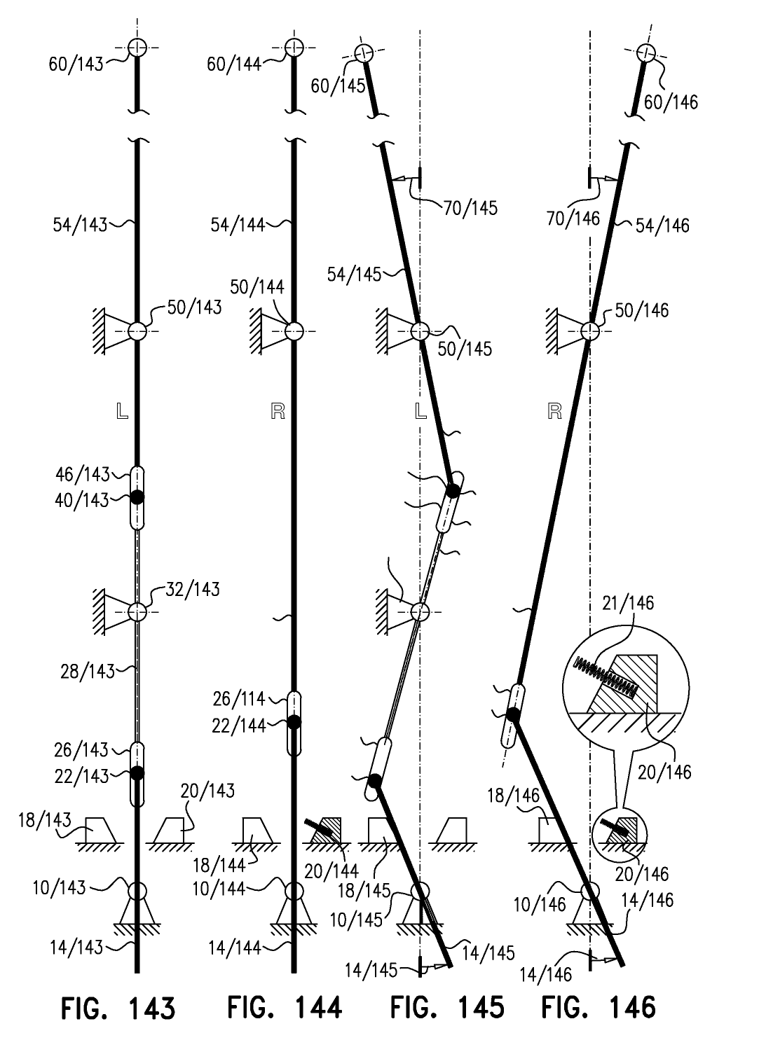

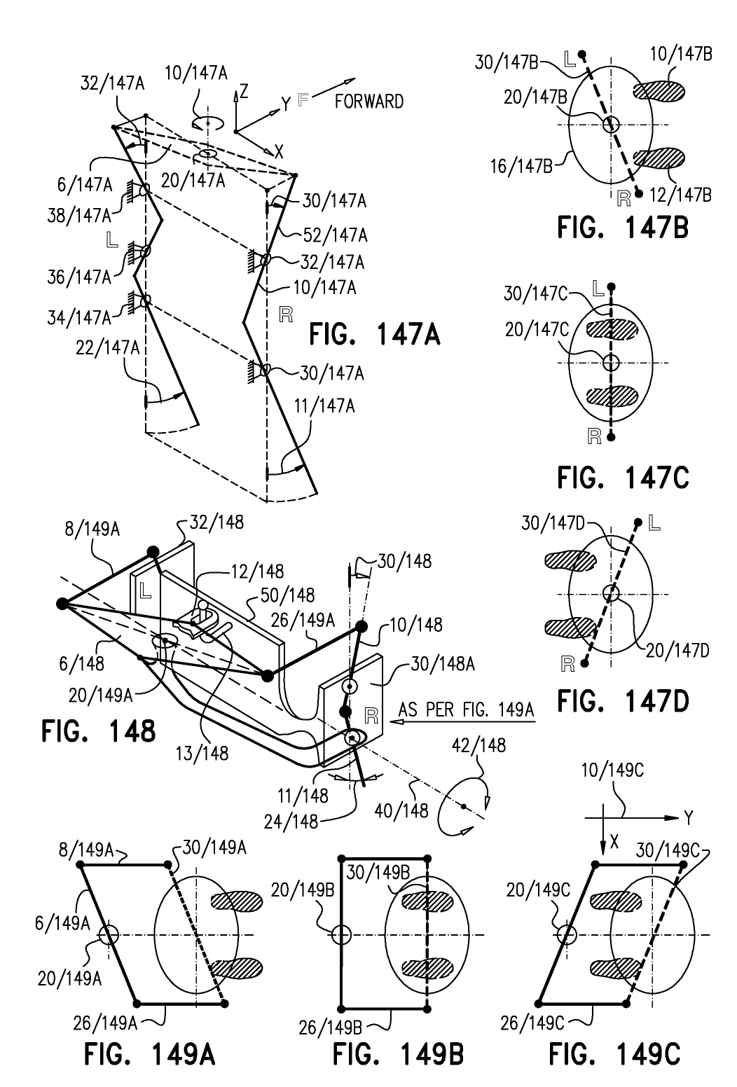

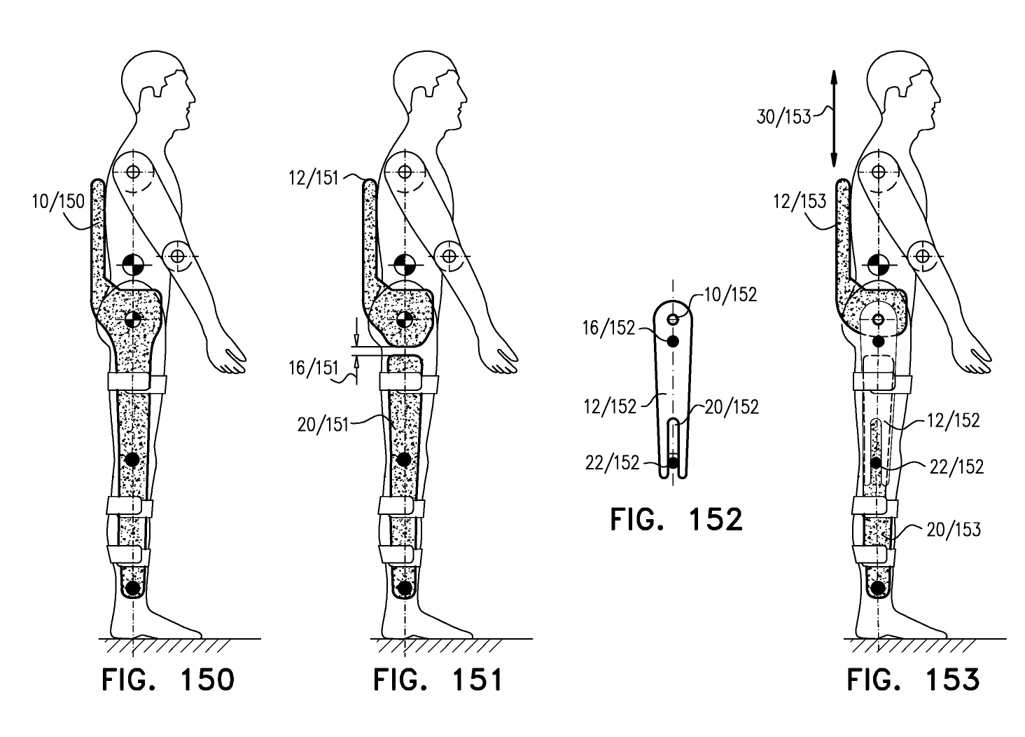

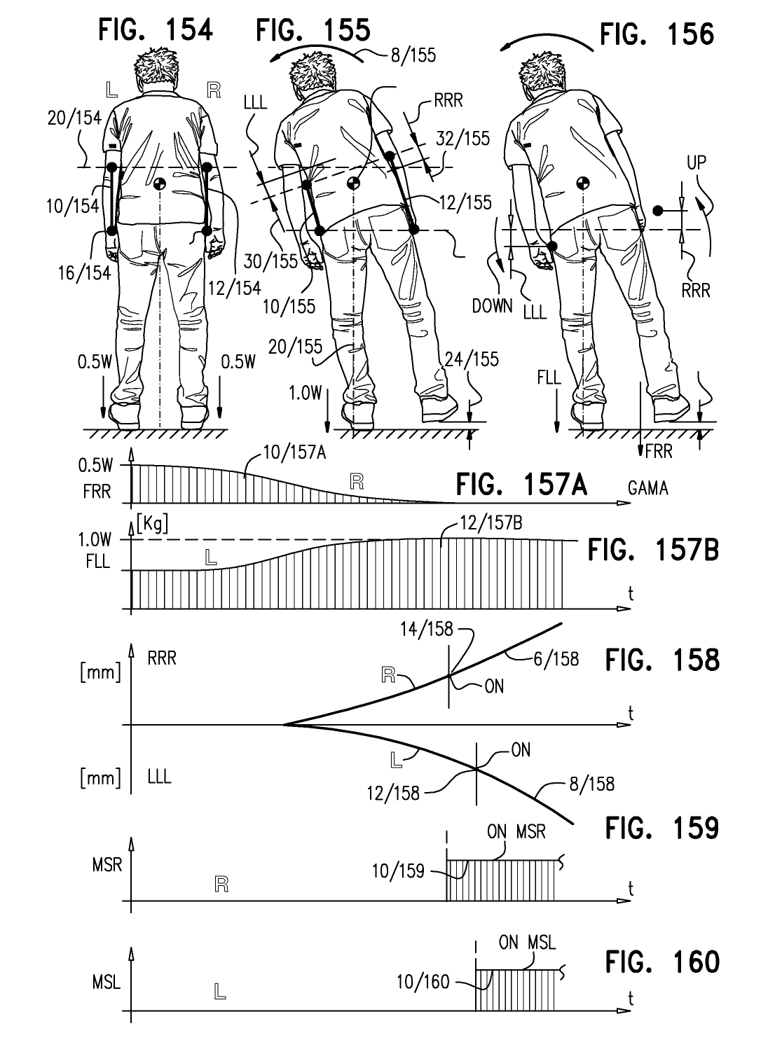

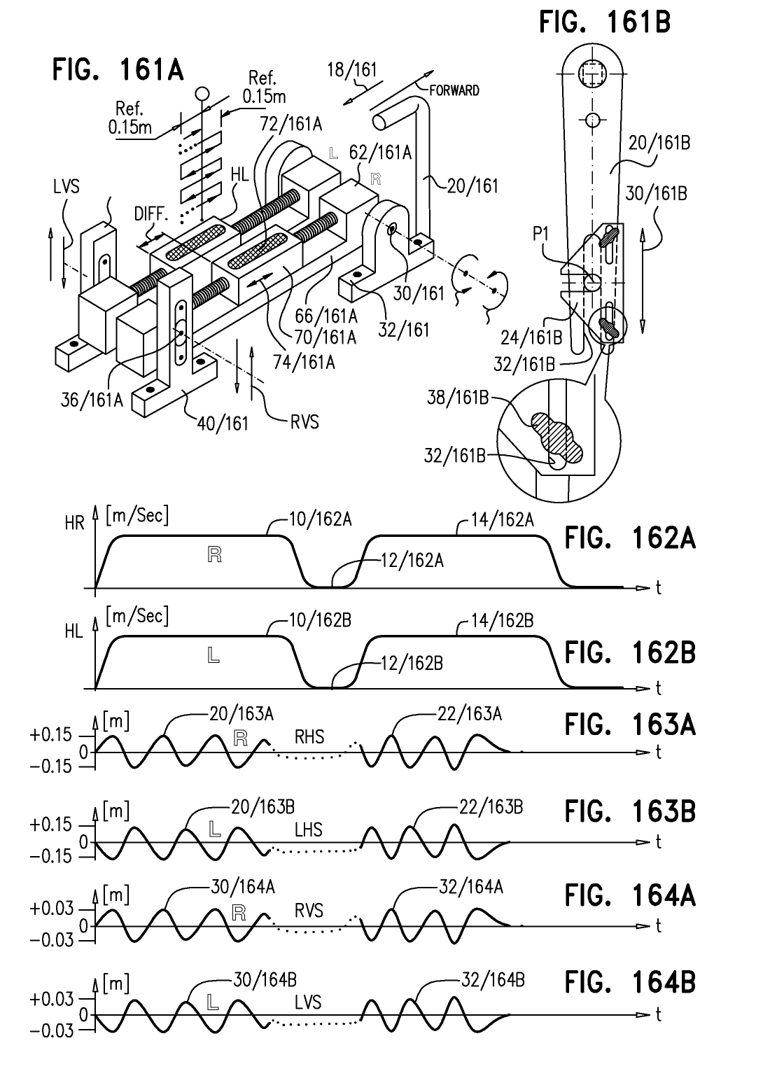

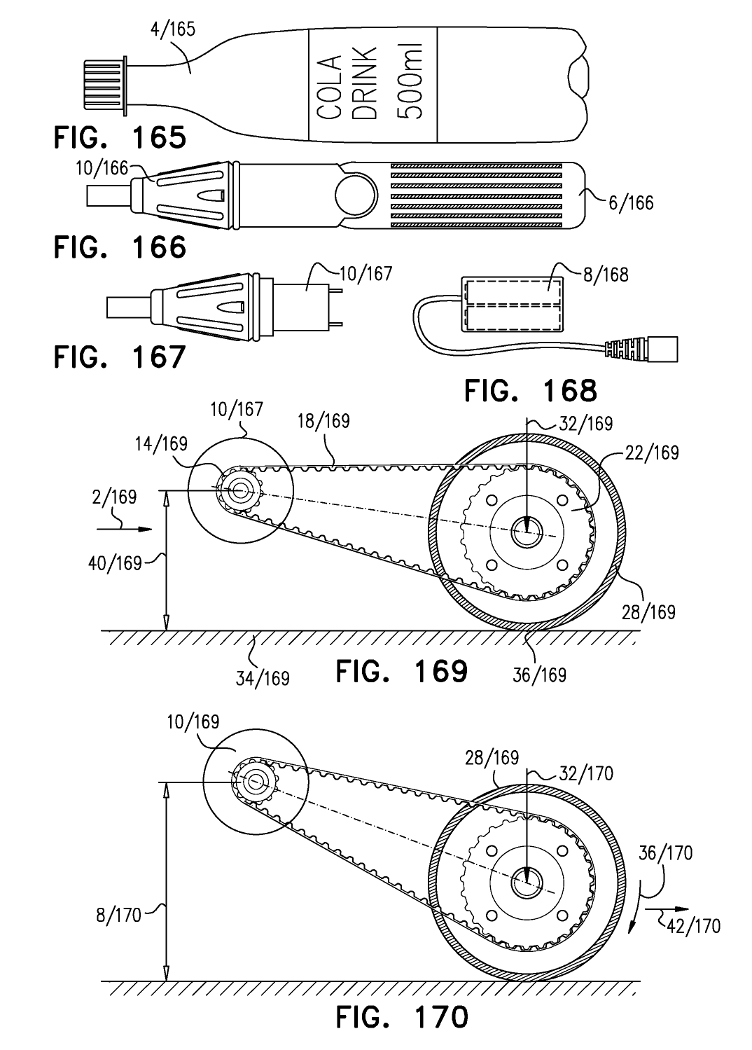

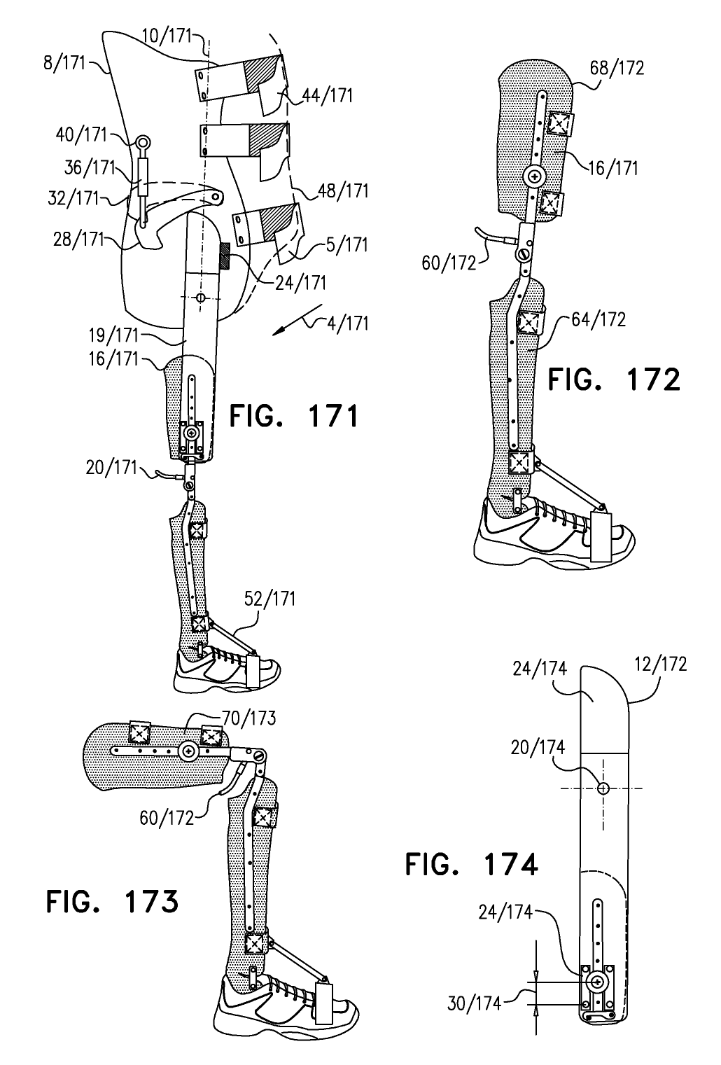

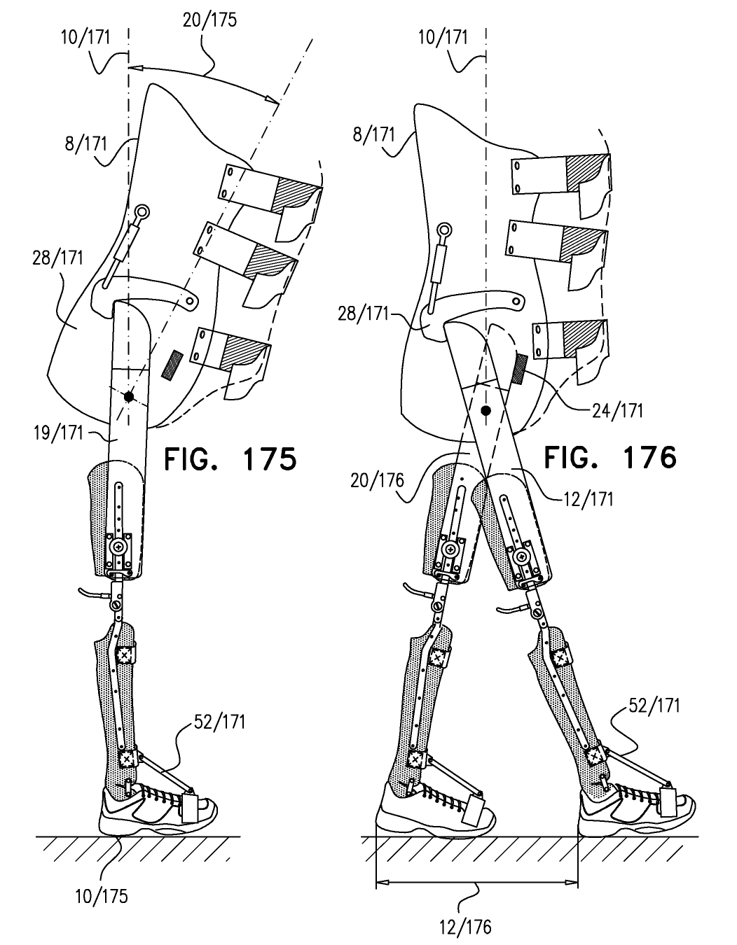

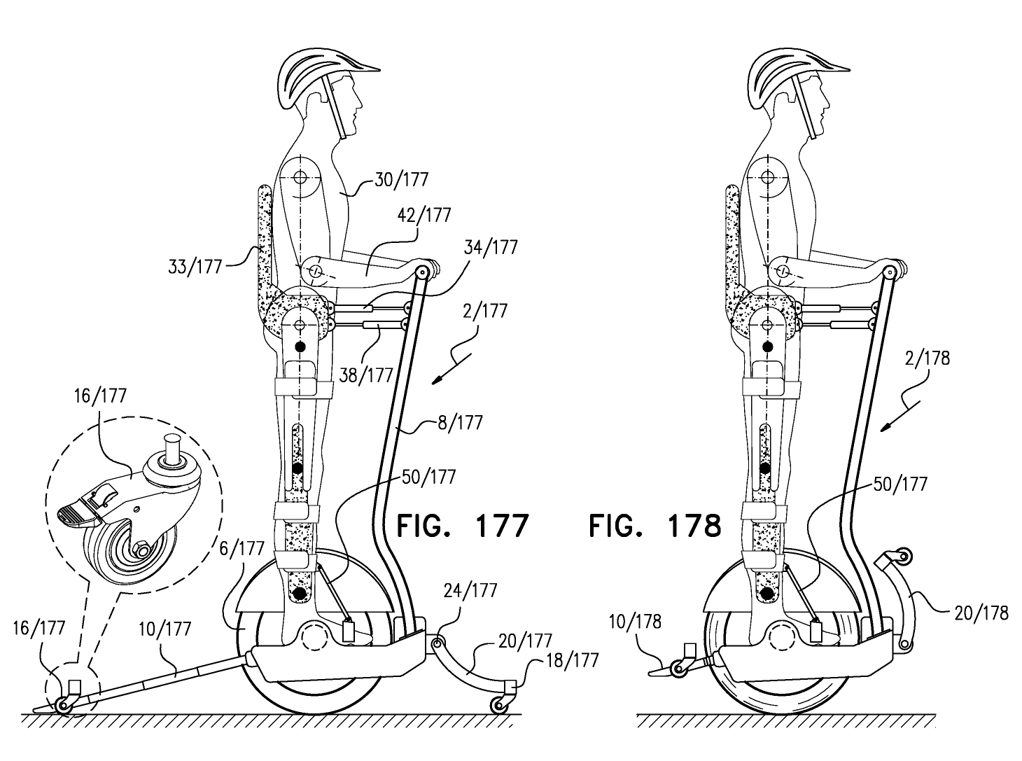

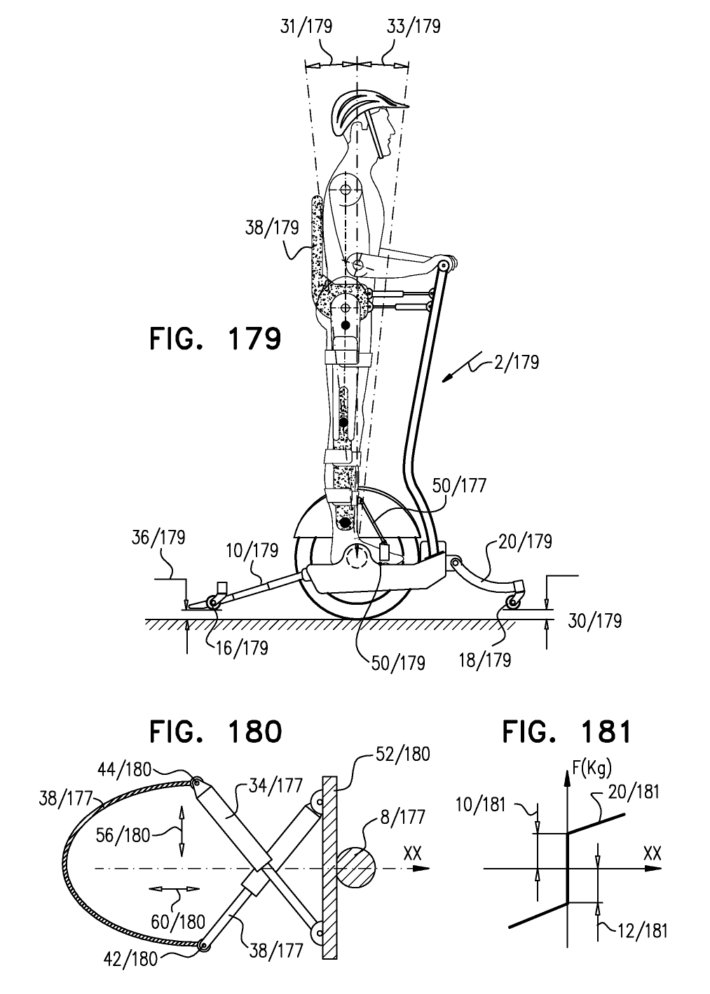

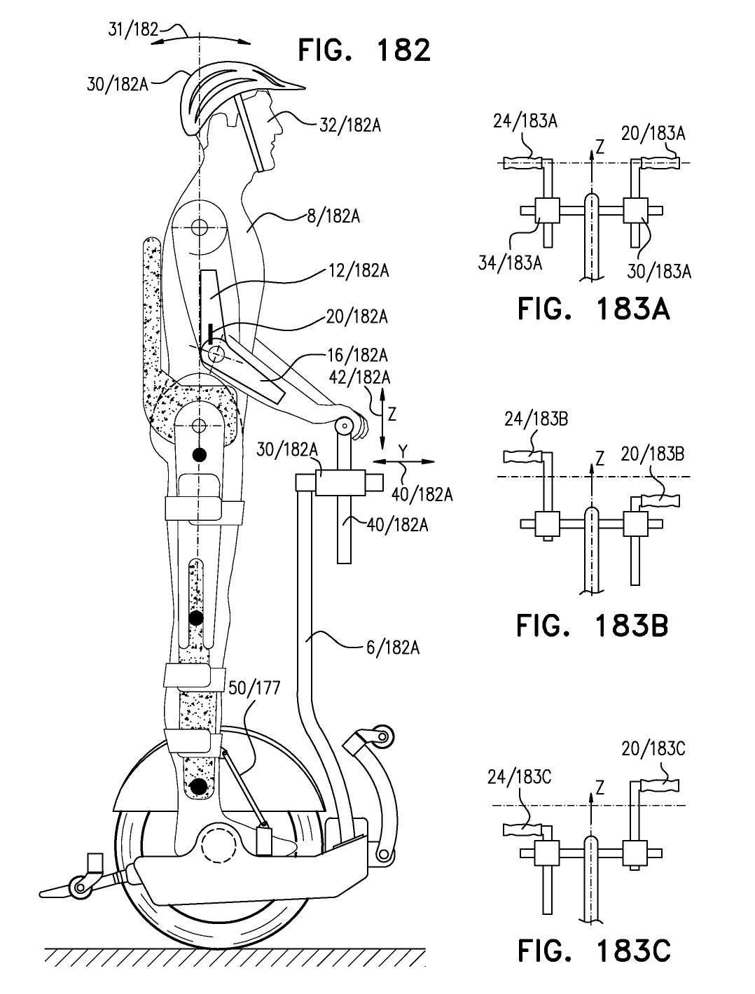

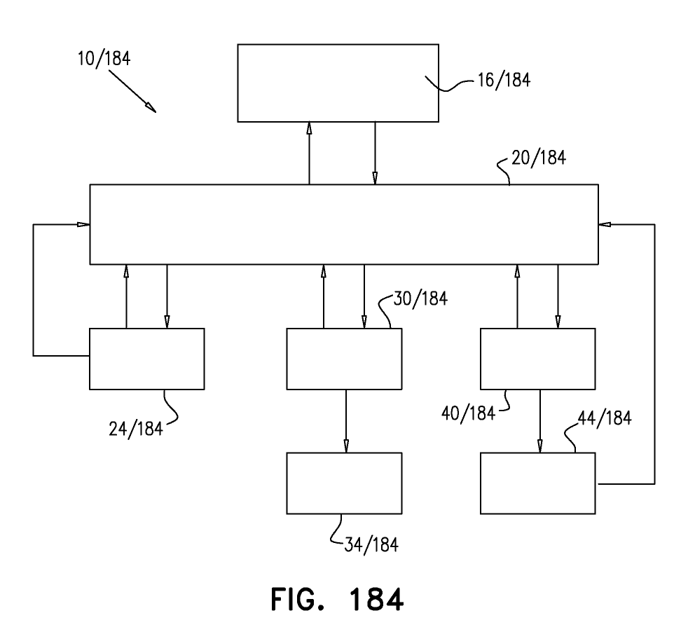

FIGS. 89, 92 and 93_Are schematic side view descriptions of examples used to compare the disabled person's leaning region with the seat

FIGS. 94 to 98_{—} are schematic view descriptions of a computerized device assisting disabled people in walking.

FIGS. 99A to 99C are schematic descriptions of a graph

FIGS. 100 to 103 are schematic view descriptions of the system and parts of the system required to move the legs of people

FIG. 100 presents schematic top view descriptions of a well-known standard spanner.

FIG. 101 presents a schematic isometric view of a mechanism designed to count the rotations, as shown in Drawings 17 and 18.

FIGS. 102 and 103 present schematic views of the desirable leg motions and foot

FIGS. 104 and 105 are schematic side view descriptions of a disabled person being assisted by an Actuator in order to move from a sitting to standing position and vice versa.

FIGS. 106 and 107 are schematic side view descriptions of a disabled person being assisted by an Actuator in order to move from a sitting to standing position

FIGS. 108 to 113 are schematic view descriptions of a designated walker 8/108 intended to provide walking assistance to a person paralyzed from above the pelvis downwards.

FIGS. 114 to 116A are schematic side view descriptions of the leg motion 20/114 transmitted to the transmission 22/114 through coupling 22/114.

FIG. 117 are schematic side view descriptions of the disabled person, with the system attached to him.

FIG. 118 presents schematic side view descriptions of a disabled person and the RGO in Drawing 117,

FIGS. 119 to 121 are schematic side view descriptions of three sample positions of the disabled person while standing,

FIGS. 122 to 124 are schematic side view descriptions of three sample positions of the disabled person's standing and the back's stabilization level in the different cases.

FIGS. 125 to 138 are schematic side view descriptions of a disabled person, such as Paraplegic T4, gaining a significant degree of independence

FIG. 125 presents schematic side view descriptions of a disabled person lying in bed

FIG. 126 presents schematic side view descriptions of a disabled person advancing his body up to the point where his knee is beyond the edge of the bed,

FIG. 127 presents schematic side view descriptions of a back support system

FIGS. 130 to 131 are schematic side view descriptions of a disabled person bending in the direction of unit 18/130 with the help of a cable 8/130 that lowers him in the direction of Down, and later on takes the leg straightening unit (Drawing 131) to have connected to the foot.

FIG. 132 presents schematic side view descriptions of a disabled person sitting and completing the connection of the foot straightening unit (Drawing 131) to his leg. The disabled person connects the coupling 14/132, and he is in a free position.

FIG. 133 presents schematic side view descriptions of a disabled person connecting the coupling with the help of a Pin P1

FIGS. 134 to 135 presents schematic side view descriptions of a disabled person who chooses to walk with crutches

FIG. 136 presents schematic side view descriptions showing as an example the stages of assembling the system on the disabled person's body in a different order than presented earlier.

FIG. 137 presents schematic side view descriptions of a disabled person going to the coffee shop and getting organized to being seated on a chair.

FIG. 138 presents schematic side view descriptions of a disabled person already in a sitting position in a coffee shop,

FIGS. 139 and 140 present schematic side view descriptions of a tall disabled person

FIGS. 141 and 142 present schematic side view descriptions of a system of Links that are Link transmission,

FIGS. 143 and 145 present schematic side view descriptions of Link Transmission of Two Stages_.

FIGS. 144 and 146 present schematic side view descriptions of Link Transmission of one stage

FIGS. 147A to 147D presents schematic isometric and Top View of drawings serving as an example of a system that transmits motion form the legs to the sides of the back.

FIGS. 148 to 149C present schematic isometric and top view of drawings serving as an example of a system that transmits motion from the legs towards behind the back.

FIGS. 150 and 153 present schematic side views of a paraplegic disabled person

FIGS. 154 to 156 are schematic back view descriptions of a disabled person standing on both legs at the beginning.

FIGS. 157A and 157B present schematic graphs showing the weight on each leg at the stage when the disabled person bends from the standing position (Drawing 154) to the full bending towards left

FIG. 158 presents schematic curves 6/158 and 8/158 respectively showing the lengthening on the right-hand side and the shortening on the left-hand side.

FIGS. 159 and 160 present schematic the Micro Switches activity as an example

FIG. 161A presents a schematic isometric view of an example of a two-track walker system.

FIG. 161B presents schematic side view descriptions of the coupling as described in Drawing 115.

FIGS. 162A to 164B—are schematic graphs illustrating

FIGS. 162A to 162B are schematic graphs illustrating

FIGS. 163A to 163B are schematic graphs illustrating

FIGS. 164A to 164B are schematic graphs illustrating

FIG. 169-FIG. 170 is a schematic drawing of the Timing Belt Transmission with the leg advancing wheel.

FIG. 165-FIG. 168 is a schematic drawing shows relative dimension of the drive system to a 500 ml Coca Cola bottle.

FIG. 169 is a schematic drawing of the Timing Belt Transmission which moves the wheel which moves the leg.

FIG. 170 is a schematic drawing of FIG. 169, but in this case, the Gear motor is raised above the ground

FIG. 171-FIG. 176 is a schematic drawing of an electrical system for a disabled person walking while his/her back is receiving support.

FIG. 171 is a schematic drawing of a walking system composed of a back support, to which two arms are attached.

FIG. 172 is a schematic drawing of the polio splint, presented in its dismantled position, is presented in Drawing 173.

FIG. 174 is a schematic drawing of arm which can also be dismantled from the back

FIG. 175, FIG. 176 and FIG. 171 are a schematic drawing of the turning of the back support in different positions of the foot being placed on the floor.

FIG. 175 is a schematic drawing of a system in which the disabled person stands with the maximal step

FIGS. 177 to 181 describing a riding system 2/177 with two driving wheels 6/177. The drawings also describe the main parts of the system and an explanation to the way it operates.

FIG. 178 is a schematic drawing of the system which is shown as the possibility of standing or riding by a disabled person who is skilled.

FIG. 179 is a schematic drawing of the system showing the possibility of standing or riding by the disabled person at the start of his/her training.

FIG. 180 is a schematic drawing of a partial top view of the grasping handle being stabilized and the crossed arms that include springs.

FIG. 181 is a schematic diagram of a spring system known in mechanical engineering.

FIG. 182-FIG. 183C is a schematic drawing of Quadriplegic on Rogo-way

FIG. 183A-FIG. 183C is a schematic drawing of the control systems causing the system to rotate, based on the handles vertical movement.

FIG. 1838 presents different height of the handles.

FIG. 183C presents the same heights of the handles

FIG. 184 is a schematic drawing of a riding system block diagram

### DETAILED DESCRIPTION OF PREFERRED EMBODIMENT

The present invention would be understood better and more fully appreciated by referring to the following detailed description taken in conjunction with the drawings.

### Abbreviations

The following abbreviations shall be used throughout the document:

| Abbreviation | Means |
|---|---|
| CG | Center of Gravity |
| w.r.t | With respect to |

### Definitions and Other Details

Note:

Whenever the text addresses a specific gender (e.g. his or her, man or woman) it should be interpreted, unless explicitly specified, as addressing both genders (e.g. his/her or man/woman)

### Ground or Floor:

A ground or a floor is a surface supporting the body weight via contact with the bottom of leg/legs.

### Walking:

The term “walking” describes the relative movement of a person from one place to another, using his legs, by the below definition of “leg”. The term also includes walking on a treadmill, where the motion is relative to the treadmill's strip.

### Forward Walking:

In the drawings, the kinematic description of human legs and body depicts the legs motion, and the CG shift. When a man's back is shown, he is advancing “into the page”. When a man's forward is shown, he is advancing “out of the page”. The standard symbols ⊙ and ⊗ means into the page and out of the page, respectively.

### Cartesian Coordinate System (XYZ)

The X and the Y axes are level, and Z points up. For the human body, Y points forward, and X points towards the left shoulder.

### Disabled

The term “disabled” refers a wide range of disabilities. The term is not limited to persons declared as disabled by the authorities, but also refers minor walking limitations.

### Foot:

The term “foot” refers a limb mounted below the pelvis, down to the sole. Examples are:
A normal human leg
A human leg suffering muscle activation weakness
A human leg suffering limited muscle activation, aided at least partially by electrical signals for muscle activation.
A paraplegic leg, lacking any muscle activation ability
A partially amputated leg, complemented fully or partially by a prosthesis
When a leg is amputated above the knee, and there is some mechanical or physical bridging element towards the ground, the bridging element shall be considered a part of the leg.
When a leg is fully amputated at the pelvis and an artificial support for the body weight shall be considered a “leg”. The support can be homogenous or made of several materials—metal, plastic, wooden, or other.

### Leg Bottom

The bottom of a leg, which is normally in contact with the floor, whether it is a bare foot, a foot with shoe, a prosthesis, a component of a walking aid, or other.

### Leg Straightening

The term “leg straightening” covers many options, al referring the mutual orientation between the leg parts. The leg straightening of a normal leg is depicted for a normal leg in Figure. In a normal leg, the straightening mainly refers pelvis, knee, and ankle angles. The same concept of straightening applies as well to partially or fully prosthetic legs.

It is well known that a straight leg can support the entire weight of a human body+load, requiring little muscle effort. The exploitation of this property is the foundation for the walking aids defined in this document for disabled people.

From the biological nature of the leg, the flexing of leg joints is mainly in the sagittal plane.

The straightening in the coronal plane is mostly derived from the leg structure and is hardly changed.

Some examples are given for clarification:
A normal human leg, capable of normal straightening
A leg with partial weakness in of muscle activation, whether the human can straighten the leg without help, or with the help of aids.
A leg with limited muscle activation, requiring electrical stimulation for straightening.
A paraplegic leg, requiring aids for straightening
A partially amputated leg, with the leg and the prosthesis forming the straightening together
When a leg is fully amputated at the pelvis and there is an artificial support for the body weight. The support can be homogenous or made of several materials.
When two legs are fully amputated at the pelvis, with a mechanical/physical support between the pelvis and the floor.

### Tilt

The term “tilting” for a human covers many options. Some of those options are changing the orientation, or jiggling, or shaking. The tilting modifies the CG position w.r.t its previous position. A typical tilting involves the alternation of weight support between the legs.

### Weight Support Leg

On standing or walking, the weight support leg caries the larger part of the weight load. The weight support leg contacts the ground (floor), from time to time, while standing or through the varying walking states.

### Free Leg

On standing or walking, the free leg supports less weight than the other leg. The free leg can be in various states. In a first state, the free leg bottom does not touch the ground. In a second state, the free legs contact the ground from time to time while standing or while walking.

### Arc

The term “arc” refers the motion of the leg bottom of the free leg while striding. When striding forward, the arc consists of three main parts as depicted in FIG. ( ): the anterior, the medial, and the posterior. For optimal striding of the disabled, the goal is that the body tilt shall evade ground contact in the medial part (and retain some spare space)—see FIG. ( ). Note: In some cases, ground contact shall form in the medial arc. The contact shall generate frictions which the drive system must overcome for advancing the free leg.

### Wheel

The term “wheel” refers a round wheel, a non-round wheel (e.g. hexagonal), or a belt, or a chain belt in a configuration similar to tracked vehicles. The wheel may be solid or deformable. Tracked wheeling allows obstacle overcoming, and is also potent for advancing over carpets.

### Communication System

It is possible to add a communication system with an at least two-directional antenna for every sub-system and or component including batteries (or another Electrical source). This issue does not appear in the figures of this document, because it is well known in the engineering field. The topic will sometimes be mentioned in this text.

Indication of a Leg which Rises Above Ground, or Delivers Very Small Weight to the Ground

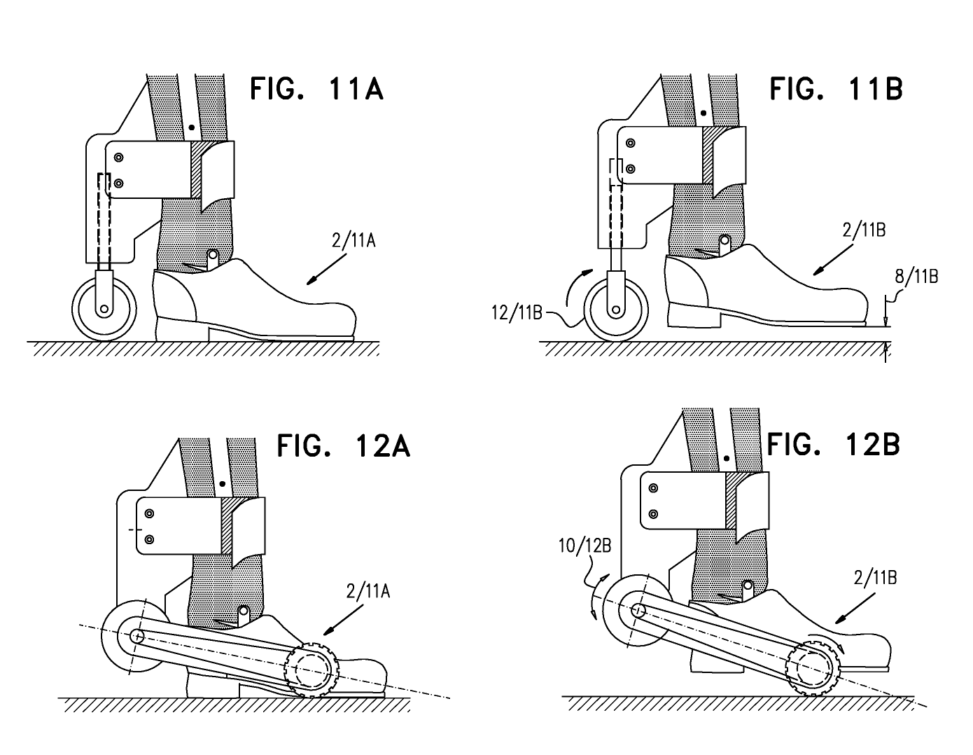

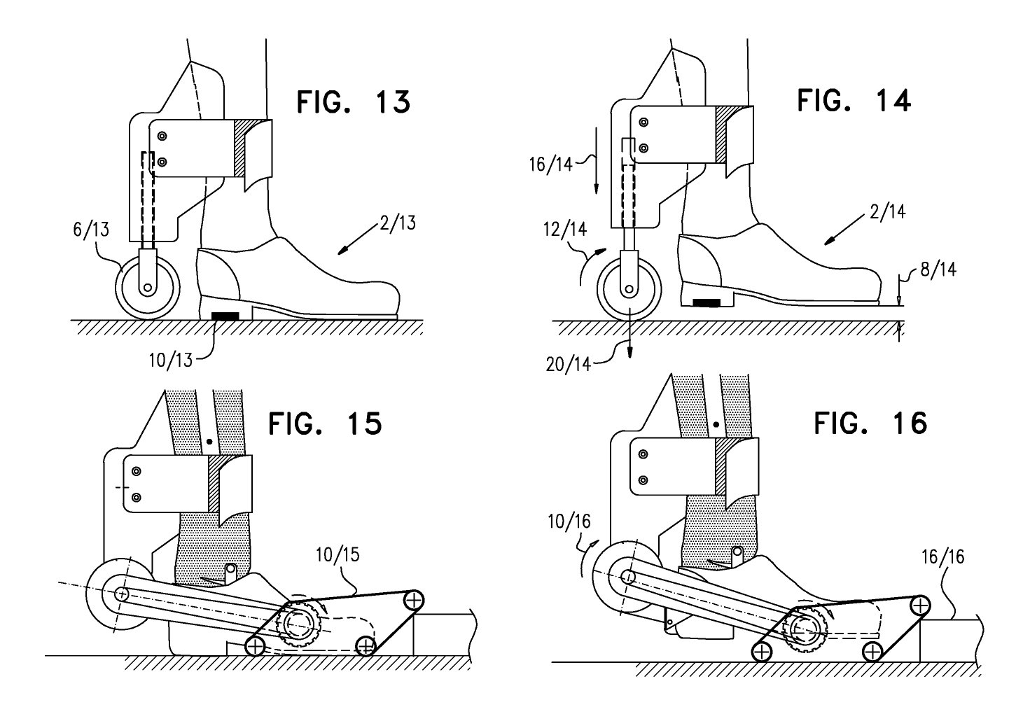

Indication of a leg which rises above ground, or delivers very small weight to the ground. The indication for various options has been explained in FIGS. 11A-16, and “load cell” indication has been explained in FIGS. 13-14. When the legs described at the abovementioned figures do not use driving systems, the indication will be by a micro switch, by a “load cell” or by both of them. The indication can be delivered to the control system in order to direct the disabled person's walk by wires, wirelessly or both. For examples, see FIGS. 27, 28, 29, 30A-30D, 31A, 32A, 33-36, 37D, 41-43B, 44. 51. and 154 to 160

Systems with Moving Parts Controlled in Closed Loop by Servo Actuators

Some of the systems in this document contain relatively moving parts, which can be controlled in closed loop by servo actuators. It is possible to receive all of the signals from the varying sensors, and log them to the system DB keyed by the disabled person's identity. It is possible to follow the disabled person's progress by examining the statistics (transition time from standing to sitting and vice versa, speeds, forces, efforts, etc.).

It is possible to set the disabled person's exercises initial conditions based on his progress, by the initial set points of the closed loop controls.

By analyzing data from the system's DB, it is possible to optimize the exercises program, following accumulating self-experience and knowledge.

As an option, data transfer shall be wireless.

It is possible for the physiotherapist to dictate modifications in exercises before and while exercising with a control box, using wired or wireless connection.

### Basic Principles of the System, the System's Logic and the Walking Operation:

See the section Definition and other Details.

### Additional Definitions

| | |
|---|---|
| Weight (of a person) | The entire weight supported by ground |
| | contact. This includes the body weight, |
| | garments, carried load, helper devices, |
| | etc . . . |
| COG | Center of Gravity, refers the weight as |
| | defined above unless otherwise specified. |
| Sensor set | One or more sensors, aimed, at measuring |
| | specified physical phenomena. |

The Leg Straightening is obtained by the disabled person's ability or by using an auxiliary device.

Tilting the body of the disabled person creates a state where the “weight support leg” supports most of the weight. The other leg becomes a “free leg”.

On this state, the “leg bottom” of the “free leg” either detaches the ground or presses the ground lightly enough, so that small exertion of propelling force may advance the free leg in a walking process.

The propelling force cannot move the “weight supporting leg”, and this leg remains stably fixed to the ground. As will be explained below, this property is essential for fall safety.

A sensors set, with or without supporting computer/control system, will recognize the “free leg” state, and advance it by applying propelling force. The propelling ceases when the leg “un-frees”, or on other conditions explained below.

Due to safety and ergonomics considerations, the step-size shall be limited. The limiting is made on the ground distance between the leg bottom and the person's COG.

The input of a walking activity is the existence of a “free leg”. Advancing the free leg will continue until either the leg re-loaded, or the step limit is exceeded.

The disabled person shall control the walking activity (which leg will step to which distance) according to his desires and abilities. Examples of several walking patterns are given in the figures of this document.

In most cases, it is possible to add a driving system to each disabled leg separately, with or without the auxiliary devices usually used by the disabled person.

### Two Stages

For disabled people whose leg straightening is obtained by one of the conditions described in this section, a modification process will be provided in two stages:

### First Stage:

Additional equipment shall be used according to the type of disability. For example:
1. A normal human leg, capable of normal straightening
2. A leg with partial weakness in of muscle activation, whether the human can straighten the leg without help, or with the help of aids.
3. A leg with limited muscle activation, requiring electrical stimulation for straightening.
4. A paraplegic leg, requiring aids for straightening
5. A partially amputated leg, with the leg and the prosthesis forming the straightening together
6. When a leg is fully amputated at the pelvis and there is an artificial support for the body weight. The support can be homogenous or made of several materials.
7. When two legs are fully amputated at the pelvis, with a mechanical/physical support between the pelvis and the floor.

### Second Stage:

In most of the above cases, after fulfilling the conditions mentioned at the “First stage” paragraph, it is possible to add the driving system to each disabled leg separately, without the auxiliary devices usually in use for walking.

In some cases, tilting the disabled person will be done by his hands and with the help of an auxiliary device such as stilts, walker, by help electro mechanical actuators etc.

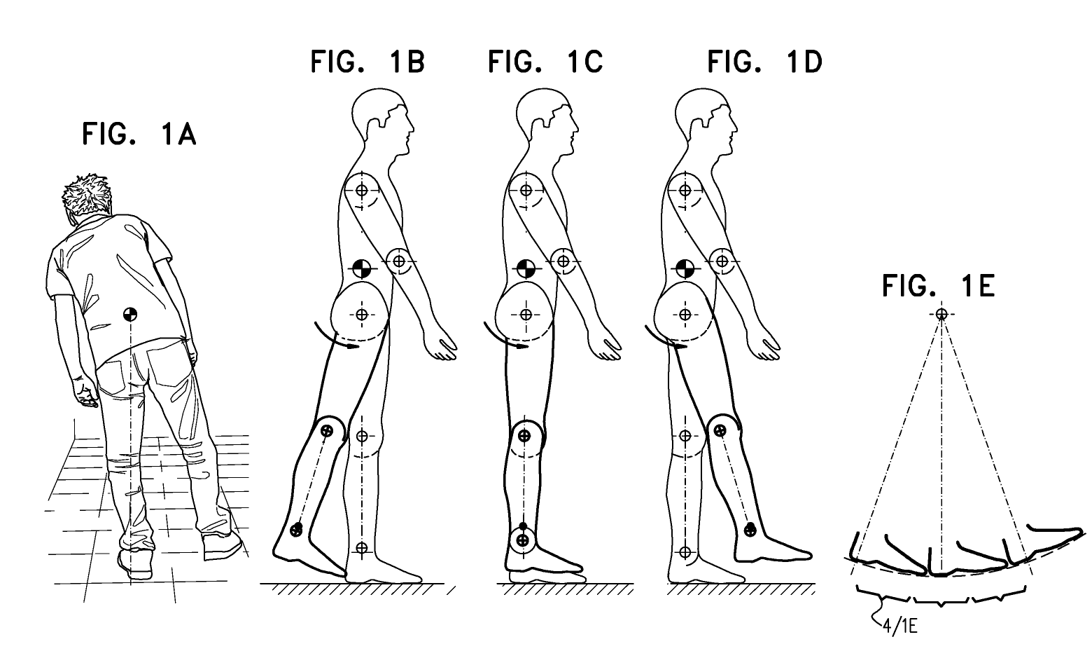

The tilting of the disabled person may be helped by another person at his side. A very challenging example is walking on the street with a person whose both legs are amputated. In this case, when the walking is moderate and slow, the disability is hardly noticeable for an observer s few meters away. This is since there is no belting except for two or three bands attached to the feet bottom, where the drive is located. Some situations allow the use of very simple systems (see e.g. FIG. 1A-1E, FIG. 11-15). Each free leg is equipped with a micro-switch. A “free leg” is identified by the release of a micro-switch.

As described above, a free leg shall be propelled until it is reloaded, or the step limit is exceeded.

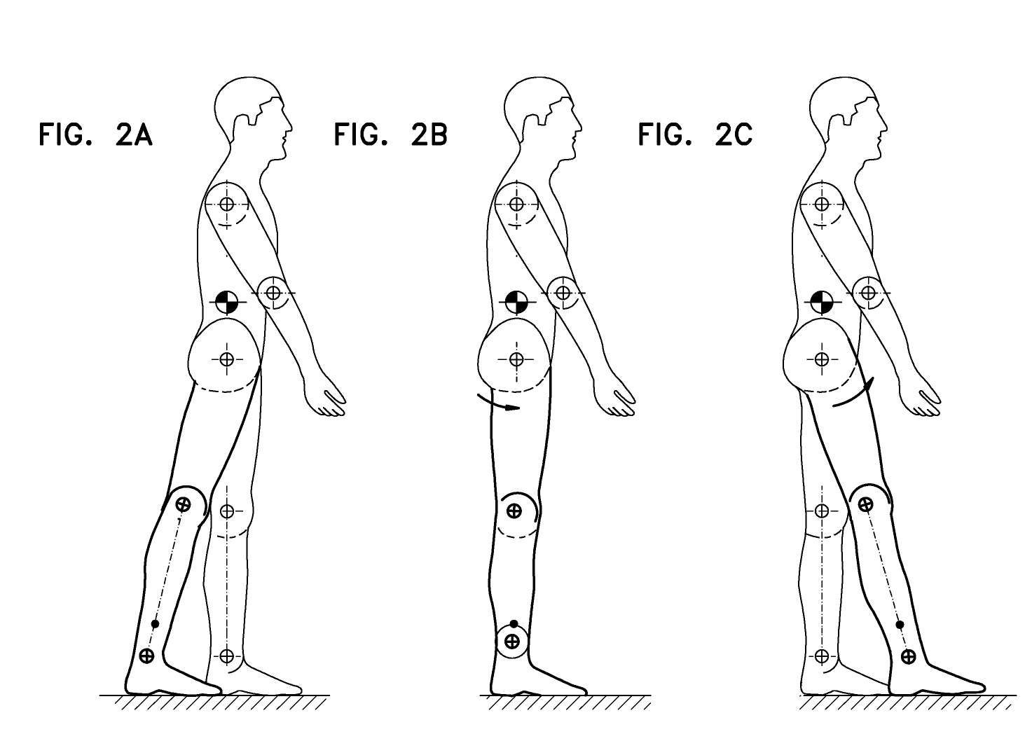

In a slightly more complex situation (see e.g. FIG. 2A-2C), the free leg is dragged and does not fully lose ground contact. Then, a force sensor with a preset threshold may replace the micro-switch of the above paragraph (see e.g. FIG. 99A-99C).

A system operated by the disabled person where the hands participate in the walking process, e.g. by pushing or driving a walker or stilts, etc.

A system which uses hands power to accumulate elastic energy. The system used the stored energy to propel the disabled person's leg or legs.

For example see FIG. 17, in which the energy generated by the disabled person's hands is stored in a flexible element, in this case a spring—any other flexible component may be used, made of materials such as rubber, plastic, etc.

Comment: it is possible to allow the disabled person to perform a balk-walking. Due to this issue we shall widen the description of this option. It is possible to implement back-walking similarly to forward-walking, following the descriptions in this document.

As an example, see FIG. 17, where the energy generated by the hands is stored in a flexible element, in this case a spring. The element may implement any acceptable engineering configuration, and be made of any flexible material, such as rubber, plastic, etc.

A cable delivers the elastic energy to the free foot, applying a propelling force of about 20 N.

As a simple implementation example, a system can be powered by a small electric gear-motor, powered by a small battery pack. The “free leg” state is identified by a load sensor or by a micro-switch A system may consist of a large amount of components, in order to deal with extreme situations. As an example see FIG. 17, where the system includes batteries, micro-switches, a dynamometer, a computer and a control system (which do not appear in the drawing). The components presented in the drawing include a torque-spring drum and a cable, a turn limiter, a motor or a gear motor, a brake and a shaft encoder.

The system can be modular. Individually tailored systems may be delivered to match specific dimensions, weight, and disability types.

The system can be modular and enable replacement of its sub-systems and of components which are not connected directly to the disabled person, such as the cable's drum or the spring presented in FIG. 17. For example: the spring force may be played between 5 N to 20 N, individualizing the “free leg” propelling force. Another possible purpose for exchanging components might be the creation of various exercises and non-standard walking modes on top of the routine walking described in this document.

### Person's Parameters and More

0.1. When we refer to the disabled person's weight, it should be understood as his weight when undressed, and the disabled person's weight and everything attached to him as well as all intermediate situations.
0.2. In Drawing 153, Arrow 30/153 stresses the possibility that the disabled person's height in large ranges does not require the adjustment of the RGO since it can overcome the differences in height with the help of 12/152 in Drawing 152, the ability of Pin 22/152 to move freely in slot 20/152.
0.3. Some of the standards described in this document intended for the use of disabled or handicapped people can also be used, depending on need, for people that are not disabled or handicapped.

### Hybrid

The system can be seen regarding the name that is customary for Hybrid in the world of vehicles.
0.1. When a car stops, it stops the consumption of electricity. In our case too—when the person stands on both feet, even for a long period of time, they maintain the non-consumption of electricity required to move the legs.
0.2. Moving the hybrid car is achieved by electrical motors in our case too—in the option of electrical drive, we activate electrical motor for the purpose of stepping.
0.3. In the hybrid car, there is an option of recharging the batteries with the existing energy available in the car. For example: in our case, we add an electric charger (was not marked in the drawings) but it is clear from the technological and engineering aspects. As an option, it can be added to any electric device described in this document. In the most convenient option—the charger is activated by a rotational handle (or other available options) with the help of the disabled person's one or both hands. Due to the minimal consumption during walking, a device with small power (wattage) will provide the ability to recharge the batteries. In an approximate calculation, a 10-minute recharging will make it possible to walk for about 4 minutes.
0.4. In a hybrid car, the charging ability can also serve as backup for the battery. In our case, the charging ability serves as backup so that the disabled person would be able to continue walking when the battery is depleted or faulty. There are many existing systems that are known for their ability to provide this option.

### Sub-Systems

For clarification purposes, all systems or sub-systems can be manufactured or marketed whether they are manufactured by the original manufacturer or added to an After Market existing system, or any other possible combination of sub-systems. For example, it is possible to combine telescopic crutches with systems intended to move the legs as presented in this document.

### DESCRIPTION OF THE DRAWINGS

The presented invention would be understood better and more fully appreciated by referring to the following detailed description taken in conjunction with the drawings, in which:

FIG. 1A presents schematic descriptions of the disabled person tilting his body such that his COG is just above his “leg bottom”.

FIGS. 1B to 1D are schematic descriptions of a disabled person loading his left leg as a “weight supporting leg”. The right leg is “free” and performs a whole walking motion. During the entire process, the right legs' bottom is above the ground.

FIG. 1E presents schematic side view descriptions of the arch movement of the disabled person's right leg heel. The disabled person's leg doesn't touch the ground.

FIGS. 2A to 2C present schematic descriptions of a disabled person standing on his left leg, which functions as a “weight supporting leg”. The right leg, which functions as a “free leg”, commits a whole walking movement. During the entire or the most of the process, the “leg bottom” contacts the ground with a frictional slipping motion

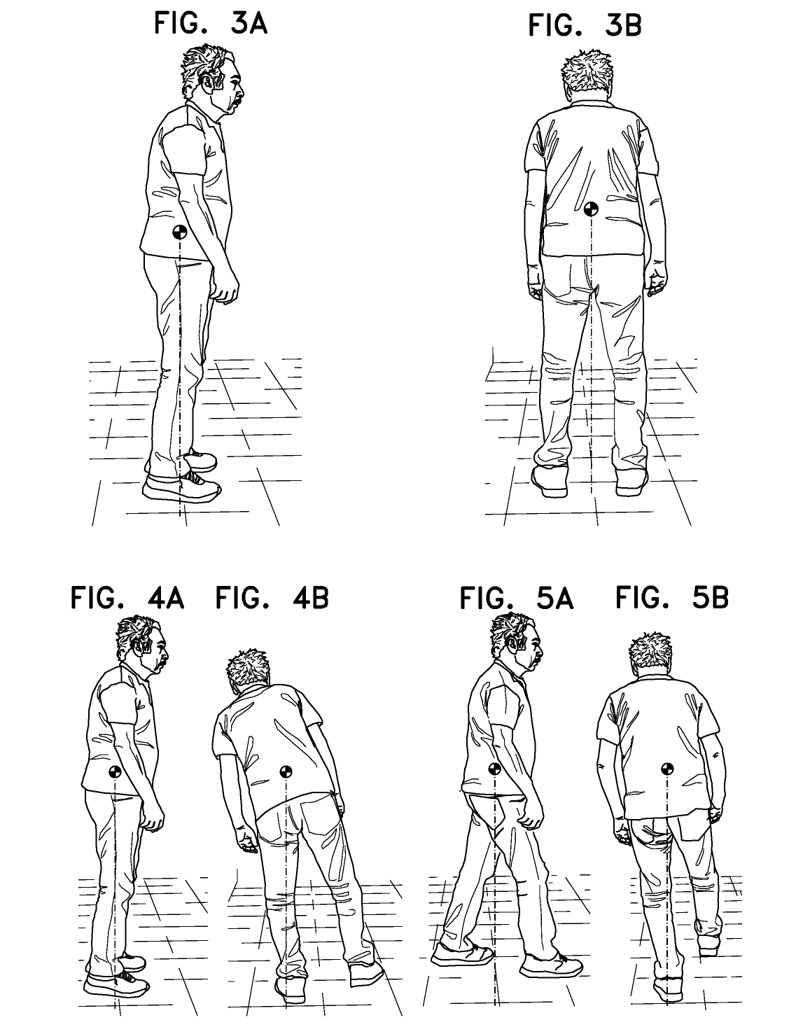

FIG. 3A presents schematic side view descriptions of a disabled person standing on his both legs, with the COG between his legs.

FIG. 3B presents schematic back view descriptions of a disabled person standing on his both legs, with the COG between his legs.

FIG. 4A presents schematic side view descriptions of a disabled person standing on his left leg and tilting his body to the left, as the COG is above his left leg's “leg bottom”, and his right leg, which functions as a “free leg”, is raised above ground.

FIG. 4B presents schematic back view descriptions of a disabled man standing on his left leg and tilting his body to the left, as the COG is over his left leg's “leg bottom”, and his right leg, which functions as a “free leg”, is raised above ground.

FIGS. 5A and 5B present schematic descriptions of a disabled person walking forward.

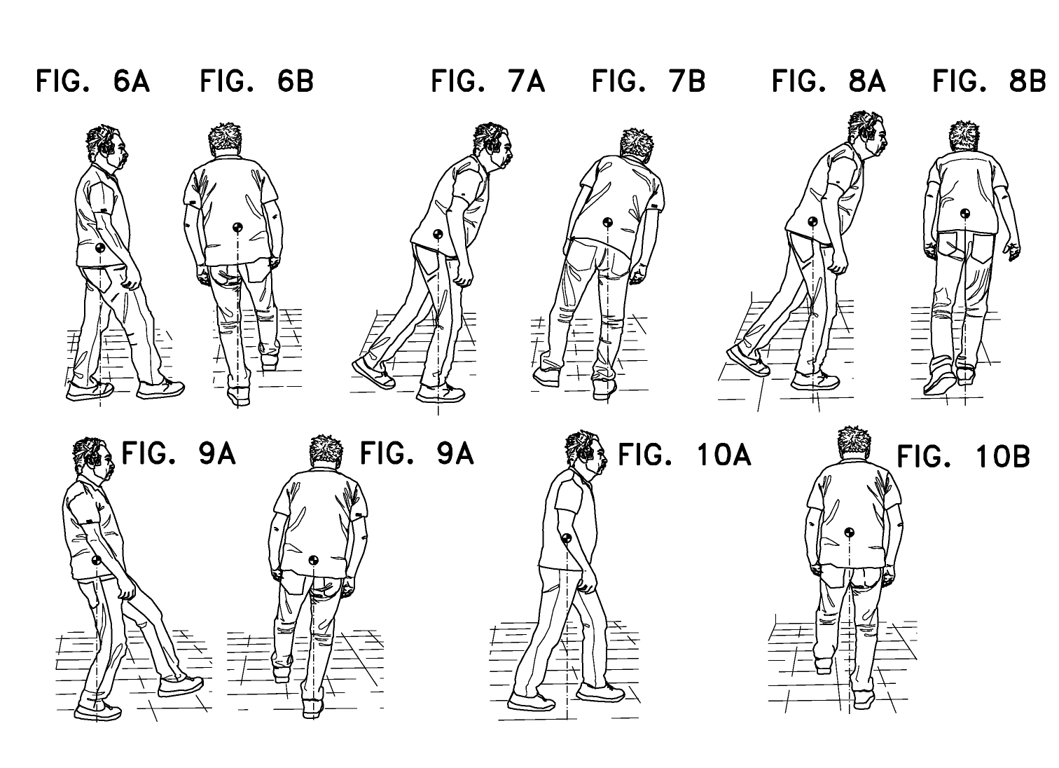

FIGS. 6A and 6B present schematic descriptions of a disabled person which had stabilized on both his legs during the walking process.

FIGS. 7A and 7B present schematic descriptions of a disabled person beginning to walk when his right leg functions as a “weight support leg”. Due to two tilts of the disabled person's body, one to the forward and one to his right side, the person's center of gravity is above his right leg. The disabled person's left leg functions as a “free leg” and is raised above ground.

FIGS. 8A and 8B present schematic descriptions of a disabled person in an additional walking state. The disabled person's right leg functions as a “weight support leg”, and his body tilts forward and right, causing his left leg function as a “free leg”, raised above ground.

FIGS. 9A and 9B present schematic descriptions of a disabled person in an additional walking stage. The person's right leg continues functioning as a “weight support leg”, and his body tilts to the back and to the right, causing his left leg function as a “free leg”, raised above ground and outstretched forward.

FIGS. 10A and 10B present schematic descriptions of a disabled person in a terminal walking stage. The bottom part of both the person's legs lies on the ground, and the center of gravity is projected between his legs.

FIG. 11A presents schematic descriptions of a foot drive mechanism. In this example, the “leg bottom” of the “weight support leg” is on the ground, and the back drive wheel doesn't rotate.

FIG. 11B presents schematic descriptions of a foot drive mechanism.

In this example, the “leg bottom” of the “free leg” is above the ground and the back drive wheel touches the ground and rotates in order to enable the leg's movement.

FIG. 12A presents schematic descriptions of an internal foot drive mechanism when the driving wheel is located at the medial part of the leg, connected to the leg's bottom, and practically lies between the legs. In this example, the “leg bottom” of the “′weight support leg” is on the ground and the drive wheel is touching the ground thanks to a spring or equivalent system. The drive wheel doesn't rotate.

FIG. 12B presents schematic descriptions of an internal foot drive mechanism when the driving wheel is located at the medial part of the leg, connected to the leg's bottom, and practically lies between the legs. In this example, the “leg bottom” of the “′free leg” is above the ground and the drive wheel is touching the ground thanks to the spring system. The drive wheel rotates.

FIG. 13 presents schematic descriptions of a foot drive mechanism 2/13. In this example, the “leg bottom” of the “weight support leg” is on the ground, and the back drive wheel 6/13 doesn't rotate. A load cell (or another type of force measurement device) in attached to the bottom part of the system

FIG. 14 presents schematic descriptions of a foot drive mechanism 2/14.

In this example, the “leg bottom” of the “free leg” is above the ground 8/14 and the back drive wheel touches the ground and the wheel rotates in order to enable the leg's movement. A load cell is attached to the bottom part of the system. Spring force 16/14 create force 20/14 on the ground.

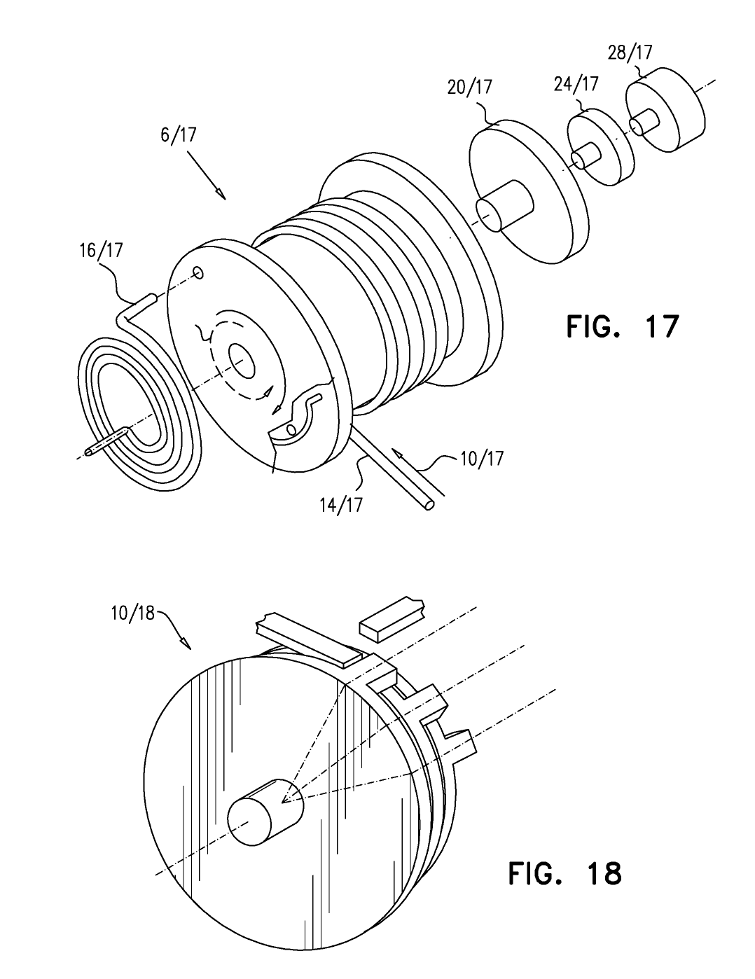

FIG. 15 presents schematic descriptions of an internal foot drive mechanism. In this example, the “leg bottom” of the “′weight support leg” is on the ground and the drive chain 10/15 is touching the ground thanks to the spring system. The drive chain doesn't rotate.

FIG. 16 presents schematic descriptions of an internal foot drive mechanism. In this example, the “leg bottom” of the “free leg” is above the ground and the drive chain is touching the ground thanks to the spring system. The drive chain rotates 10/16, in order to enable the leg's movement. Chain 10/15 is touching balk 16/16

FIG. 17 presents schematic exploded view of a foot drive mechanism and of force exertion by a cable. When the limits to the cable drum revolutions also limits the length of the cable exiting.

FIG. 18 is a schematic of an isometric view of the cable drum's revolutions limiting mechanism

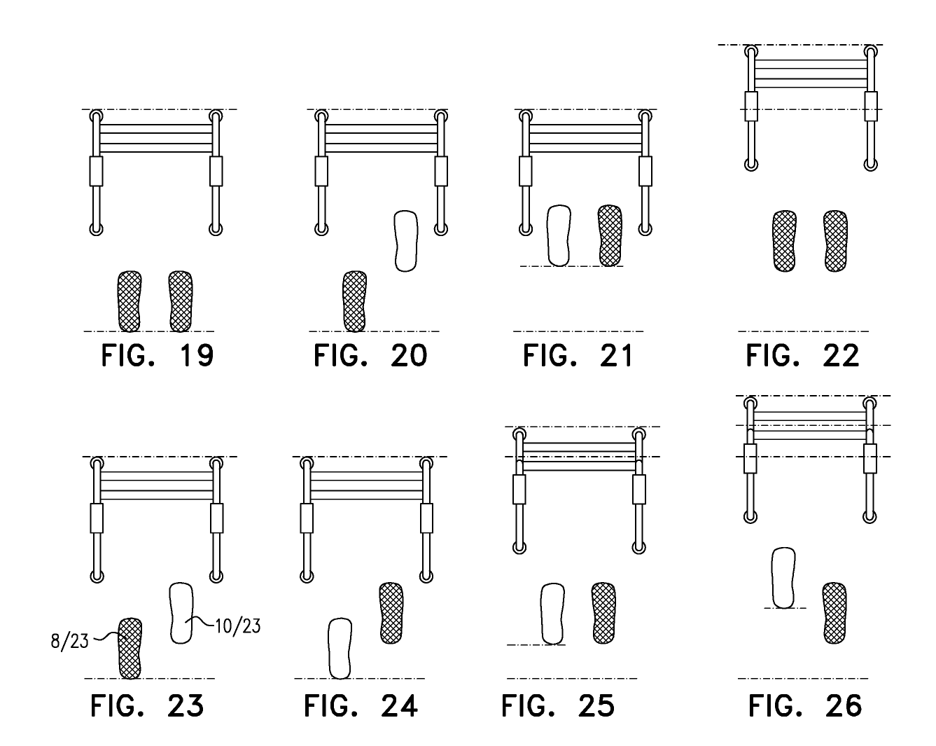

FIGS. 19 to 22 present schematic descriptions of the traces created by a disabled person using a walker. The walking process begins and ends with the disabled person's legs standing near to each other.

FIG. 23 presents schematic descriptions of the traces created by a disabled person using a walker. As the walking process begins, the disabled person's left leg functions as a “weight support leg” (labeled in the footprint by crossed lines), while his right leg functions as a “free leg” (labeled in the footprint as an empty area) and is outstretched forward.

FIG. 24 presents schematic descriptions of the traces created by a disabled person using a walker. In the second stage of the walking process, the person's right leg functions as a “weight support leg” and is outstretched forward, and his left leg functions as a “free leg”.

FIG. 25 presents schematic descriptions of the disabled person's right leg traces, during a dynamic stage of his walking process with a walker. In this stage, the disabled person's left leg functions as a “free leg”, and is moving forward without touching the ground. During this stage, the walker is moved forward.

FIG. 26 presents schematic descriptions the traces created by a disabled person using a walker. The person is at the ending of the walking procedure. The persons' right leg functions as a “weight support leg”, and his left leg, which functions as a “free leg”, is outstretched forward. In fact, the disabled person's legs position is symmetric with the initial position described in FIG. 23.

FIG. 27 is a schematic isometric front view of a disabled person with a walker. The walker includes two systems which drive the disabled person's legs and help him walk.

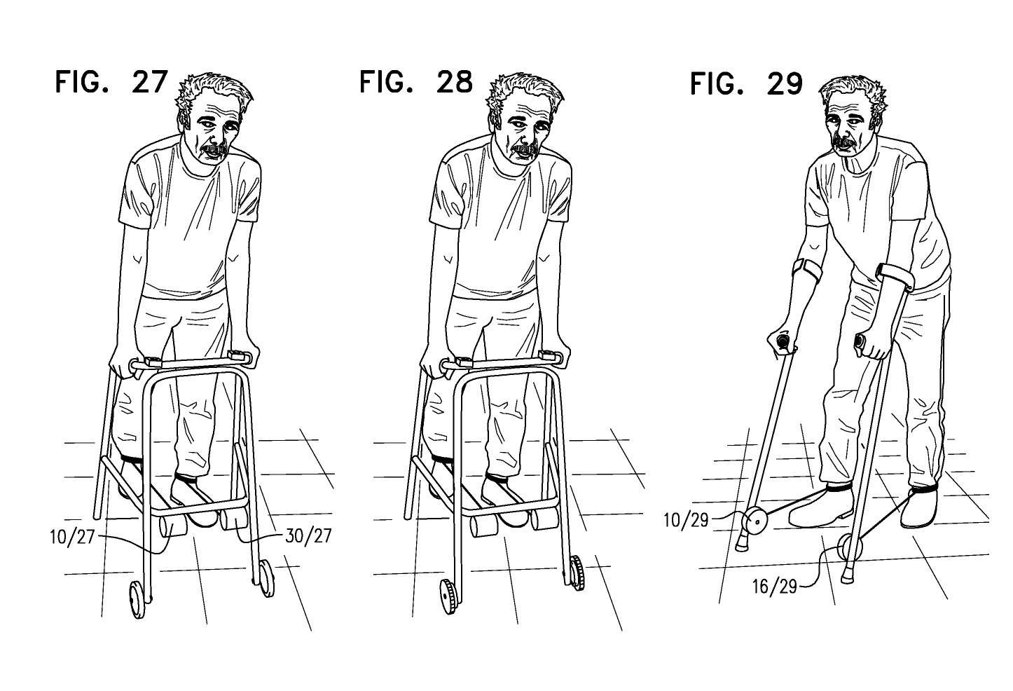

FIG. 28 presents schematic isometric front view of a disabled person with a walker. The walker includes two systems which drive the disabled person's legs and help him walk, and two systems which drive the walker's front wheels.

FIG. 29 presents schematic isometric front view of a disabled person using two stilts. A system which drives the disabled person's leg and helps him walk is attached to each stilt.

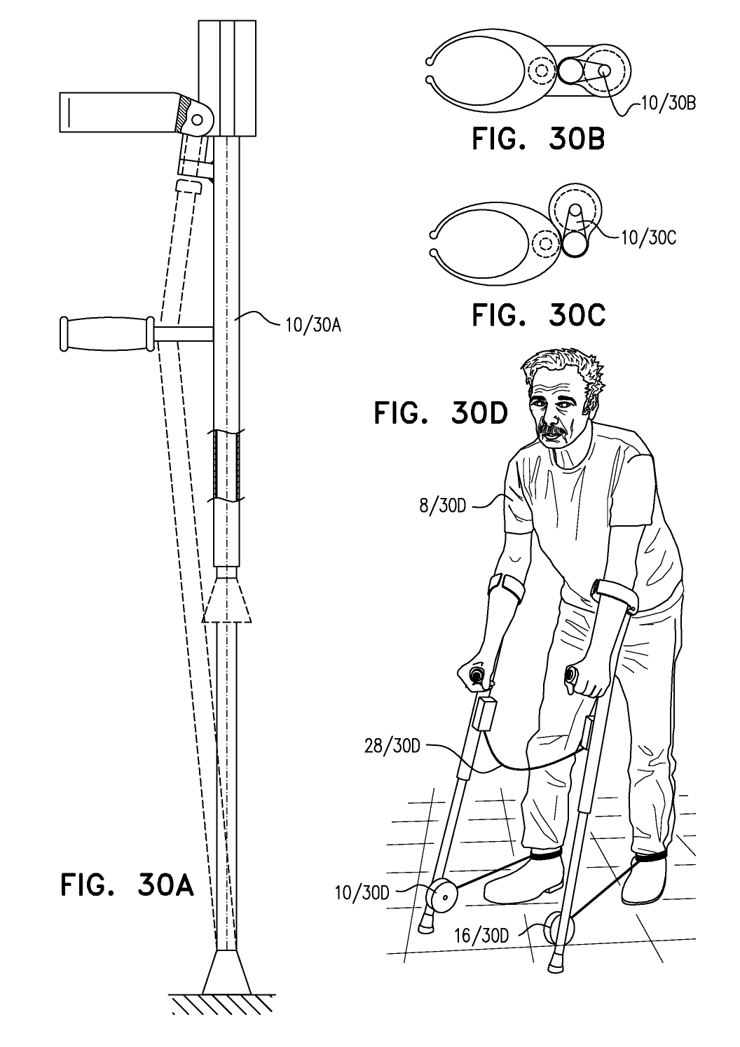

FIG. 30A is schematic side view of the component in charge of the stilt's elongation in a right telescopic stilt. At the left, a standard stilt is presented, labeled with a hatched line. It's obvious that the handle and arm grip locations of the telescopic stilt are similar to those at the standard stilt.

FIG. 30B is schematic partial top view of the telescopic mechanism driving system. The driving system is located behind the stilt, and therefore is suitable for use in both legs (right or left).

FIG. 30C is schematic partial Top view of the driving system of the telescopic mechanism. The driving system is located at the right stilt's right side, in order to prevent it from disturbing most of the right hand motions.

FIG. 30D presents schematic isometric front view of a disabled person using two stilts, containing two driving systems for the disables person's legs, which help him walk with a half automatic—half manual control. Both stilts are telescopic, and there's a possibility to activate one stilt by an automatic command sent by the other stilt by cable.

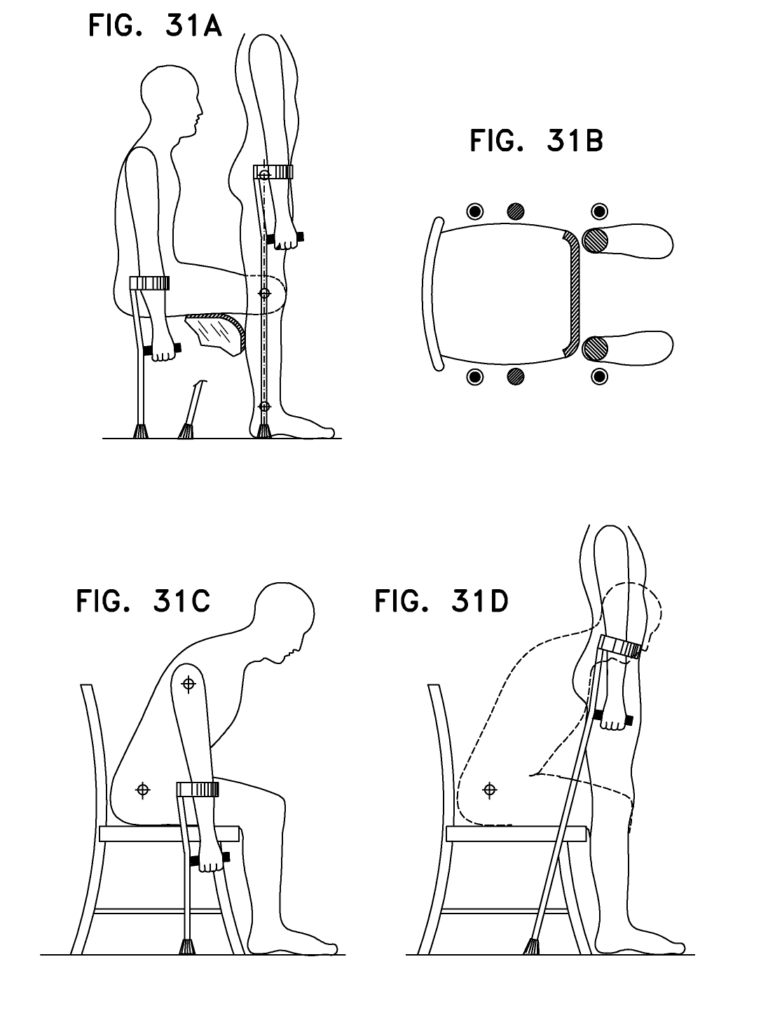

FIG. 31A is schematic side view of a disabled person standing and sitting on a standard chair, using the telescopic tilts. In addition, the bottom part of a stilt in interim status (the status between sitting and standing) is presented.

FIG. 31B is schematic top view of the situation described in figure

FIG. 31C is schematic side view of a disabled person sitting on a standard chair and bending forward, preparing to stand up. In this situation, the telescopic stilts are gathered in, allowing the disabled person to straighten his hands, and accordingly lift his weight by his hand muscles with minimal effort.

FIG. 31D is schematic side view of a chair and a disabled person who had reached to standing position with the help of the telescopic stilts. The stilts had lengthened and lifted the person up, using his “hands straightening” position, from sitting position to standing position. During the whole process, the stilts remained at the same place, touching the ground. The stilts can be similar to the ones presented in FIG. 30D.

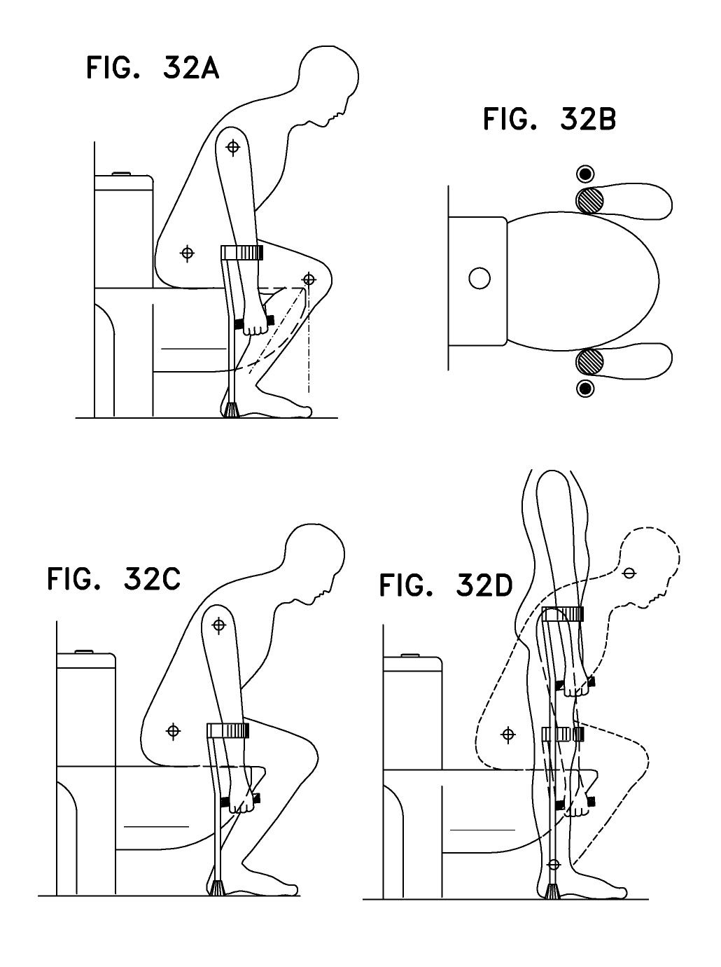

FIG. 32A is schematic side view of a disabled person sitting on a lavatory seat and preparing to stand up. In this situation, the stilts are gathered in, allowing the disabled person to reach to the “hands straightening” position. The disabled persons' legs are located under his knees, drawn back as much as possible.

FIG. 32B is schematic top Section XXXIIB view of the situation presented in FIG. 32A.

FIG. 32C is schematic side view of a disabled person sitting on a lavatory seat and bending forward, preparing to stand up, after resetting the telescopic systems. This resetting process is called “homing”.

FIG. 32D is schematic side view of a disabled person who had reached to standing position with the help of the telescopic stilts. The stilts had lengthened and lifted the person up, using his straightened hands. During the whole process, the stilts remained at the same place, touching the ground. The stilts can be similar to the ones presented in FIG. 30D.

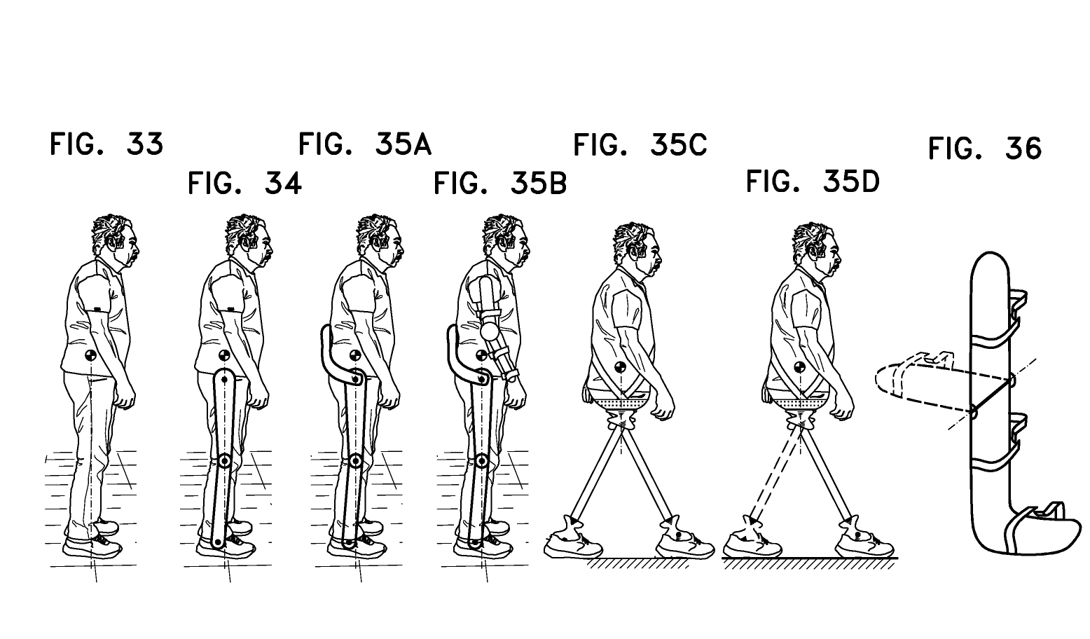

FIGS. 33 to 36 The walking ability will by the help of a foot drive mechanisms or force by cable or others mentioned in this document.

FIG. 33 is schematic side view of a disabled person which cannot walk, but has an ability to stand. Assembling a driving system to the bottom part of his legs will allow him to walk. With the help of a walker, stilts or a “double handled stilt”, the disabled person will be able to sit on a chair or a lavatory, and stand up.

FIG. 34 is schematic side view of a disabled person who's legs are paralyzed (typical for poliomyelitis). The disabled person will be able to walk, stand up or sit down on a chair or a lavatory seat with the instruments described in this document. One option of walking is by using the help of another person, which will support the disabled person stability and not his weight.

FIG. 35A is schematic side view of a disabled or paraplegic person. The disabled person will be able to walk, stand up or sit down on a chair or a lavatory seat with the instruments described in this document. One option of walking is by using the help of another person, which will support the disabled person stability and not his weight.

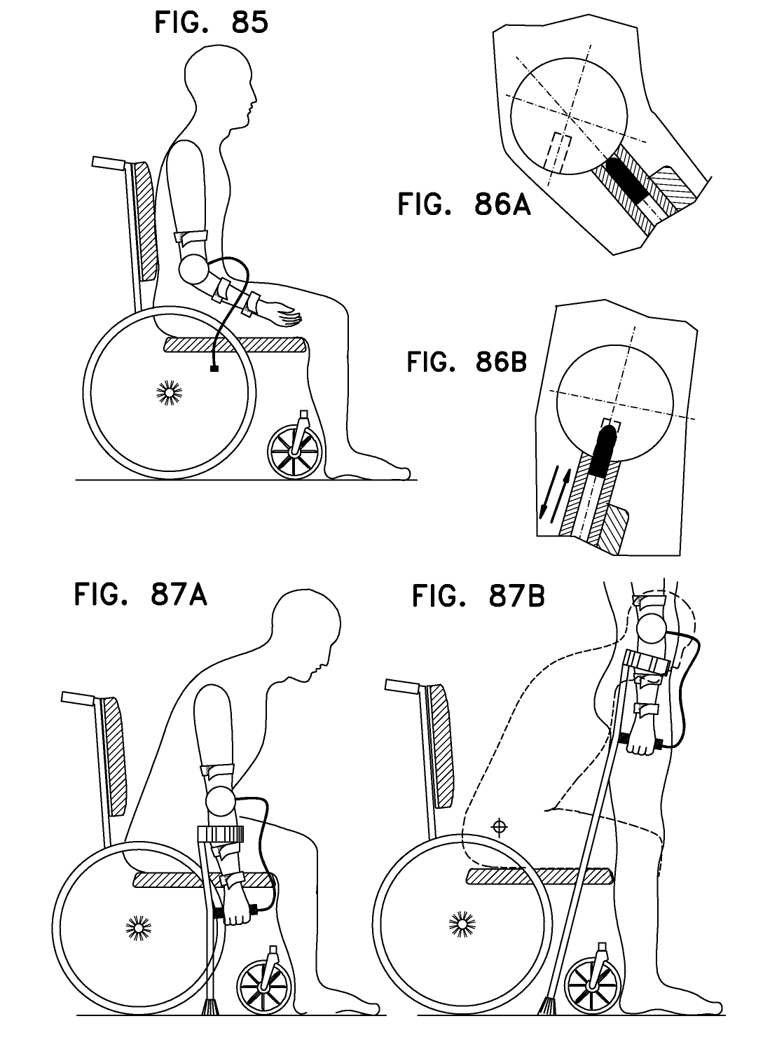

FIG. 35B is schematic side view of a disabled or paraplegic person. (see FIGS. 85 to 87B and 114-142) One option of walking is by using the help of another person, which will support the disabled person stability and not his weight.

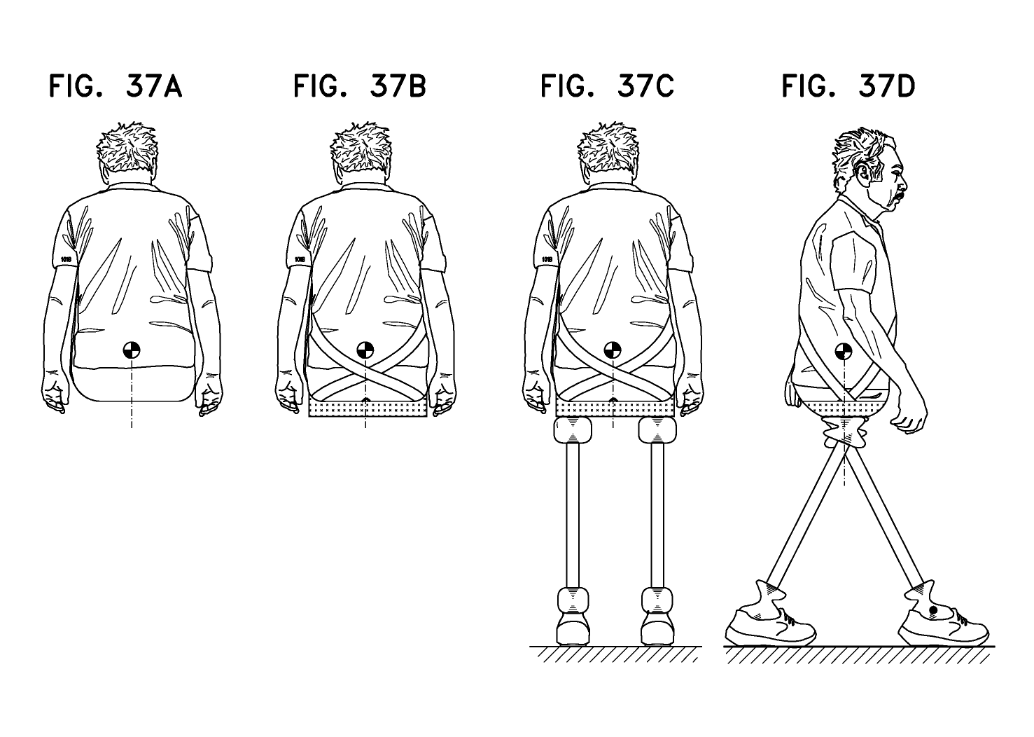

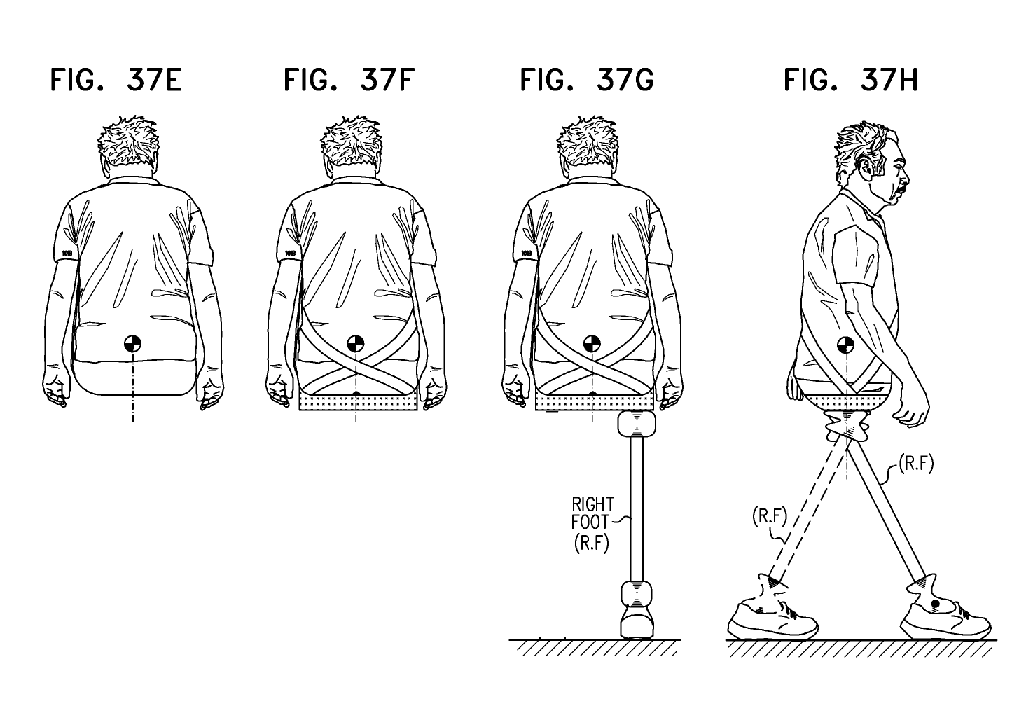

FIG. 35C is schematic side view of a disabled person (see FIGS. 37A-37D). One option of walking is by using the help of another person, which will support the disabled person stability and not his weight.

FIG. 35D is schematic side view of a disabled person (see FIGS. 37E 37H). One option of walking is by using the help of another person, which will support the disabled person stability and not his weight.

FIG. 36 is schematic Isometric view of an auxiliary device which fixates the leg in a straightened position for walking or standing, or in right angle position for sitting. The legs might either be bare or with shoe

FIG. 37A is schematic back view of a disabled person who's legs are amputated to his pelvis.

FIG. 37B is schematic back view of a disabled person who's legs are amputated to his pelvis, with a adapter attached to the bottom part of his body.

FIG. 37C is schematic back view of a disabled person who's legs are amputated to his pelvis, with a adapter attached to the bottom part of his body. Two prosthesis legs, consisted as an example of wooden rods with two elastic connectors attached to the ends of each rod.

FIG. 37D is schematic side view of a disabled person who's legs are amputated to his pelvis, with a adapter attached to the bottom part of his body. Two prosthesis legs, consisted of wooden rods with two elastic connectors attached to the ends of each rod. The person walks thanks to forces applied on his legs bottoms, with the aid of a balancing device which is not presented in the figure. One option of walking is by using the help of another person, which will support the disabled person stability and not his weight. The walking ability will by the help of a foot drive mechanisms or force by cable or others mentioned in this document.

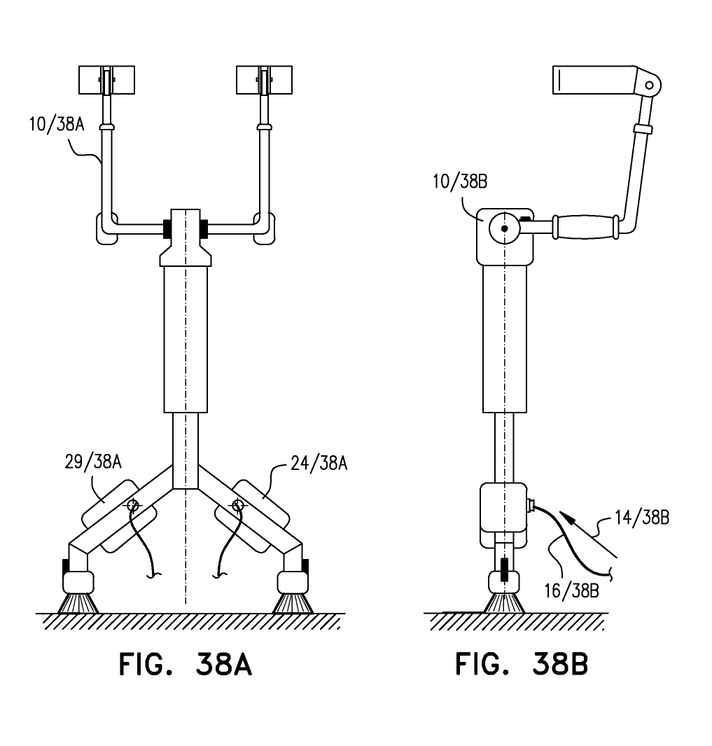

FIGS. 37E to 37H is understood from FIGS. 37A to 37D FIG. 38A is schematic front view of a telescopic “double handled stilt”10/38A, containing two 10/38A and 24/38A systems which apply forces 14/38B on the legs with cable 16/38 and make them move forward and bearing of the stilt's bottoms with nearly vertical Axis.

FIG. 38B is schematic side view of the telescopic “double handled stilt” 10/38B defined in FIG. 38A.

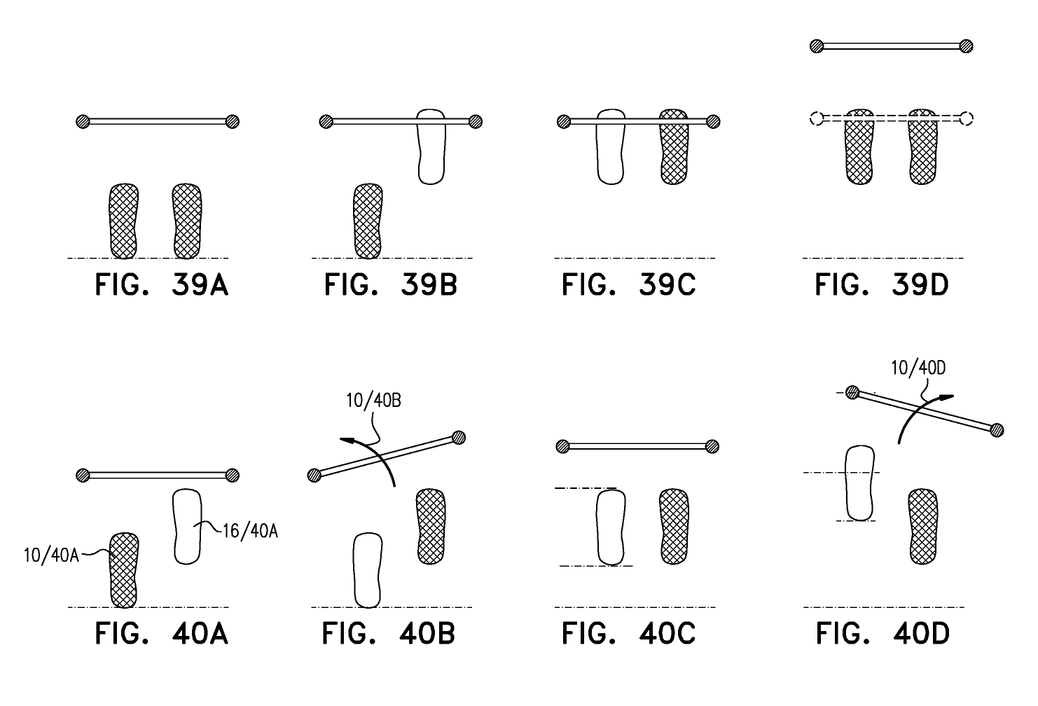

FIGS. 39A to 39D are schematic descriptions of the traces of a disabled person using a walker. At the beginning of the walking process, as well as it's end, the person's legs are located near to each other.

FIG. 40A presents schematic descriptions of the traces created by a disabled person using a “double handled stilt”. As the walking process begins, the disabled person's left leg functions as a “weight support leg” 10/40A (labeled with cross lines), while his right leg functions as a “free leg” 16/40A (labeled with a uniform fill) and is outstretched forward.

FIG. 40B presents schematic descriptions of the traces created by a disabled person using a “double handled stilt” with a counterclockwise (CCW) 10/40B advanced rotary motion. In the second stage of the walking process, the person's right leg functions as a “weight support leg” and is outstretched forward, and his left leg functions as a “free leg”.

FIG. 40C presents schematic descriptions of the disabled person's right leg traces, during a dynamic stage of his walking process with a “double handled stilt”. In this stage, the disabled person's left leg functions as a “free leg”, and is moving forward without touching the ground. During this stage, the “double handled stilt” is moved forward.

FIG. 40D presents schematic descriptions the traces created by a disabled person using a “double handled stilt” with a clockwise (CW) 10/40D advanced rotary motion. The person is at the ending of the walking procedure. The persons' right leg functions as a “weight support leg”, and his left leg, which functions as a “free leg”, is outstretched forward. In fact, the disabled person's legs position is symmetric with the initial position described in FIG. 40A.

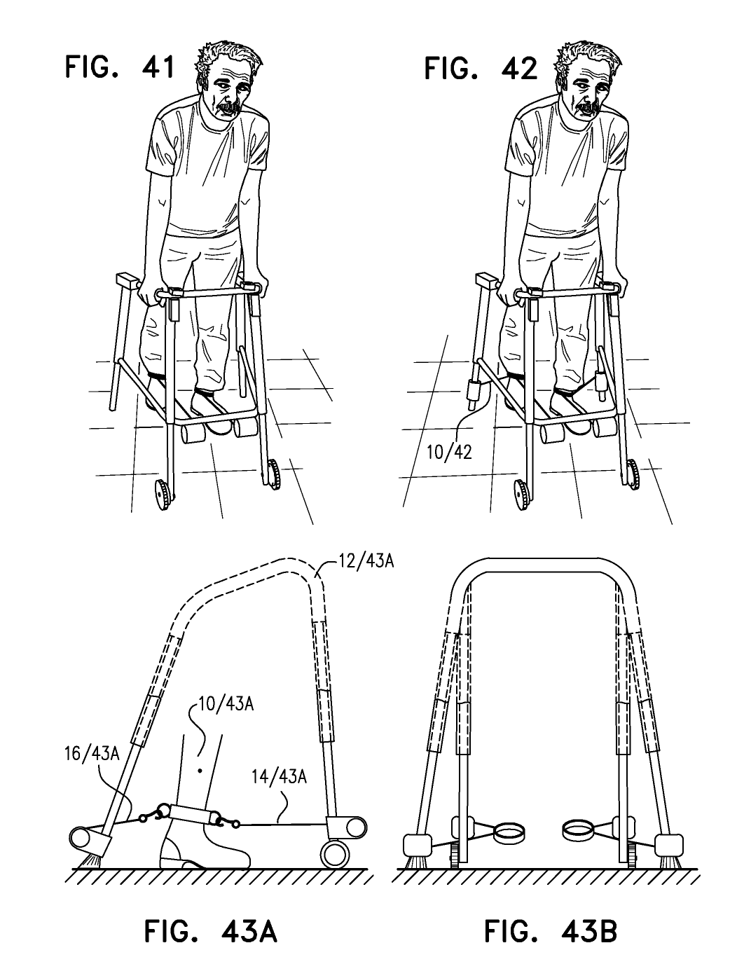

FIG. 41 is schematic Isometric view of a disabled person with a telescopic walker or as an option none telescopic walker, containing two systems which drive the disabled person's legs and help him move forward. The walker as an option controls the 4 telescopic legs, and other well known activities from the control and robotics fields.

FIG. 42 presents schematic isometric front view of a disabled person with none telescopic walker 10/42 (as an example) attached with two rear systems which apply force on the legs towards back. Walking backwards is important mainly for the purpose of reaching to a chair or a lavatory seat. This option increases the disabled person's ability of being independent, a matter of great importance, especially in the toilets.

FIG. 43A presents schematic side view for a disabled person 10/43A using the telescopic walker 12/43A or as an option none telescopic walker described in FIG. 42. The figure presents the two cables which are connected to the disabled person's leg; one cable 14/43A applies force to draw the leg forward, and the other one applies force to draw it backwards.

FIG. 43B presents schematic front view for a disabled person using the telescopic walker or as an option none telescopic walker described in FIG. 42. The figure presents the cables applying forces to move the legs forward and backward, attached with rings which to the disabled person inserts his legs.

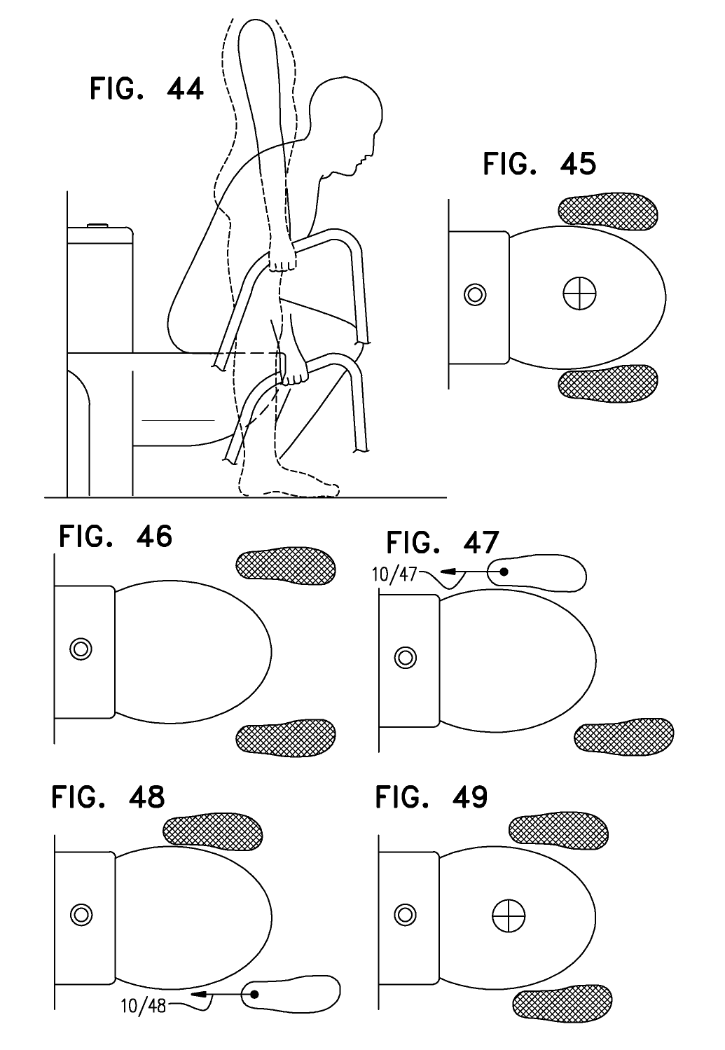

FIG. 44 is schematic side view of a disabled person who stands in front of the lavatory seat after walking there backwards. Next, the person sits with the help of the telescopic walker and his straightened hands. During this process, the person carries his own weight with negligible effort, thanks to his being in the “hands straightening” position.

FIG. 45 is schematic top view of the situation presented in FIG. 44. The disabled person's traces are presented, while both of the legs serve as “weight support legs”.

FIG. 46 is schematic top view of a disabled person's traces at the beginning of his sitting process on the lavatory seat. At this stage, the person is standing.

FIG. 47 is schematic top view of a disabled person's traces while the person stands, his right leg functions as a “weight support leg” and his left leg 10/47 moves backwards, functioning as a “free leg”.

FIG. 48 is schematic top view of a disabled person's traces while the person stands, his right leg 1/48 has reached to its' destination and functions as a “weight support leg”.

FIG. 49 is schematic top view of a disabled person's traces while both his legs function as “weight support legs”. Next, the person sits on the lavatory seat with the help of the telescopic walker. Clearly, the inverse process will lift the disabled person from the lavatory seat.

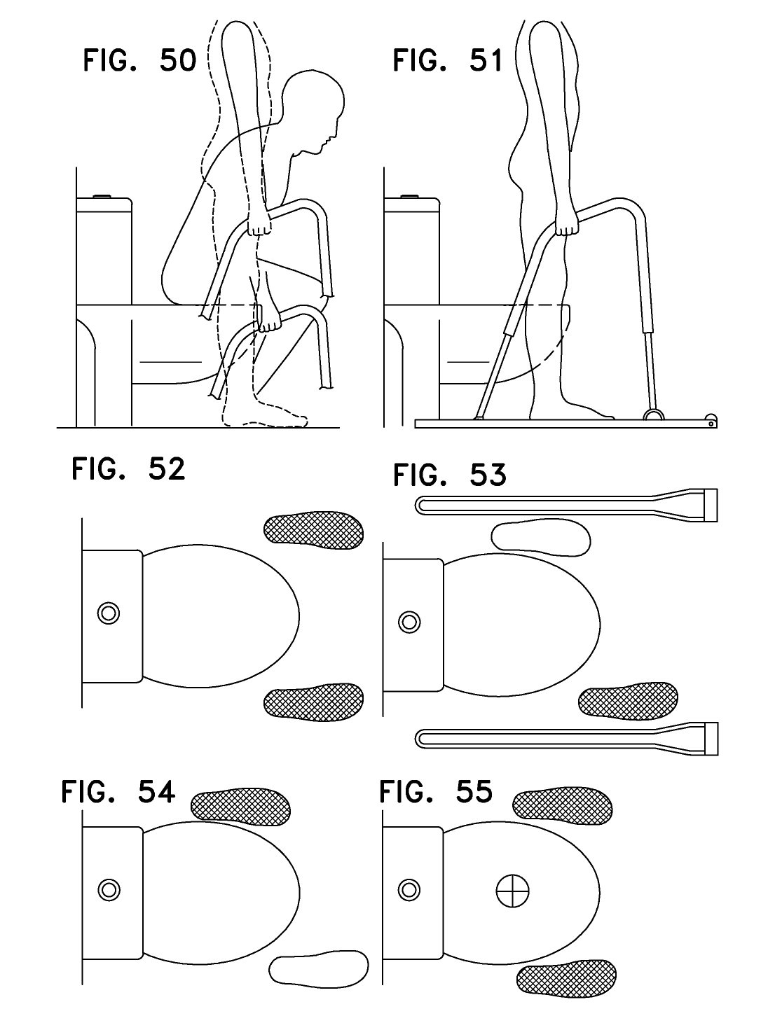

FIGS. 50 to 55 present schematic descriptions of an auxiliary system for disabled people of varying disability levels, which assist them to stand up and sit down on the lavatory seat. This requirement is typical for senior citizens homes and other nursing businesses. Two rails with end travel stops, each containing a designated telescopic walker, are located in front of the lavatory seat. The system is designed to be used by a disabled person after reaching it with or without help from another person/system. In addition, if a disabled person wishes to use his own telescopic walker instead of the above described system, it is possible to remove the designed telescopic walker. Apart of the rails and the designated walker attached to the system, it is similar to the one described in FIGS. 44-49.

FIG. 50 presents schematic side view descriptions of a disabled man standing on his legs (labeled with a hatched line). Next, the person begins the sitting process with the help of the telescopic walker. At the end of the process, the person reaches to sitting position (labeled with a continuous line).

FIG. 51 presents schematic side view descriptions of a disabled man standing on his legs, his back turns to the lavatory seat. The person uses the telescopic walker, which is in located in the rails, in order to begin the sitting process on the lavatory chair.

FIG. 52 is schematic top view of the situation described in FIG. 45. The figure describes the beginning of the disabled person's sitting process on a lavatory seat. At this stage, the person is standing.

FIG. 53 is schematic top view of a disabled person's traces, when the person stands, his right leg functions as a “weight support leg” and his left leg moves backwards, functioning as a “free leg”. This figure also presents the rails.

FIG. 54 is schematic top view of a disabled person's traces while the person stands and his right leg functions as a “weight support leg”, after reaching to its destined location. At this stage, the person is standing.

FIG. 55 is schematic top view of a disabled person's traces while the person stands and both of his legs function as “weight support legs”. Next, the person sits on the lavatory seat with the help of the telescopic walker. Clearly, the inverse process will change the disabled person position from sitting to standing.

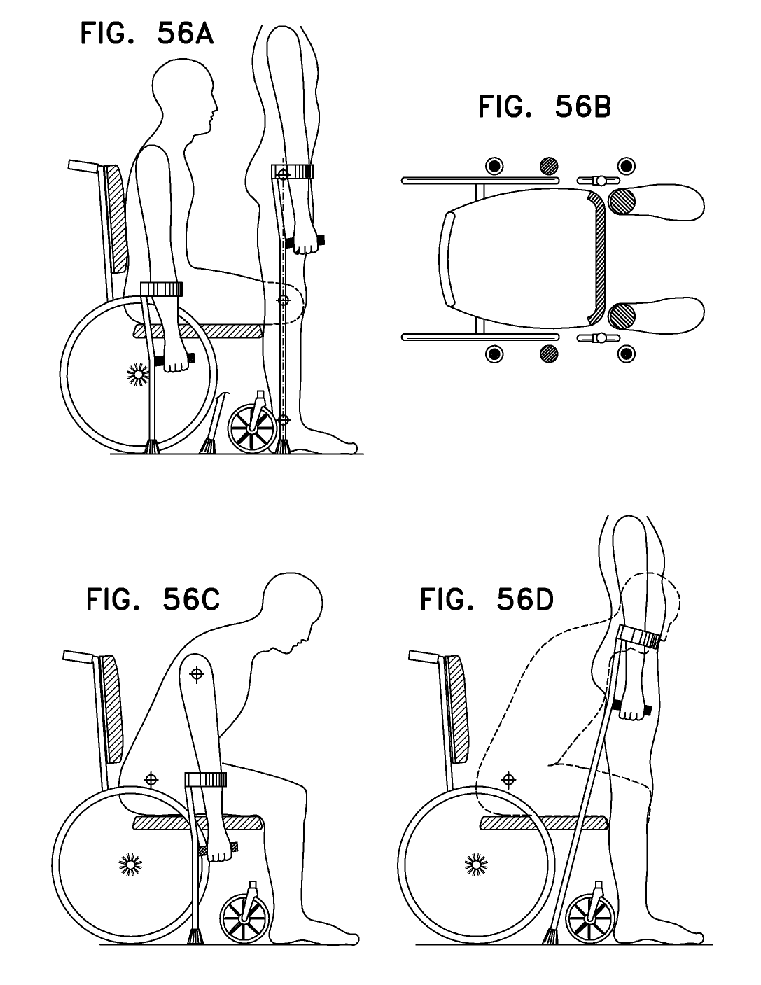

FIG. 56A is schematic side view of a disabled person standing and sitting on a wheel chair, using the telescopic crutches to transit from standing position to sitting position. In addition, the bottom part of a crutch in an interim status (the status between sitting and standing) is presented.

FIG. 56B is schematic top view of the situation described in FIG. 56A.

FIG. 56C is a schematic side view of a disabled person sitting on a wheel chair and bending forward, preparing to stand up. In this situation, the telescopic crutches are gathered in, allowing the disabled person to straighten his hands, and accordingly to lift his weight by his hand muscles using a minimal effort.

FIG. 56D is schematic side view of a wheel chair and a disabled person, which had reached to standing position using the telescopic crutches. During this process, the crutches remained at the same place, and constantly touched the ground. The crutches can be similar to the ones described in FIG. 30D.

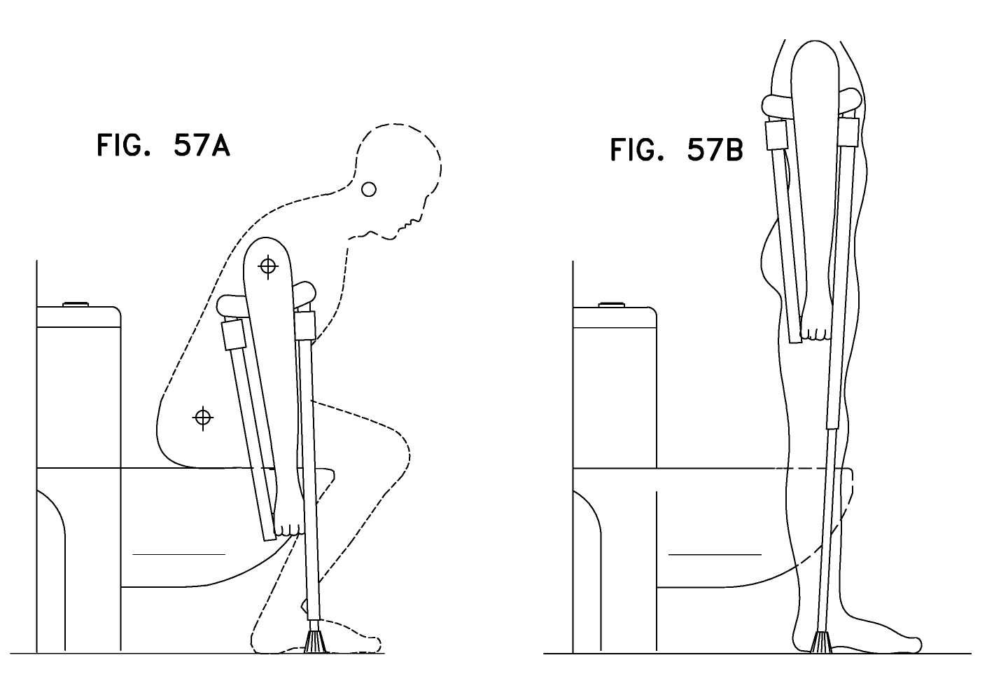

FIG. 57A presents schematic side view of a disabled person using high crutches. The person is preparing to stand up.

FIG. 57B presents schematic side view of a disabled person using high crutches. The person is standing after rising up from sitting position, and is supported by the crutches.

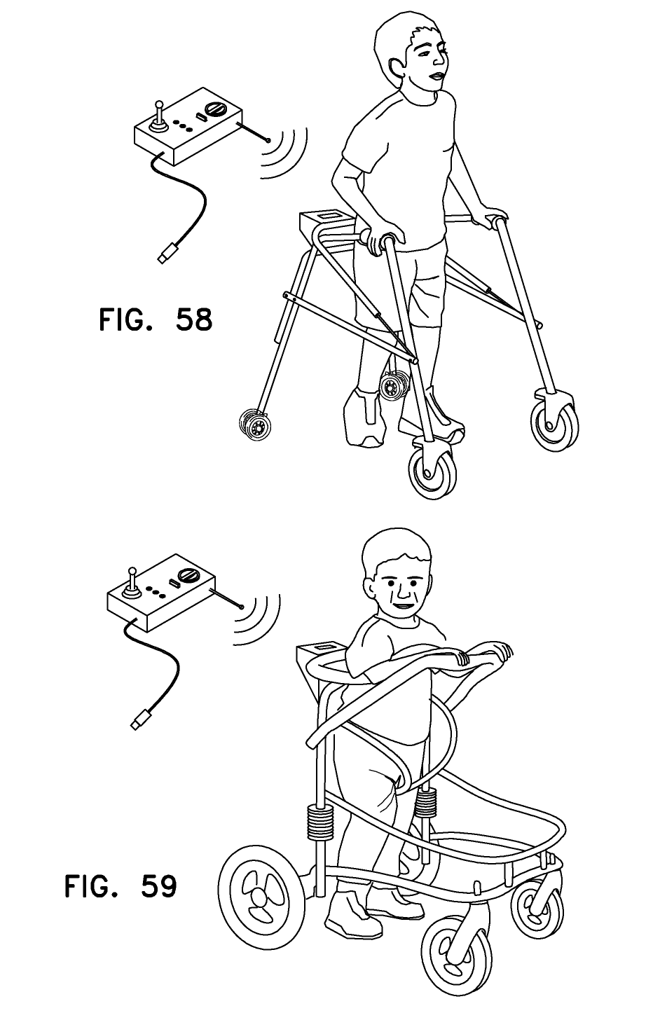

FIGS. 58 and 59 present schematic isometric front view of a care taking walker for kids. Every sub-system containing moving components can be mechanized with a servo actuators. All of the signals from the different sensors can be received and saved in a DB, sorted by a child's name. The data's analysis and its usage are described elsewhere in this document. As an option, a physiotherapist may dictate exercises' modifications with a control box, using wired or wireless connection.

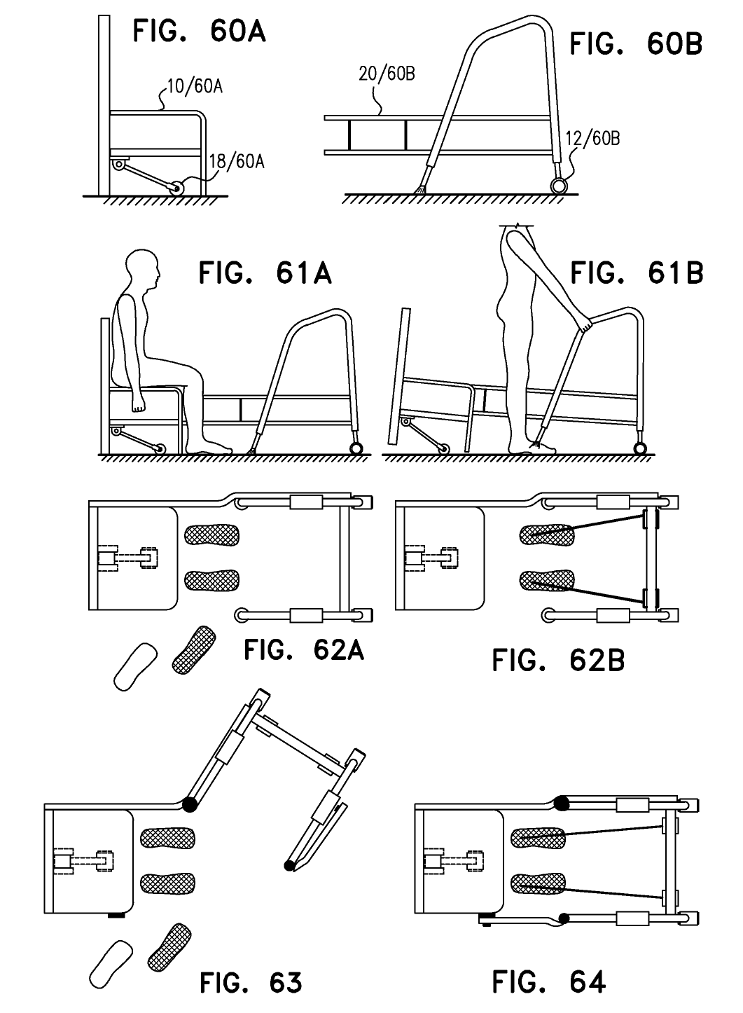

FIGS. 60A to 64 are schematic side view descriptions of a system aimed to practice a disabled person's walking with a walker. The system contains a chair 10/60A which is connected to walker. In case the disabled person stumbles, he will fall into the chair without getting hurt. In fact, the system protects disabled people from harming falls. The system contains 3 wheels; two frontal wheels 12/60B connected to the walker, and one wheel 18/60B located under the chair. When the person using the system stands, the chair will rise up and the person will be able to easily move forward. When the person sits, the chair will return down to the ground.

FIG. 60A presents schematic side view descriptions of a chair whose bottom part is attached with an arm containing a strongly stressed spring. The arm is able to lift the chair up. The arms terminate with a caster wheel.

FIG. 60B presents schematic side view descriptions of a walker joined with rods 20/60B, which are aimed to connect the walker to a chair. The rods will only be connected to one side of the walker (In this case, the left side).

FIGS. 61A and 12B presents schematic side view descriptions of a disabled person sitting on the chair after a “fall” or a volitional sitting.

FIGS. 62A and 62B present schematic side view descriptions of a disabled person standing, causing the chair to rise up and “float” on the springy arm and the wheel.

FIG. 63 presents schematic top view descriptions of the system. The figure presents the trails of a disabled person entering the walker.

FIG. 64 presents schematic top view descriptions of the walker system, which allows a disabled person to walk by applying forces on his bottom parts, as described elsewhere in this document.

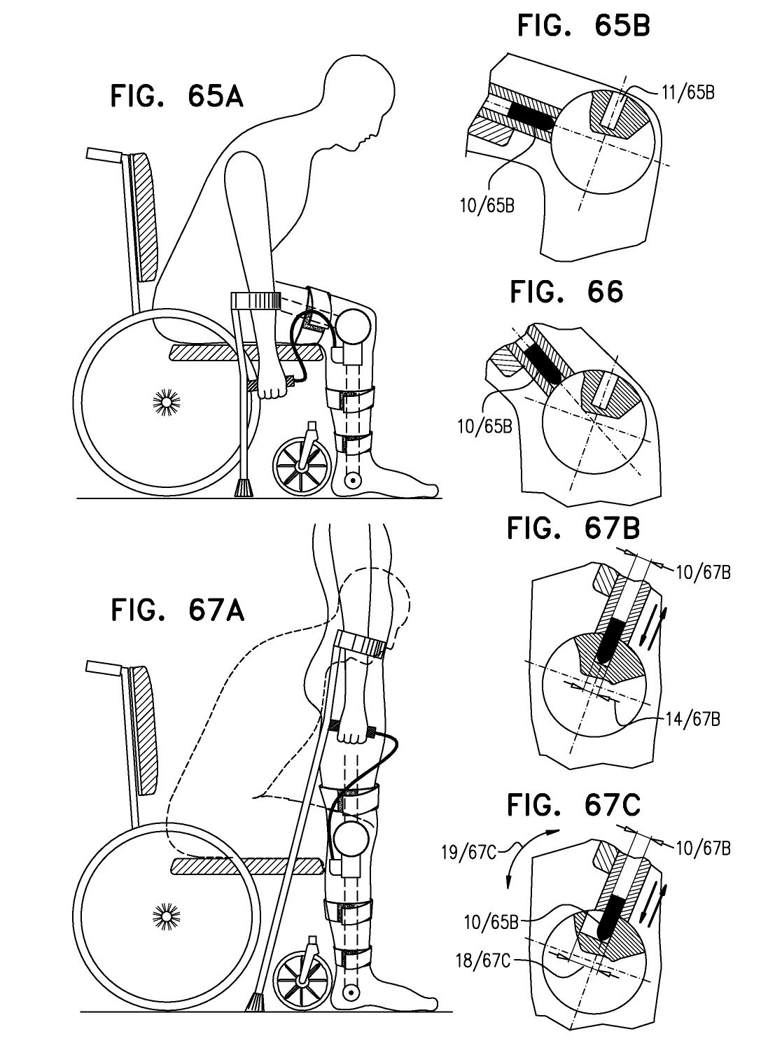

FIGS. 65A to 67B presents schematic side view of a disabled person transiting from sitting position to standing position. When the person arrives to standing position, he needs to “lock” his leg/legs straight, using an electric or a mechanic lock. The locking process will be automatic thanks to the mechanism described in this figure. When the person transits from standing position to sitting position, he needs to open the lock, but can't reach the lock with his hands. The mechanism described in this figure allows the person to open the lock electrically or mechanically while standing, and in fact enables him to sit. The person will be able to activate this mechanism with his hands. The mechanism is described in this figure with respect to crutches, but is similar for all of the other systems demanding transition from standing position to sitting position and inversely as described in this document (such as a wheel chair). This mechanism will suit many other “seats”, some described in this document, such as an ordinary chair, a bed or a car seat. In particular, the mechanism is important for the case of rising up and sitting down on a lavatory seat. In this case, the described device will reduce the disabled person's dependence of another assisting person, and therefor will help him keep his privacy.

FIG. 65A presents schematic side view descriptions of a disabled person sitting with a leg-straightening device, similar to other devices which are used by kids with poliomyelitis or by paraplegic people. The device is located at the person's knee, and its axis is close to the knee joint. The cable which operates the mechanism, which can be mechanic, electric, or electric with a mechanic backup, is emphasized.

FIG. 65B presents schematic side view descriptions of the mechanism when the disabled person is in sitting position. Locker 10/67B slot 14/67B

FIG. 66 presents schematic side view descriptions of the mechanism when the disabled person is transiting from sitting position to standing position. The lock tangentially slips over the arc.

FIG. 67A presents schematic side view descriptions of a disabled person in standing position.

FIG. 67B presents schematic side view descriptions of a disabled person in standing position. The lock had reached to its destined position and is sliding into the locking slot, and a full lock results.

FIG. 67C presents schematic side view descriptions of a disabled person in standing position. The lock had reached to its destined position and is sliding into the locking slot 18/67C, and a full lock results. The width of slot 18/67C is more than slit 10/67B. This enable rotation relative of the two parts of the knee in direction 19/67C. This relative motion prevents “sticking” of the knee when walking or other motion of the disable.

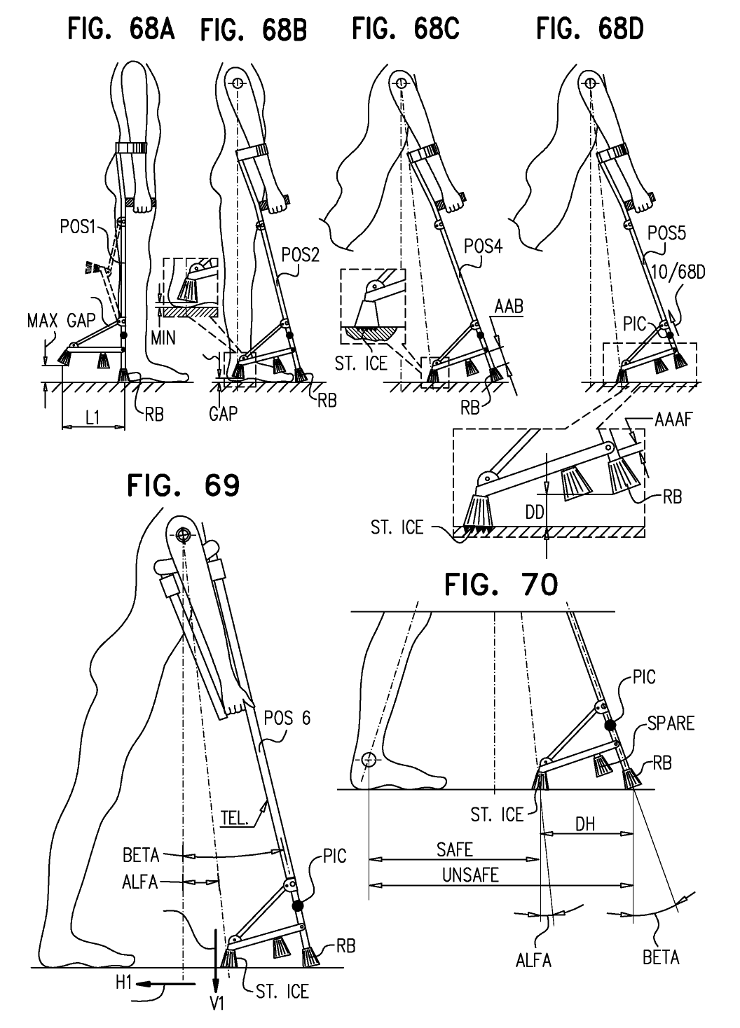

FIGS. 68A to 70 are schematic side view descriptions of a disabled person using a crutch/two crutches preventing him from skidding. As an example, a rubber support is attached to the crutch's back. The rubber support is designed never to touches the ground during a normal safe walk, as described in FIGS. 68A and 68B. When the disabled person skids, as described in FIG. 68C, the rubber meets the ground, supporting much of the person's weight and preventing him from falling.

Many experiments showed that the distance between the front rubber and the back rubber cause an additional lock which entirely prevents skidding and the resulting falling. In the experimental system, the rubber support was attached to a rotary axis, and could be folded in to the crutch. As mentioned before, as long as the crutch is moving safely, the rubber support's back will never touch the ground. An additional experiment examined the mechanism's ability to help a disabled person walk on ice. Walking on ice is very dangerous for disabled people, and therefore many of them can't commit this action. In the experiment, a rubber support was attached to the crutch's front. The back support was fitted with a spiked a component, which could easily pierce into the ice, instead of a rubber. While walking inside the house, the spikes didn't touch the ground. Outdoors on the ice, on skid, the spikes pierced into the ground, halting the skid and preventing a fall.

FIG. 69 presents schematic side view descriptions of a disabled person on ice after the system with ST. ICE as per detail of FIG. 70 had stopped his skidding and prevented him from falling.

FIG. 70 presents' schematic enlarged side view descriptions of the system described in FIG. 69. It is seen that the angle between the back support component and the ground is almost two times smaller than the angle between the frontal support component and the ground. A physical analysis validates the sufficiency of this to stop the skidding. Some experiments exhibited that disabled people get quickly familiar to the back support, especially for safe ice walk.

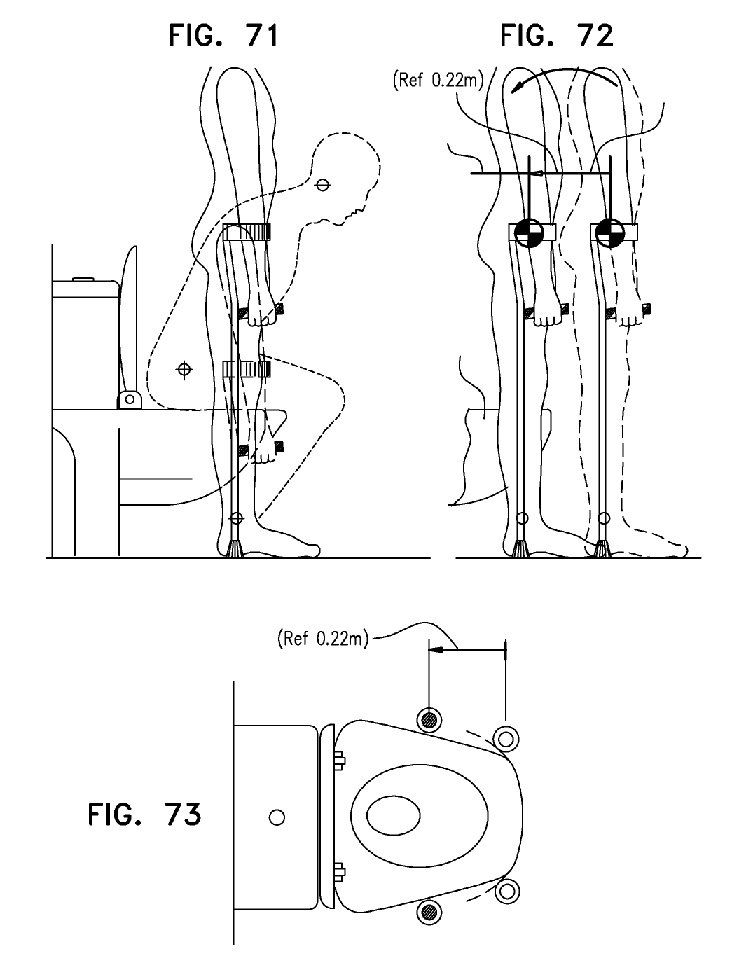

FIGS. 71 to 73 are schematic descriptions of a disabled person transiting form sitting position to standing position, using a lavatory seat adapted to disabled people. The figures present the advantages of this lavatory seat.

FIG. 71 presents schematic side view descriptions of a disabled person rising up to standing position from an lavatory seat adapted to disabled people.

FIG. 72 presents schematic side view descriptions of the disabled person's ability to move backwards, at the arrow direction. Moving backwards brings the person to a much better position for standing up. The only limit for walking backwards is when the person's legs reach to the lavatory seat.

FIG. 73 presents schematic top view descriptions of a lavatory seat adapted to disabled people. Usually, the upper contour of ordinary lavatory seats is oval. These aesthetic sits are fit for healthy people and are not optimal for disabled people with difficulties in standing up. The upper contours of a lavatory seat in the example, which is adapted to disabled people is more sharp-angled, thus enabling a disabled person to move back w.r.t the lavatory seat further than it's possible in an ordinary lavatory seat (see dimensions—Ref 0.22 m). This situation is described in FIGS. 72 and 73.

A numerical example:

For 80 kg person, the torque advantage in 22 cm backshift for from to standing transition is

M=80*0.22=17.6 Kg*m

Just to perceive the magnitude of the saved effort, this is approximately the required torque for step climbing, known to be extremely challenging for disabled people. For many disabled people, this saved torque makes the difference between self-powered or assisted standing.

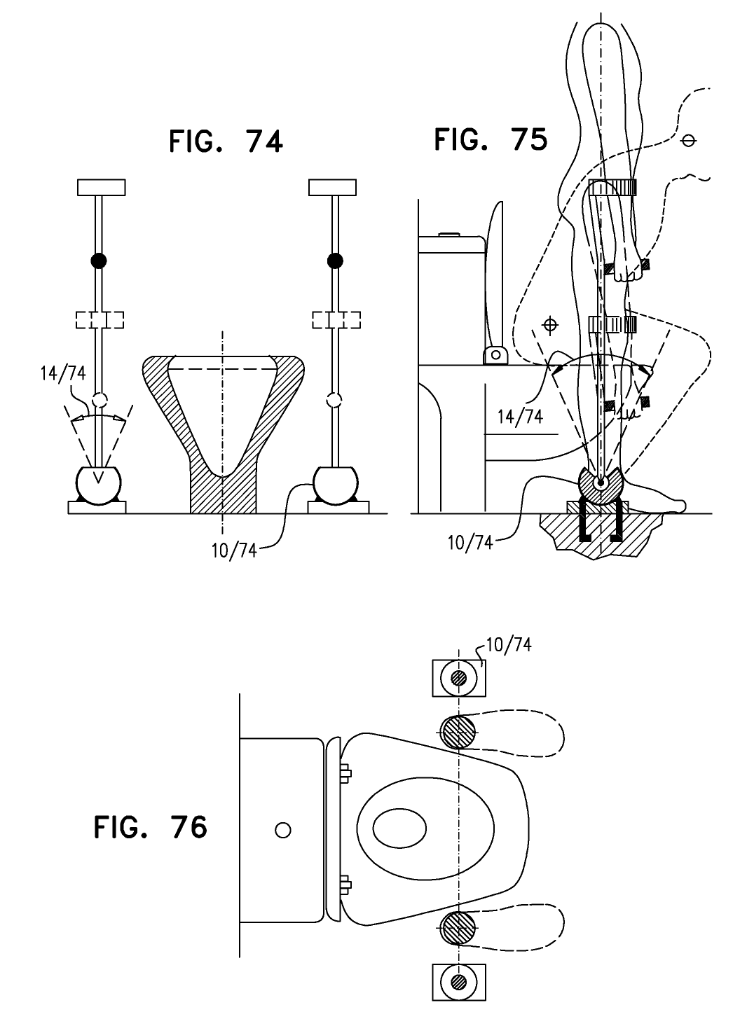

FIGS. 74 to 76 are schematic descriptions of a disabled person transiting from sitting position to standing position with the help of crutches which are, at this example, telescopic, fixed to the ground 10/45 and free to perform conical motion 14/74 at the depicted angles. The vertex of the angular motion is for example a ball joint, angle limited by its housing.

The angular motion allows many body and hand postures on transiting between sitting and standing. This arrangement may serve people who can walk but find the sitting and the rising actions difficult.

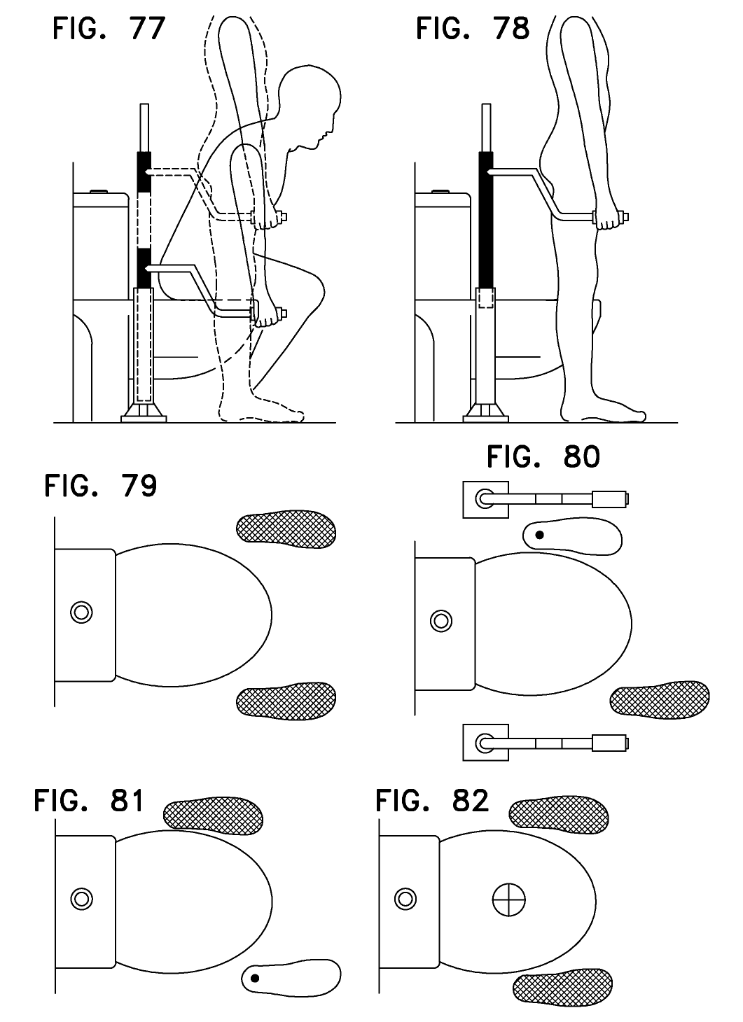

FIGS. 77 to 84 are schematic descriptions of a disabled person using a banister for each hand. The explanation is similar to the explanations of FIGS. 74 to 76, with the exception that instead of telescopic crutches, the banisters are ascending or descending.

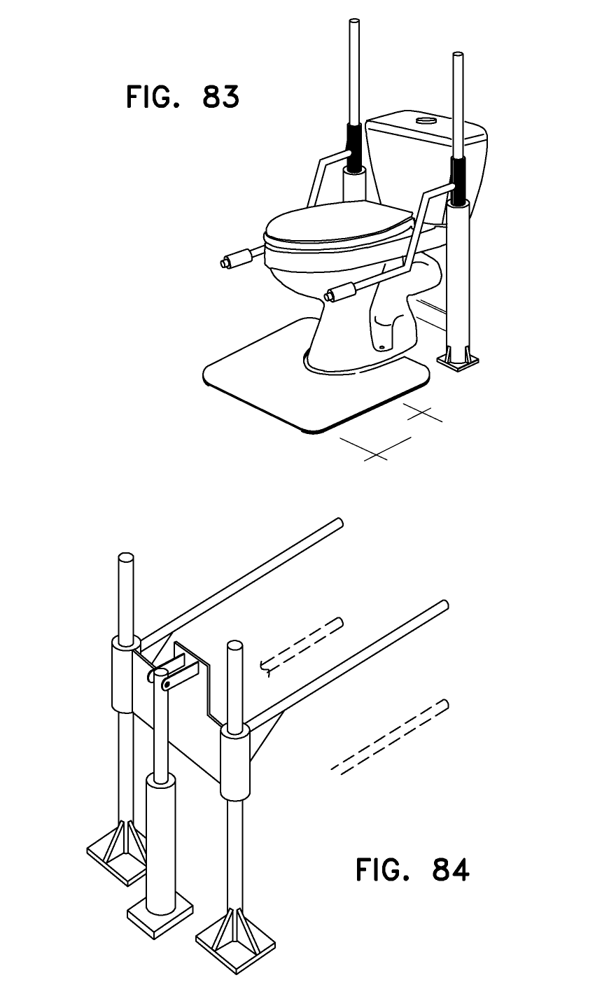

In FIG. 83, one actuator drives the ascending or the descending of the banisters along the guides. In FIG. 84, two actuators, built in with the guides, perform the ascending-descending.

The machinery details are implemented by standard engineering practices.

FIGS. 85 to 87B are schematic side view descriptions of a disabled person moving from a sitting position in a wheelchair to a standing position, and later on, from a standing position to sitting in a wheelchair. In this process, the disabled person has to respectively lock and remove the lock located at the knee region. The drawing shows a mechanical device enabling the disabled person do so without the need to bend towards his knee. The device is mechanical or electro-mechanical causing the operation of the lock.

FIGS. 86A to 86B Present the automatic locking causing the lock to reach the locking slot

FIG. 86A Presents one of the options for disconnecting the lock, making it possible to bend the leg for the purpose of sitting down.

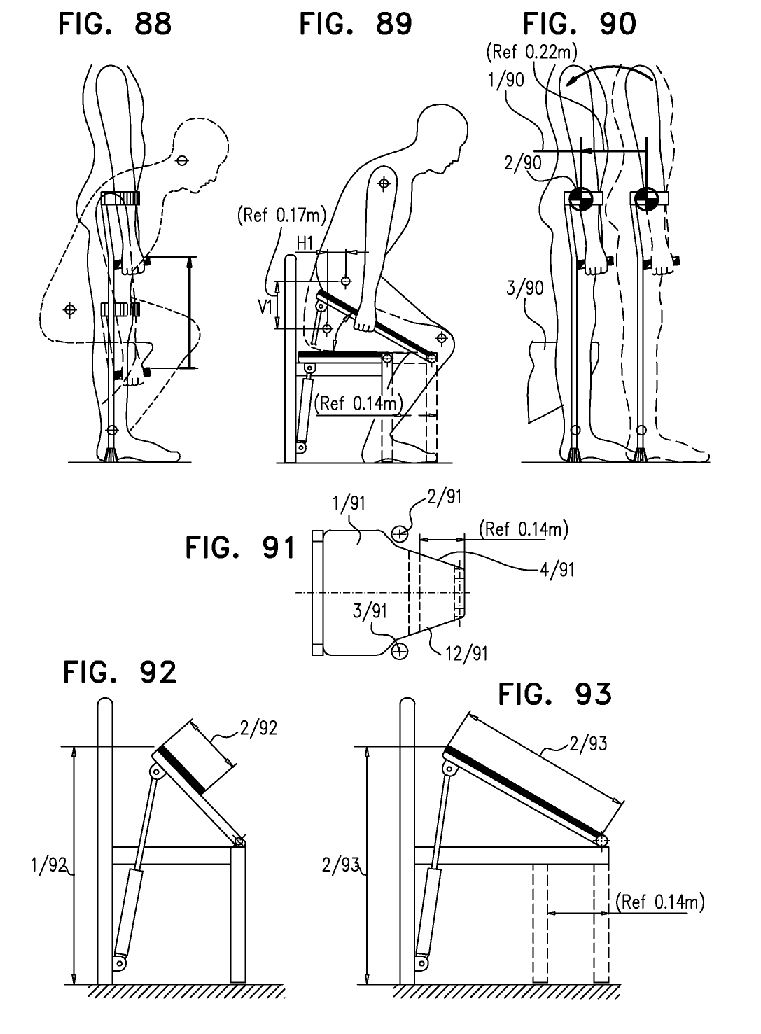

FIGS. 88 to 93 Are schematic view descriptions, comparing a regular seat to the innovative seat, which is longer in the horizontal direction by 0.14 m 10/91, and narrower in a sampled design of a trapeze 12/91, or any other one that would make it possible to sit whatever the trapeze is capable of. The angular lifting of the seat is carried out as is customary in lifting of this kind, when spring or electro-mechanical mechanisms are used. The process of assisting a disabled person in the transition from sitting to standing is compared to the assistance involved in part of the process of the transition from standing to sitting. There are at least two advantages to the innovative seat when compared to the regular seat. These advantages will be presented.

FIGS. 90 and 91 Are schematic side view and top view descriptions presenting (in the example) the disabled person's ability to move backwards approximately 0.22 m further to the point until his legs touch the seat as a limit. In or to present this substantial advantage, we will present a sample calculation. Let's assume that the disabled person's weight is 80 kg. The reduced moment (Toque) during standing is:

M=80 kg*0.22 m=17.6 kg*m

This is the moment required of the disabled person to go up a step (stair), and it is known that this value of moment is very problematic.

FIGS. 89, 92 and 93 Are schematic side view descriptions of examples used to compare the disabled person's leaning region with the seat when the disabled person is lifted as an example V1=0.17 m, as presented (illustrated) in Drawing No. 89. Increasing the leaning region from 2/92 in Drawing No. 92 to 2/93 as in drawing No. 93 is significant for the disabled person. This significance is intensified since it is known that disabled people are susceptible to pressure wounds. Some disabled people suffer from these wounds so that increasing the supporting region would reduce the risk of pressure wounds.

FIGS. 94 to 98 are schematic view descriptions of a computerized device assisting disabled people in walking. The device would help walking and exercising in the conditions described in Drawings 33 up to 35D—showing a relatively mild case of a disabled person in Drawing no. 33 who can stand on his own but is unable to walk to the point of a person that both his legs are amputated, as in Drawings 37A up to 37D. Conditions that can be assisted through the use of this device are quadriplegics as in drawing No. 35B, which are considered to be the most severe in the population of people with back injuries. Walking can be carried out either forward or backward using the drives with the cables which are located at the bottom of the legs as well as the walker wheels, depending on need, as explained on other pages of this document.

In the example, each moving system includes a sensor used to measure the movement and the condition of that system. This information is transmitted to the computer in real time. In addition, there are devices that identify the “free leg”. According to Drawings 11A and 11B, the leg being lifted off the ground is identified, and according to Drawings 13 and 14, the moment when the “free leg” leaning strength is such that it can be moved—is identified. In the example, the “free leg” position is the one that activates all of the various movements (Trigger) according to the logic that is determined for the exercise of the specific disabled person or the logic of a default. To make it easier to understand, we will define an orthogonal X, Y, Z axis system as illustrated in the drawings. System 2/94 can move in direction 20/98 with the electrical wheel 4/94. Controlled Y and Z robotic axis is driving handles 10/94 and 12/94 Motion as per FIG. 95 will cause the tilting 10/95 which is the tilt 10/95 and 10/96 in FIG. 96. The inverse of those Z 20/94 motion is sown in FIG. 97 as tilting 10/97. Movement of handles 10/94 and 12/94 in Y direction will case tilting in walking direction Y. Spring wires are for Person stabilization.

FIGS. 99A to 99C are schematic descriptions of the graph 99A-99C We will rely on the explanations provided for FIGS. 99A-99C to explain, through the use of several examples, various activations of the “free leg” starting from the most simple up to the ones requiring computerization and dictated logic.

The consumption of electric energy in our concept in relation to others RGO systems is minimal for the purpose of walking since our activation force is at the bottom of the leg. In the experiments shown in Drawings 12A and 12B, we used a Gear Motor and an electric battery of a simple Makita screwdriver. As a reference, the battery sizes 3.5 Cm*3.5 Cm*4.5 Cm weighing 0.1 kg (100 g). The battery volume is less than that of a cigarette pack. We installed a gear Motor and a battery in each leg. The two batteries made it possible to walk for approximately 40 minutes using both legs. It should be stressed that walking for two hours was made possible with 3 pairs of batteries with total weighing 0.6 kg.

### The Most Simple Activation

We used this activation in some of the initial experiments without any sensors and no computerized logic. We regularly activated the two Gear Motors under the batteries voltage constantly. This could be done since it is suitable for continuous drilling with the screwdriver. Whenever the leg reached the “free leg” position, we achieved the motion of that leg and in fact we achieved a continuous 20-minute walk with two batteries in this wasteful way. We will present several examples for the activation of walking for longer walking time.

### Activation Using the Logic of Motion Sampling of 0.2 Seconds Following a 2-Second Resting Interval

We will use the systems according to Drawings 11A-11B to elaborate on the explanation. This explanation clarifies the activation for the other systems. It also includes the ones where force is activated on the leg, as illustrated in Drawings 17 to 30A as well as 41-43B. We will refer to the logic as “the free leg logic”. In this logic, we identify the positions of “free leg” and “weight support leg”, and according to his identification and the transitions between these positions, we either activate or stop the motion on the relevant leg by stopping the motor.

In this example, the identification of the leg as “free leg” for the purpose of moving it forward, and later on moving it when it is identified as the “weight supporting leg”, will be based on the Output of the Incremental Shaft Encoder (ISE) as will be explained later on. For example, in this method, according to Drawings 11A and 11B, we add Incremental Shaft Encoder (ISE) to each gear Motor in both legs, in the customary method of control, ISE is connected to the motor. This ISE will identify the leg motion by identifying the rolling of the wheel or the movement of the components moving the leg. In the example a computerized and control system is added for the activation of the Gear Motor as is customary in motion systems in control closed loop. It is possible that part of the control system will serve the moving drives of both legs. This possibility will include a tow-way communication between the two activation systems. In this example, the communication will be wired or wireless.

### A Description as an Example for the Cycle of Walking Activity for the Disabled Person:

2010. The battery voltage is activated for 0.2 seconds on the first leg (randomly chosen), if motion is identified since the leg is in a “free leg” position. The voltage continues to be activated until the ISE stop is identified which means that the leg is at the “weight-supporting leg”.

2012. The battery voltage is activated for 0.2 seconds on the other leg and it continues as in the previous section of 2010.

2014. If voltage is activated on the leg and no motion is achieved, the other leg will be activated until there is an initiated pause of the walking process.

Walking Time in the Motion Sampling Logic of 0.2 Seconds Every2-Second Intervals with Two Batteries.
1. In continuous walking with a battery in each leg, we will achieve, as explained earlier, a 20-minute walking duration 20 Min*2=40 Min
2. An extreme case where the system is activated all of the time while the disabled person is standing. The activation will last for only 0.2 seconds every 2-seconds interval. The system will in fact be activated for only tenth of the time and therefore the activation time (WALKING) in this situation will be about 6.7 hours.

20 Min*2*10=400 Min=6.7 Hours
0.3. Walking and resting positions with both batteries will achieve activation time lasting from 40 minutes to 6.7 hours.
   Activation with Micro-Switches (Near Leg) for Each Leg

When the leg is lifted off the ground, we will achieve with the micro-switch the indication of “free leg”. The rest of the explanation in this example is obvious as well due to the calculation and explanation for the three time intervals in the previous section. 40 Min . . . 6.7 Hours . . . Between (40 Min and 6.7 hours)

Activation with Micro-Switches as Per FIGS. 154 to 160.

See details of FIGS. 154 to 160

Activation with Load Cell in Each Leg

When the leg places a lower force on the floor than has been set, the Load Cell will transmit the “free leg” indication. In this example as well, the rest of the explanation is obvious due to the calculation and explanation for the three time intervals in the previous section. 40 Min . . . 6.7 Hours . . . Between (40 Min and 6.7 Hours)

FIGS. 100 to 103 are schematic view descriptions of the system and parts of the system required to move the legs of people that are disabled or that are not handicapped in their legs. The motion is done through the combination of two rotation motions—the first rotation motions around the knee's rotation axis, and the second rotation motion is the occasional rotation of the foot clockwise and counter clockwise (CW and CCW). An example to the main options is that the system is electrically activated, and another option is that the person activates the system on his own. Another option is the controlled combination of the previous two options. The absolute advantage of combining the motions in relation to each motion on its own has been validated in the experiments.

FIG. 100 presents schematic top view descriptions of a well-known 2/100 standard spanner. The direction of the button position CW 4/100 or CCW determine the rotation direction of the exit axis intended to open the screw closings when the handle 2/100 makes rotation motions 6/100 forwards and backwards. An angular change in the button position 4/100 to the perpendicular [symbol] will change the rotation direction of the exit axis.

FIG. 101 presents a schematic isometric view of a mechanism designed to count the rotations, as shown in Drawings 17 and 18. When this mechanism is connected to the head of the rotation reversion mechanism of the spanner 2/100, we will achieve any number of rotations that had been set for the exit into the reverse direction in its exit axis. This reversing of direction will be utilized to reverse the rotation direction of the foot at the locations that had been determined.

FIGS. 102 and 103 present schematic views of the desirable leg motions 10/103 and foot 6/103. Drawing 102 shows the rotational motions integrated around the rotation axis 2/102 at the 8/103 mechanism, which carries out an arch motion 10/103. While in motion, rotation is entered to the 2/101 mechanism through a transmitter [symbol] that is not shown in the drawing. These rotations control the direction of the foot rotation. “Track” 18/102 shows the upward motion from the bottom to the “edge” 16/102 when at this point, the foot carries out a rotation in the direction of CW. The transmission mentioned earlier—the entrance into it is made from a “archer tooth” in the 1/103 system and a Tooth wheel which is connected to unit 2/101. “Track” 10/102 shows a downward motion from the upper “edge” 14/102 going down, while at this stage as well, the foot is rotating in the CW direction. After this cycle, the number of rotations counted is the one which will reverse the CW direction to the CWW direction, and this kind of reversing will be repeated every cycle. The result will be the combination of the leg and foot rotations in changing directions of CW and CWW. The engineering contents technology is clear due to the mentioning of the component functions. We did not include the technological details so that the explanation would not be too complicated. From the bottom to the “edge” 16/102 as at this point, the foot is rotating at the CW direction.

FIGS. 104 and 105 are schematic side view descriptions of a disabled person being assisted by an Actuator 16/104 in order to move from a sitting to standing position and vice versa. It should be stressed that that the two Actuators are not crutches since upport 05/104 is at the shoulder area they do not provide assistance for walking. One s and the other one 08/104 is on the knee. Lifting is assisted by the Actuator motion in the direction of the arrow 04/104 and in the approximateize of 06/105.

FIGS. 106 and 107 are schematic side view descriptions of a disabled person being assisted by an Actuator in order to move from a sitting to standing position and vice versa. It should be stressed that the two Actuators are not crutches since they are not used to assist in walking. One support is at the shoulder area and the other is on the chair or another object close to it. Drawing 106 shows an Actuator that does not need a special device on the chair. It can be helped by any support available in proximity of the disabled person. Drawing 107 shows an Actuator adjusted to a designated chair. The Actuator is designated for this purpose as well. This way, it is possible to perform greater and safer lifting while standing, and later on, the disabled person continues on his own or with the help of any kind of support for walking.

FIGS. 108 to 113 are schematic view descriptions of a designated walker 8/108 intended to provide walking assistance to a person paralyzed from above the pelvis downwards. Hatched line 36/108 note the standard walker as a reference, whose enlargement is intended to have stabilized further. Device 10/108 for supporting the disabled person from the bottom of the legs 14/108 up to the upper part of the back 18/108. This support a lineup that stabilizes the disabled person's standing position. The angular motion limitation tracks 22/18 forward and backward make it possible to protect the disabled person from falling. The walking assistance systems 26/108 and 28/108 provide assistance to walking as explained in Drawings 42 up to 43B. Arrow 32/108 notes the forward walking direction. Pins 1-/109 and 14/109 restrict the disabled person's moving forward 20/109 and backward 22/109. The 42/108 rotation axis of the 10/08 device is near the rotation axis of the disabled person's ankle. There is the option of having wheels 46/108 that could be electrically activates through a command from the disabled person. This way, the various drivers mentioned in the drawings can be activated in this case even though they are not shown in drawings. Walking is achieved mainly through step by step. The right-hand rotation axis of the device 14/110 is located inside the Bearing House 14/110. They enable the disabled person to bend by making it possible to have the right-hand bar lifted upwards in the direction of 14/111 at near the at this bearing house, making the bending motion of the disabled possible 10/113 as well as the bending 22/11 as shown later on.

The left-hand rotation axis 18/111 of the device 22/110 is inside the Bearing Housing 42/108, enabling the disabled person's body to bend by making it possible to lower the left-hand rod 28/111 downwards in the direction of 32/111, thus enabling the bending motion of 10/113 as well as the bending motions 22/11 later on.

FIGS. 114 to 116A are schematic side view descriptions of the leg motion 20/114 transmitted to the transmission 22/114 through coupling 22/114. Pin P1 is connected to device 20/114 which is connected to the disabled person's leg 24/114, and it transmits the leg motion to the transmission. For example, the device 20/114 which is connected to the disabled person's leg is presented in Drawing 36 as an example. The slot [symbol] 10/114 into which the pin can slip, forms the L1 size, enabling among other things, the formation of RGO which does not require adjustment due to the disabled person's height in within a large range, such as disabled at the height of 160 cm up to 185 cm, without adjustment. The Coupling has an additional role of stabilizing the lower part of the leg around the axis 30/115 intended to prevent rotation 32/115 around the same axis. This issue is specifically important to create the “Wheel” Direction stability, as presented in Drawing 115. This stabilization directs the wheel that causes the wheel drive motion, as presented, for example, in drawing 11B. This stabilization will make it possible for the disabled person to advance with the help of the electrically-operated wheels in the desirable direction that he would choose. The mechanical direction can be achieved in a number of ways that are known in engineering, for example large touch planes in the areas touched in sliding. The intermediate part 22/116B is connected to the quadratic transmission axis, making it possible to transmit the coupling's rotation to the transmission. The coupling achieves centering through the round hole 20/115 which is centered on the transmission's quadratic axis 24/115. After the coupling is connected to the transmission 22/116B, the coupling is connected through the locker 10/117.

FIG. 117 are schematic side view descriptions of the disabled person, for example, with the system attached to him. The system includes a back support 10/117. Two straps 14/117 and fast lockers 18/117 can be used to connect the support 10/117 to the back so that it would always be at the height determined in the direction of Z. This height is set only once by the length of the straps so that the transmission axis height TRN=i would be close to the leg's rotation axis height at the pelvis area, which is a setting in the direction of Z. A one-time direction of the back support 10/117 in regard to the back sets the transmission axis location TRN=i so that it would be close in the direction of Axis X to the leg's rotation axis at the pelvis area. Strap 22/117 and strap 24/117 exert pressure on the abdomen, attaching the back to the back support 10/117 in order to ensure the location at the direction of X. This way, whenever the back support is “put on” 10/117, we would return to the correct location of the transmissions (right and left), to the exact location as had been adjusted. Links 30/117 (right and left) transmit the Transmission Output motion upwards. Later on, straps 32/117 transmit the motion towards the back support or towards link (lever) 6/147 in Drawing 147 as in the example or as the for production.

FIG. 118 presents schematic side view descriptions of a disabled person and the RGO in Drawing 117, where it is possible to create a desirable bending at any reasonable angle 12/118 by changing the location of the pin 10/118, as shown in the drawing.

FIGS. 119 to 121 are schematic side view descriptions of three sample positions of the disabled person while standing, and the level of the back being stabilized in various positions. In order to make it easier to explain, the right leg only is presented and while the left leg, which is not shown, is in a position of centered standing as shown in Drawing 120. In Drawing 120, the right leg is in a centered position, in Drawing 119, the right leg is in a rear position and in Drawing 121, the right leg is in a frontal position. In all of the three positions, the Transmission ratio in these drawings of the transmission is i=1:2. In the example, the horizontal motion 10/119 achieved is 5 cm for walking of approximately 30 cm with the right leg or left leg. The length of 5 cm is determined among other things by the transmission ration i=1:2. The slot 14/119 makes it possible to at least prevent part of the motion towards the back. Another possibility (Drawing 120) is the control of the transmission of the motion towards the back by using springs 1S and 2S that are in contact with Pin 5P which is operated by an Arm 10/120. In some other cases, it is possible to add absorbers to the springs, which are not shown in the drawing, for the absorption of the back motion. There will be cases where only absorbers would be used without the springs. Pins PTR1 and PTR2 are on the motion transmission track from the leg to the transmission.

FIGS. 122 to 124 are schematic side view descriptions of three sample positions of the disabled person's standing and the back's stabilization level in the different cases. Everything that has been explained for drawings 119 to 121 is respectively the same as in Drawings 122 to 124.

In these drawings, the Transmission Ratio is i=1:20 instead of i=1:2 in the previous drawings. In the example, the horizontal motion 10/122 achieved is 0.5 cm for walking for approximately 30 cm with the right leg or the left leg. The size of 0.5 cm has been determined, among other things, by the Transmission Ration of i=1:20. Increasing the Transmission Ration by 10-fold reduced the motion by 10-fold from 5 cm to 0.5 cm. In fact, control has been achieved in the motion/stabilizing of the back, as determined by physical therapists, between a desirable major back motion and the addition of another motion to the disabled person's body up to the point of minimizing the motion of the back.

FIGS. 125 to 138 are schematic side view descriptions of a disabled person, such as Paraplegic T4, gaining a significant degree of independence due to the fact that his RGO is detachable. The detachability issue will be defined through an example. Please refer to a number of additional drawings: drawings 114-117 and drawings 150-153 that will enhance clarification.

In this drawing series (FIGS. 125 to 138)—as an example, we will present a disabled person Paraplegic T4 who independently goes through all stages from lying in bed up to meeting his friends at a coffee shop, doing so independently except for being seated at the coffee shop where he is being assisted in the transition from a standing position to a sitting position. While at the coffee shop, the disabled person removes the system attached to his back 10/127 in Drawing 127, reaching a position in which he seems to be no different from a healthy person. From the disabled person's viewpoint, this is very important. While being seated at the coffee shop, the disabled person leans with his arm [symbol] in area 14/138 in Drawing 138, invisibly providing support for his back. It is also possible to achieve support for the back by using an “abdominal belt” 30/138 (Drawing 138) that bypasses the chair. The entire procedure from bed up to the coffee shop is possible in reverse—from the coffee shop to bed. This procedure is inverse.

FIG. 125 presents schematic side view descriptions of a disabled person lying in bed 8/125, leaning on his elbows and in this way, lifting his back from the chair. Later on, through the use of slight motions with his elbows, he advances his body on the bed in the direction of 12/125.

FIG. 126 presents schematic side view descriptions of a disabled person advancing his body up to the point where his knee is beyond the edge of the bed, and the lower part of his legs 12/126 fall is a rotational motion 10/126. At this stage, the disabled person is preparing for the initial lifting with the help of a cable 14/126 in the UP direction.

FIG. 127 presents schematic side view descriptions of a back support system 10/127 which the disabled person had made available on the bed, for example.

### FIG. 128 Presents Schematic Side View Descriptions of a Disabled Person Who has Completed

the sitting process with the help of a cable 10/128 that lifted him in the UP direction.

FIG. 129 presents schematic side view descriptions of a disabled person at the final stage of “wearing” the back support system 10/129 on his back, including the belt closure. At this stage, he is still being supported by the cable 10/129.

The Following should be Stressed as an Example:

since the batteries are small. The most desirable option is that they would be placed on the legs rather than the back. This is possible due to the negligible size of the batteries, making it possible to walk for a number of hours. In a major part of the systems, this method has an advantage since in some cases, a system without any electrical wiring from the drives to another sub unite. Each leg is a complete functional unit.

FIGS. 130 to 131 are schematic side view descriptions of a disabled person bending in the direction of unit 18/130 with the help of a cable 8/130 that lowers him in the direction of Down, and later on takes the leg straightening unit (Drawing 131) to have connected to the foot.

FIG. 132 presents schematic side view descriptions of a disabled person sitting and completing the connection of the foot straightening unit (Drawing 131) to his leg. The disabled person connects the coupling 14/132, and he is in a free position.

FIG. 133 presents schematic side view descriptions of a disabled person connecting the coupling 14/133 with the help of a Pin P1 (Drawing 114). At this stage, he connects the Wheel Drives (Drawing B12) when he chooses the option of walking with the help of the Wheel Drives, or any other option mentioned in this document.

FIGS. 134 to 135 presents schematic side view descriptions of a disabled person who chooses to walk with crutches after being lifted out of bed with the help of a cable that still supports him in the direction of UP. Later on (Drawing 135), he releases himself from the cable and walks in the direction of 1/135.

FIG. 136 presents schematic side view descriptions showing as an example the stages of assembling the system on the disabled person's body in a different order than presented earlier. The stages are numbered 1 to 4 as shown in the drawing. Stage 1 will involve the connection of the wheel drive to the leg straightening system (Drawing 131). In fact, this stage can be skipped if the drive is left as fixed without removing from the leg straightening system. Stage 2 involves the “wearing” of the back straightening kit 30/136 on the back. Stage 3-Wearing the leg straightening system 16/136 on the leg. Stage 4-Connecting the coupling as shown in earlier drawings.

FIG. 137 presents schematic side view descriptions of a disabled person going to the coffee shop and getting organized to being seated on a chair.

FIG. 138 presents schematic side view descriptions of a disabled person already in a sitting position in a coffee shop, for example, after having removed the back support system by himself 30/136, and as an option—through other means—part of or the rest of the RGO system parts. To be stressed again—at the coffee shop, the disabled person is leaning with his arm area 14/138 in Drawing 138—this way he provides invisible support for his back. The stabilization of the back can also be achieved by an “abdominal belt” 30/138 (drawing 138) that bypasses the chair. The glass of wine 20/138 and cake 22/138 emphasize the advantage of the system in providing a different quality of life for disabled people with a detachable RGO.

FIGS. 139 and 140 present schematic side view descriptions of a tall disabled person who is 6′8″. The length from the floor up to the pelvis axis is 105 cm. The length from the pelvis axis up to the upper point of the back support BB is 35 cm. The length ratio 3 (105/35=3) dictates a ratio of 10 cm between the horizontal step motion 30 cm (30/3) to the horizontal motion of point BB. The transition of the motion from the foot was with the help of a straight Link. Drawings 141 up to 149C define systems whose transmission ratio is smaller than 1. For example, the ratio of the Link transmission as in Drawings 143 up to 149 is smaller than 1. It is 1:2.

FIGS. 141 and 142 present schematic side view descriptions of a system of Links that are Link transmission, which is defined in more detail in Drawings 143 and 145. In the drawing, the leg is shown in a vertical position towards the ground and so is the Link 20/141 attached to it (as in the drawing “From Leg”). The transmission rotation axis 23/141 marked as BE1 is in proximity to the pelvis axis in the direction of Y (the direction of walking) and Z (the vertical axis) that were described earlier. The second Link 30/141 is the one that would move the arm 32/141 that is turned towards the back. The arm rotation axis 30/141 is 27/141. It is marked as BE1. Changing the location of the rotation axis 27/141 marked as BE1 to the rotation axis 27/141 marked as BE1 to 28/141 marked as BHH would reduce the transmission ratio as known in Mechanical Engineering as the calculation of Link transmission systems of this type. In Drawing 142, we can see the system after the right leg. For example, made a step in the direction of the arrow FFRONT also marked as IN FROM LEG. The Drawing shows that the motion direction of the Links 22/142 and 30/142 is reverse when the link motion 30/142 is in the direction of the arrow BBFRONT.

Drawings 141 and 142 are known in Mechanical Engineering as Link Transmission. My explanation here will also serve as an explanation to drawings 143 up to 146.

Link Transmission One Stage

as in Drawings 142 and 146. This transmission includes two links and two rotation axes for the Links. The Link's angular motion of the Output Link (to the back) is reverse to the angular motion of the Input Link (from the leg). The relative length of the Links and the relative location of the axes sets the Transmission Ratio at 1:i. In our examples, the transmission Ratios are for Reduction Transmission, meaning that the Output Link performs a rotation angle that is smaller than that of the Input Link. When we refer to “transmission”, it could be the Link Transmission type that had been presented in the various examples in this document, and it includes as an option, the majority of transmissions known in the world of Mechanical Engineering. The Transmission Ratio determines the transmission of the additional motion to the back due to the disabled person's stepping/walking. This additional motion of bending the back is periodical in its nature depending on the pace of walking. The Amplitude size of the back motion is determined, among other things, by the step size and the Transmission Ratio 1:i of the Transmission. Drawings 141 and 142 show that it is possible to change the Transmission Ratio of the Link Transmission by replacing the location of the Link axis 2 EB 27/141 by the location presented as BHH 28/141. The Transmission Ratio is respectively changed from 1:2 to 1:3.75 in the sizes presented in the drawings. Another example: in Drawings 119-121, the Transmission Ratio of the Transmission is 1:2, and the Pin amplitude 10/119 is 5 cm, which would provide controlled motion to the disabled person's back for his comfort. In Drawings 122-124, the Transmission ratio is 1:20, which is 10-fold greater than the previous one. The Pin amplitude is 0.5 cm, which is 10-fold smaller. The amplitude is, in fact, so small that it would be absorbed within the Backlash of the system, and the disabled would actually be unable to notice it.

FIGS. 143 and 145 present schematic side view descriptions of Link Transmission of Two Stages. As shown in Drawings 143 and 145, there are three Links: 14/143, 28/143 and 54/143 as well as three rotation axes for the Links 10/143, 32/143 and 50/143. The angular motion of the Output Link 54/143 (to the back) is reverse to the angular motion of the Input Link 14/143 (from the leg). The Input Link from the leg 14/143 is limited in its rotation between two stoppers 18/143 and 20/143 (See Drawing 145 for clarification). In the example, the Link 14/143 is attached to the left leg during rotation with the help of stoppers 18/143 and 20/143, which they too restrict the ability of the back to achieve forward or backward bending 70/145. It is known that this kind of restriction is a basic requirement for RGO systems.

FIGS. 144 and 146 present schematic side view descriptions of Link Transmission of one stage as shown in Drawings 144 and 146. There are two Links 10/144 and 54/144 as well as two rotation axes for the Links 10/144 and 50/144. The angular motion of the Output Link 54/144 (to the back) is reverse to the angular motion of the Input Link 10/144 (from the leg). The Input Link from the leg 14/146 is restricted in its rotation between the two stoppers 18/144 and 20/144 (See Drawing 146 for clarification). In the example, Link 14/146 is attached in its rotation 14/146 to the right leg with the help of stoppers 18/146 and 20/146, which they too restrict the ability of the back to achieve forward bending 70/146 or backward bending. It is known that this kind of bending is a basic requirement for RGO systems, and it is realized. It is possible to install a spring 21/146 or a shock absorber that is not shown in the Drawing—both or only one of them. A possible position of the legs of a disabled being assisted by the RGO system are as one option about “vertical” to the floor as defined in Drawings 143 and 144. The “other” position which is defined for both legs forward as in Drawings 145 and 146 is made only for the purpose of making it easier to explain. In fact, it should be understood that the legs are not forward but they are rather as defined “vertical” to the floor as defined in Drawings 143 and 144, and in fact, the back is the one bending forward. It is possible to understand the rest of the positions due to this explanation. As result of what is shown in Drawings 143 up to 146—in every position where both legs are close to one another, bending the back would also be restricted due to bending 60/145 or 60/16 in relation to the location of the legs.

FIGS. 147A to 147D presents schematic isometric and Top View of drawings serving as an example of a system that transmits motion form the legs to the sides of the back. The tread of the feet is marked as an example in Drawing 147B numbered as 10/147B and 12/147B, showing from above the location of the legs in relation to the disabled person's body and helps in understanding the rest of the drawings regarding the various locations. The principle of transmission through the links 24/147A and 22/147A whose motion is transmitted from the legs leads to a situation in which the motion of the center of the back in the forward and backward direction is basically “zero”. This way, the back is stabilized for the purpose of bending the back forwards and backwards due to the defined motions of the legs. It is known that paraplegics need to restrict the forward and backward bending of the back. In the isometric drawing 147A on the right, marked in R—the link transmission is the one described in Drawings 142, 144 and 146. The angular motion 24/147A entered from the leg and the angular motion 30/147A transmitted to the back are identical in their direction. In the isometric drawing 147A on the left, marked as L, the link transmission is the one described in Drawings 143 and 145. The angular motion 22/147A entered from the leg and the angular motion 32/147A transmitted to the back are reverse to one another in their direction. The reduction transmission ratio are theoretically identical on both sides. On the right-hand side on grade one, the transmission 1:i=1:2 on the left side two stages (each of them is the root of 2) whose product is 1:i=1:2 as well. To make it easy to explain, we defined “virtual links” marked with a striped line, 30/147B 6/147, 30/147C and 32/147D. It is known in mechanical engineering that the sum of the two reverse motions leads to the sum of motions at the center of the links being equal to zero.

FIGS. 148 to 149C present schematic isometric and top view of drawings serving as an example of a system that transmits motion from the legs towards behind the back. Parts 30/148A and 32/142A serve here as an example for the link transmission. When transmissions of a different kind are used, the bases serve as bases for the connection of the transmission to the system. The principle of transmitting through the links 11/148 and 10/148 whose motions are transmitted from the legs, leads t a situation in which the motion of the center of the back in the forward and backward direction is basically “zero”. This way, the back is stabilized for the purpose of reducing the “bending” of the back forward and backwards due to the defined motions of the legs. In the isometric drawing 148 on the right-hand side, marked as R, the link transmission is the one described in Drawings 142, 144 and 146. The angular motion 11/148 entered from the leg and the angular motion 30/148 that is later on transmitted to the back are identical in their direction. In the isometric Drawing 148 on the left-hand side, marked as L, the link transmission is the one described in Drawings 143 and 145. The angular motion 22/147A entered form the leg and the angular motion 3/147A transmitted to the back are reverse to one another in their direction. The rest of the explanation can be understood from the previous one. To make it easier to explain, we have added the “virtual links” 30/149A, 30/149B and 30/149C. To clarify the following explanation, it is possible to use Drawings 139 and 140. Links 8/149A and 26/149A help in bypassing the disabled person's body to reach behind his back. The later part of the explanation can be understood from the explanation n the previous section. Here, the actual link 6/148 is the one that nullifies the motion at the center of 20/149. This link with the help of part 12/148 that has a slot in it, transmits motion towards 13/148 which is connected to the part to which the disabled person is connected with the back straps. Link 6/148 divides the motion of each leg in two. As an illustration, we will present a calculation that would make it easier to clarify the level of stabilizing the back due to the walking motion of the leg in relation to the position defined in Drawings 147A up to 149C. The stabilizing would define the motion of the back forward following DH. A number of auxiliary assumptions: The extent of walking is 30 cm, the transmission ratio is 1:2, the distance from the floor up to the disabled person's pelvis axes is 105 cm. the height of the back support form the pelvis is 35 cm. These measurements were taken from a disabled person 2 meters tall.

DH=(30 Cm)*(1/2)*(25/105)*0.5=2.5 cm.

This move of 2.5 cm due to a single step or +/−2.5 Cm due to both legs is negligent from the disabled person's point of view. In fact, some will say that this motion that enters mobility to the upper part of the body contributes to the preservation of his internal organs. Following medical guidelines, it is possible to increase or decrease this dynamic motion in very extensive areas.

FIGS. 150 and 153 present schematic side views of a disabled person, a paraplegic in Drawing 150 is assisted by RGO 10/150 consisting of a continuous “solid” unit starting from the bottom of the leg, and in some other cases, even lower up to the upper part of the back. With the help of these drawings, we will present a way of After Market which means a change in the RGO existing on the market which is transformed to a device that is different from the original. The purpose of the change is to split the RGO making it detachable to at least two parts, and in another situation to more parts. The splitting, by a physical cut or in any other way of separation (parting), is demonstrated in the parting area 16/151 which is located under the main mechanism of the RGO, and the parting id that of the back support 12/151 from at least the support 20/151 of one leg. The splitting will usually be for support of the two legs. In order to complete the explanation, one can use Drawings 125-138 which demonstrate the splitting of the manufacturer's original product, called OEM. In these drawings, we can also see an example for increasing the quality of life for disabled people due to the splitting. The connection between the upper part and nx the legs area is carried out with the help of the coupling in Drawing 152 to one or both legs, depending on the case. Drawing 153 presents the disabled person after the connections are completed. The coupling 12/152 is used in connecting the upper part 12/152 to the lower part 20/153. The connection and its advantages were outlined in other sections.

FIGS. 154 to 156 are schematic back view descriptions of a disabled person standing on both legs in Drawing 154 with RGO as the one in Drawing 153 with the coupling as in Drawing 152 or the one described in Drawings 129-137. In this case, the disabled person's weight W is more or less equal on both his legs—W/2 on each leg. When we refer to the disabled person's weight, it is meant as his weight when undressed and plus everything connected to him. In this position, the approximate lengths of 10/154 and 12/154 from the pelvis 16/154 up to approximately half of the height of the back 20/154 are more or less equal. Drawing 155 shows that when the disabled person bends to the left 8/155, his weight 1.0 W is transferred to his left leg 20/155, and his right leg is lifted off the ground at the distance of 24/155, and at this position, it does not bear any part of the disabled person's weight. On the left side, the length of 10/154 is shortened to 10/155 to length of LLL 30/155. On the right side, the length 12/154 extends to 12/155 to RRR 32/155. The shortening and lengthening noted are made possible due to the coupling described, among other things, in Drawings 129, 132 and 137 where the slot makes it possible for the pin to move inside the slot in the longitudinal direction. Drawing 156 shows the LLL downward shortening DOWN, and the RRR upward lengthening UP. The actual values measured were above 5 cm. The ability to shorten or lengthen makes it possible for the disabled person to bend in the direction of 8/155 and the opposite to the the right-hand side without any resistance of the RGO. According to this document, the RGO actually makes it possible to bend left and right with no disruption to the disabled person due to the RGO. According to this document, the RGO actually makes it possible to walk with no disruption since it does not constrain any connection between the motion of one leg over the other.

It should be Stressed that in all Mechanical RGOs that are Known to Me

it is impossible t have the choice of shortening or lengthening due to their RGO system. The RGO eliminates this option almost completely, and therefore the action forward can take place only when one leg constrains the other. Since there it is almost impossible to be able to bend, a major part of the person's weight is supported by the arms, causing the disabled person to tire very easily.

It should be Stressed that in all Innovative Mechanical RGOs

mentioned in this document possess the sensory bending ability. This way, the arms only create the bending while throughout the bending—the legs bear the disabled person's weight up to the point where one leg bears the entire weight. The arms do not have to make the effort. The disabled person achieves the walking motion according to the various methods mentioned in this document.

In Fact,

in a major part of the options presented in this document, the “energy” required of the disabled person for walking is minimal, and mainly is what is required to bend the body right and left only.

Lengthening and Shortening for the Purpose of Logic Signals:

This shortening and lengthening can be utilized through the use of Micro Switch or another customary to identify when the leg is off the floor or is about to be off the floor. This method is important in its own right since it prevents the need for a power meter [symbol] or something similar to it between the shoe and the floor. The utilization of this lengthening to activate a Micro Switch is accepted and known technically and it is possible to choose one method out of many known methods, It has not been entered in the Drawings since it is obvious.

FIGS. 157A and 157B present schematic graphs showing the weight on each leg at the stage when the disabled person bends from the standing position (Drawing 154) to the full bending towards left (Drawing 155 and 156) as a function of time T. Graph 10/157A regarding the right leg presents the reduction of force 0.5 W up to being off the floor when the force is zero. Graph 12/157B regarding the left leg presents the increase of force from the value of 0.5 W up to the full transfer of the weight to the left leg. In slow motion, the sum of the forces in the graphs at any moment is the disabled person's weight.

FIG. 158 presents schematic curves 6/158 and 8/158 respectively showing the lengthening on the right-hand side and the shortening on the left-hand side. The on signs in the abovementioned graphs note the transfer of the Micro Switches from OFF to ON 14/158 on the right-hand side due to the lengthening and 12/158 on the left-hand side due to the shortening on the left-hand side,

FIGS. 159 and 160 present schematic the Micro Switches activity as an example. It is, in fact, possible to use just one of them, but the two of them help increase the reliability of dictating the logic, among other things, for the purpose of exerting force on the bottom of the feet at the right timing for the purpose of walking. Graph 10/159 shows the activity of the Micro Switch on the right-hand side. When ON MSR reaches the position of 10/159, it means that it identifies a lengthening set for activation. Graph 10/160 shows the Micro Switch activity on the left-hand side. When ON MSL reaches the position of 10/160, it means that it identifies a shortening set for activation.

FIG. 161A presents a schematic isometric view of an example of a two-track walker system which includes two Screw Drive systems 62/161A. Each drive is on its own with a separate control for it, a main control system, with the main logic controlling in both drives. As an example motions for activating the person are stepping in 30 cm steps that are formed by the forward and backward motions of the legs. A moving base 40/161A for the leg moves on track 66/161A. Drive system 36/161A in Z direction creates the motions RVS and LVS. On this base, the location 72/161A is marked where the leg stands. The motions 74/161A are in the direction of forward and backward. As an option known in Mechanicad Engineering we can change the two Screw Drive systems 62/161A with two Timing Belts and all others will be according to a good design.

The Following Verbal Description for FIG. 161-AAA Describes a Walker System with Two Drive Straps. The Drawing for the Following Description Will be Added to the PCT Submission. The Following Description Makes it Easier to Understand the Activity of the System with the Screw Drive 61/161A.

FIG. 161B presents schematic side view descriptions of the coupling as described in Drawing 115. The coupling 20/161B—after having a change carried out and intended to transmit vertical motions from the belts to the disabled person's body (See Drawings 164A and 164B). Part 24/161B serves as a locker for pin P1, creating a new situation where there is a continuum of the vertical motion transmission 30/161B with the help of the RGO to all body parts. In fact, and for the purpose of clarification, we cancelled the function of pin P1 in the slot 32/161B, for example, the locking of 24/161B is executed with the help of two locking screws 38/161B.

the locking 24/161B can be used also for a disabled riding on two wheel riding system, for example FIGS. 177 17 179 182

FIGS. 162A to 164B—The goal here is to enter motions and vibrations to the disabled person's body as well as to his various internal organs through vertical or horizontal shakings or any other of their combinations that could be dictated by a computer (not marked in the drawings). The motions presented are only for explanation purposes. It is possible to dictate motions that are due to default or that are designated according to the disabled person. As an option the computer and control dictate the motions in a closed loop or open loop. For example, there are devices intended to help a disabled person stand for one hour a day in order to attempt to preserve the function of his body parts, and especially his internal organs. The system presented dynamically activated the human body. This is why it is much better than the “static systems”. The system has been described by belts, similarly to the walker. What described here can be realized on foot tread found on linear tracks that are more or less in vertical positions in different stages. This option is a relatively simple adaptation required according to the customary mechanical engineering.

FIGS. 162A to 162B are schematic graphs illustrating the horizontal motion as a function of time T, horizontal walking motion, transmitted from the belts to the bottom of the feet which are in contact with the belts most of the time. The vertical axes in Graphs HR to the right and LH to the left in Drawings 162A and 162B respectively are the belts' speed in [m/Sec]. The speed values and their duration are marked in 10/162A, 14/162A, 12/162A and 14/162B, 10/162B, 12/162B.

FIGS. 163A to 163B are schematic graphs illustrating the horizontal motion as a function of time T—for example, a horizontal walking motion at a low frequency value of 2 Hz. This motion is transmitted from the belts to the bottom of the feet which are in contact with the belts most of the time. The vertical axes in graphs HRS to the right and LHS to the left in Drawings 163A and 163B respectively are the belts' motion in meters [m]. The Position values and their duration are marked in drawing 163-A as 10/163A, 22/163A. The Position values and their duration are marked in Drawing 163-B as 10/163B, 22/163B. as an example, the motions were presented as reverse sinusoidal at the amplitude of 0.15 meters. For clarification purposes, the motions as a function of time

T as one of them is Sin and the other is Cos. The belts enter motions to the legs, in which each leg performs a forward/backward motion at the values of +/−0.15 meter illustrating the maximal reciprocal position of 0.3 m between the feet, resembling walking.

FIGS. 164A to 164B are schematic graphs illustrating the vertical 1 motion as a function of time T, a vertical vibration motion, for example at high frequency value of 5 Hz. This motion is transmitted from the belts to the bottom of the legs, and from the feet—to all of the disabled person's upper body parts, which are in contact with the belts most of the time. The vertical axes in graphs HRS to the right and LHS to the left in Drawings 164A and 164B respectively are the vibration motions of the belts in meters [m]. The Position values and their duration are marked in Drawing 164A as 30/164A, 32/164A.

The Position values and their duration are marked in Drawing 164B as 30/164B, 32/164B. As an example, the motions were presented as reverse sinusoidelic at the amplitude of 0.03 meters which is a small amplitude, and will be activated at high frequency. For clarification purposes, the motions are sinusoidelic as a function of time T as one is Sin and the other is Cos.

FIG. 165-FIG. 168 is a schematic drawing of the electrical drive system. It is intended to show the simple and inexpensive parts that we used for the proto-type. In order to illustrate the size of the components and the fact that they are small, they are compared to the size of a 500 ml Coca Cola bottle 4/165, and they are drawn in the same measure scale. The screwdriver/drill 6/166 is the smallest size of the Makita Company, and it is seen that it is at the same length as the Coca Cola bottle. Gear Motor Drive 10/166 is a part that we take out of the screwdriver/drill 6/166 and it is shown in Drawing 167 as 10/167. Another part of the screwdriver/drill 6/166 that we use is the battery 8/168. The cost of the two parts—the gear Motor Drive and the battery is approximately $30 for moving one leg and $60 for moving both legs.

FIG. 169-FIG. 170 is a schematic drawing of the Timing Belt Transmission with the leg advancing wheel.

FIG. 169 is a schematic drawing of the Timing Belt Transmission 2/169.

Gear motor Drive 10/167 moves the Timing belt wheel 14/169 and with the Timing Belt 18/169 it moves the Timing Belt wheel 22/169, which moves the wheel 28/169 which is surrounded by rubber. Force 32/169 is achieved by a spring (not shown in the drawing) and it causes friction with the ground 34/169 in that area. The distance of 40/169 of the gear Motor Drive 10/167 from the ground, showing as an example that the disabled person's leg is leaning on the ground which is identified as an example to a situation in which the micro-switch stops the Gear motor.

FIG. 170 is a schematic drawing of FIG. 169, but in this case, the Gear motor 10/167 is raised above the ground to a height of 8/170 showing the leg being raised above the floor. The spring force 32/170 presses the wheel to the ground. In this position of raising the leg, the micro-switch activates the Gear motor, which rotates the wheel 28/169 in the direction of 36/169, and in this way, it advances the leg in the direction of 42/170.

FIG. 171-FIG. 176 is a schematic drawing of an electrical system for a disabled person walking while his/her back is receiving support. To make the explanation simple, the drive systems as well as other systems that had been explained in earlier drawings are not entered here. The focus was on presenting the proto-type that was manufactured and tested in Ronen D.'s walking—a paraplegic 4 T person (paralyzed from his chest down). The explanation for one side can be understood for the other side, as well as for the entire system left and right. Walking was initially tried with the walker. The dismantling and assembly of the system were described, among other things, in Drawings 125-138. The parts that come in contact with the person are manufactured according to the disabled person's size. These parts are according to the standards acceptable in the world of orthopedics. They went through the most restrictive testing in Europe and the American FDA. The other parts are sub-systems that are not manufactured according to the disabled person's size, and therefore, manufacturing them in serials would be inexpensive. In the future, it will become mandatory to meet restrictive standards for the system, but it seems that in this case, it will be necessary to prove that the system is safe, and it will do so easily.

FIG. 171 is a schematic drawing of a walking system 4/171 composed of a back support 8/171, to which two arms are attached 12/171—left and right. Two polio splints 16/171 are attached to the arms (as they were known in the past). The splints are attached to the arms 12/171 with a connector 19/171 which is also adjustable and it can be locked according to the person's height (for adjusting the system to the distance between the biological axis of the person—the pelvis axis and the knees axis). Restricting the angular motion of the back around the pelvis axis is restricted by two stoppers on each side. A fixed stopper 24/171 and a rotating stopper that includes two extreme positions—stopper 28/171 in a stopping position, and stopper 32/171 in an open position. The open position is intended for the transition stages of standing to sitting and vice versa. There is the option of a Linear 36/171 that transforms from one position to another depending on the dictations that are determined. Ring 40/171 makes it possible to have a manual activation of the stopper in case of an electrical failure. Three belts 44/171 press the person's abdomen to the back support 8/171. Axis 10/171 presents the vertical position of the system/disabled person. It is necessary to prevent the foot from “falling” downwards. This standard device is a “Dictus Band” 52/171, which connects the shoe to the foot, as shown.

FIG. 172 is a schematic drawing of the polio splint 16/177, presented in its dismantled position, which the system allows. The locking opener 60/172 makes it possible to lock the lower part 64/172 to the upper part 68/172. When it is activated, it makes it possible to move from a standing position to a sitting position 70/173, which is presented in Drawing 173.

FIG. 174 is a schematic drawing of arm 19/171, which can also be dismantled from the back 8/171, when the dismantling can be done in the area of the mechanical axis 20/174 of the pelvis. The meeting area of the arm with the stoppers 27/174 is mechanically defined. The dismantling and locking connector 24/174 makes it possible to adjust the heights 30/174.

FIG. 175, FIG. 176 and FIG. 171 are a schematic drawing of the turning of the back support 8/171 in different positions of the foot being placed on the floor. In Drawings 171 and 175, the feet placed on the floor are foot next to foot. In Drawing 176, the feet placed are in the maximal step 12/176. In Drawing 171, arm 19/171 is in contact with a fixed stopper 24/171, which prevents the back from bending backwards, but it leaves the possibility to bend forwards. This bending forward 20/175 can be seen in drawing 175.

FIG. 175 is a schematic drawing of a system in which the disabled person stands with the maximal step 12/176. In this position, the right arm 19/171 stops at the stopper 28/171, and the left arm 20/176 stops at stopper 24/171 (FIG. 176). These stops in this particular case presented, stabilize the disabled person in an angular position as related to the axis 10/171. We have to emphasize the advantage of the standing position in the maximal step. In this standing position, the disabled person does not have to exert any effort in stabilizing his/her body (Front-Back). The system stabilizes his/her body, and the support received from a walker or crutches is very negligible, almost zero. Another major advantage in regard with all of the known electrical systems is that in this position, when the feet are on the floor, there is no need for electricity consumption (as had been explained), and the disabled person can actually stay in this position for a few hours, 5 hours, 10 hours or more, if he/she chooses to do so. By changing the angular location of the stoppers, it is possible to set each turning or the range of other turnings according to the position that is comfortable for the disabled person.

Reference is made to FIGS. 177 to 181 describing a riding system 2/177 with two driving wheels 6/177. The drawings also describe the main parts of the system and an explanation to the way it operates. The drawing describes system 2/177 when it is in a position that enables the disabled person 30/177 to move onto it and from it with the help of a slanted surface 10/177 which is in its open position, and it leans in the back on two swivel casters. In the front part of the system, there are two arms 20/177.

These arms have the possibility to rotate around a rotation axis and cause a mechanical locking in the desirable location, which is in the usually accepted methods. The slanted surface 10/177—one possibility is that it can be entered and taken out manually. The other possibility is that it can be entered and taken out robotically. Flexible bar 50/177 has the same characteristic of 34/188 (of FIG. 181) but not the same values. It transfer the tilting 31/179 (of FIG. 179) force/torque to the riding system 2/177 which needs it for the control

It is possible to add the option of a support system for the disabled person. As an example, it will be made of two crosswise arms including springs. The upper arm 34/177 and the lower arm 38/177. The disabled person maneuvers the system by bending his/her body with the help of the hands 42/177 forward and backward, and motion of the system backward and forward respectively. Turning the body right and left with the help of the hands would cause the system to turn clockwise (CW) and counter-clockwise (CCW) respectively. The disabled person's body straightness as shown in drawing 171 is assisted by the back support 33/177. In the riding position, it is possible to get the range of the back turning due to the stoppers (24/171 and 28/171 FIG. 171) would be smaller than that of walking. This can be achieved by limiting the range of the stoppers by adding an additional component that will be entered between the arms (12/171 FIG. 171) and stoppers (this is not shown in the drawings). The component can be electrically activated or entered by another person. There are at least two possibilities to build the system. The first one is when the entire manufacturing would be by one manufacturer as an OEM system. The second possibility (After Market). For example, it is possible to purchase a complete Segway system and add to it all of the computational and controlling and mechanical additions. This could be done while creating communication among the computerized systems. For safety purposes, sensors whose output will be entered into the computerized system will be added. The sensors will provide a signal on the obstacles and dangers involved in movement, and the system would act according to the logic that had been set and would cause the system to slow down and or stop depending on need. When the arms 20/177 with the wheels 18/177, and the surface 10/177 with the wheels 16/177 are “robotically” the entire system would be able to integrate them in the slowing down process, or the slowing down up to stopping, and this way, it would stabilize the system, and prevent the disabled person from falling down after identifying an obstacle. This is related to Drawings 178 and 179.

FIG. 178 is a schematic drawing of the system which is shown as the possibility of standing or riding by a disabled person who is skilled. It is typical for a disabled person who is skilled and trained that he/she does not need the support of arms 20/178, and does not need the slanted surface 10/178 when they are folded/entered to the position described in Drawing 178. The “Load cell” (force) will be described in the explanation of Drawing 179. In order to add safety for the disabled person who is skilled or while becoming skilled—it is possible to add ultra-sound sensors as an option, similar to the ones that are used in vehicles. In this case, the sensors would be turned forward, and with the addition of the possibility to turn backwards. Their output will be entered to the computerized system and would help in the management of slowing down and stopping, depending to the obstacle that would be identified.

FIG. 179 is a schematic drawing of the system 2/179, showing the possibility of standing or riding by the disabled person at the start of his/her training. It is typical for the disabled person to be trained on a leveled surface. The description relates to a leveled surface as an example. The two arms 20/179 are brought to a position that is close to the surface/floor so that the distance of the wheels 18/179 will be at the distance 30/179 of a few centimeters from (off) the floor. The slanted surface 10/179 is brought to a position in which the two wheels 16/179 will be at a distance 36/179 of a few centimeters from (off) the floor. It would be reasonable to assume that depending on the rider's skill, these distances will increase when the disabled person would be more skilled and can increase more tilting 31/179 and 33/179. As an option, it is possible in this case to dictate that the ultrasonic sensors would not be installed, or alternately, some of them or all of them would be installed. As an option, it is possible to install an optical device in the area between the wheels 18/179, similar to optical devices used in elevator doors, where the “Cutting Beam” provides signal that the door is not closed. In our case, the signal would indicate that there is an obstacle between the wheels, such as a large stone. For safety purposes, it is possible to include the sensors that had been mentioned above or other sensors that are used in the world of safety, such as sensors based on laser and/or others.

FIG. 180 is a schematic drawing of a partial top view of the grasping handle being stabilized 8/177 and the crossed arms that include springs. The upper arm 34/180 and the lower arm 38/178 are attached to the handle with bar 52/180. The other side of the crossed arms is attached to the disabled person's back support 38/179 at the connection points 42/180 and 44/180 This system is intended as an option to serve as a support system for disabled person at a height close to the pelvis. The crossed arms stabilize the disabled person within the range of forces shown in Drawing 181, which are force 10/181 and 12/181, as long as the disabled person does not activate low-level force with his/her hands. The stabilization is in the directions of 56/180 and 60/180. In fact, preventing the motions in the directions that had been mentioned, prevent the disabled person's body from turning in relation to the stabilized grasping handle 8/177. The activation of force with the hands when the force is greater than mentioned 10/181 and 12/181 would cause hand movements in the directions of 56/180 and 60/180. In fact, these motions would cause an angular turning of the disabled person around his/her feet 50/179 in Drawing 179. These turnings are the ones that would cause the system to move forward, backward, stop, rotation CW and rotation CCW.

FIG. 181 is a schematic diagram of a spring system known in mechanical engineering. The combination of springs and internal stoppers, for example inside a rod 34/177 according to the dictation of the first forces 10/181 and 12/181 and the spring curve 20/181 would show the procedure of forces as in drawing 181.

FIG. 182-FIG. 183C is a schematic drawing of Quadriplegic on Rogo-way

As an example, a system that is partially similar to Drawing 178. This system is mainly intended for riding by a quadriplegic (paralyzed in both arms and both legs) or for people with disabilities of a variety of degree. The command for riding forwards, backwards a in the direction of CW and CCW, which is achieved by turning the head in the desirable direction, is received by transmission to the control systems (also possible by a cable).

System 6/182A “Rogo-Way” is presented with a paraplegic 8/182A whose hands arms) 12/182A are locked with a hand (arm) locking system, which includes a locker 20/182A which locks the hands (arms) at an angle that is comfortable for the paraplegic to grasp the handles of the left hand (arm) 20/183A and the left hand (arm) 24/183A, as presented in Drawing 183A. The customary grasp of the quadriplegic is by being tied to the appropriate grasping location. The system has two control systems—the right one 30/183A, and the left one 34/183A, as shown in drawing 183A. These two systems include Linear Drives in the direction that is close to the horizontal Y 40/182A, and in the direction which is vertical to it Z 42/182A. The Helmet of the quadriplegic 32/182A is connected to a control system built inside a helmet 30/182A. Turning the head in different directions would initiate a standing position or riding forward, backward as well as rotation in the directions of CW and CCW depending on the turning 29/182A that would dictate (transmit) the motions to the handles.

The motions in the direction of Y would be equal on both sides, in a center position—sanding, in a forward position—riding, in a back position—moving backwards or stopping, depending on the speed of this motion. These motions of the handles cause the body to turn, and this turning initiates moving forward and backward, as shown in drawings 177-179.

FIG. 183A-FIG. 183C is a schematic drawing of the control systems causing the system to rotate 6/182A. The control system of the right hand (arm) 30/183A is in the direction of Z. The control system of the left hand (arm) 34/183A is in the direction of Z. The handles 20/183A and 24/183A are connected to it respectively.

Drawing 183A presents different heights of the handles—no rotation would take place.

Drawing 183B presents different height of the handles—the right hand (arm) is low 20/183B, and the handle 24/183B is high. In this position, there will be a rotation in the CW direction because the disabled is turning to the right.

Drawing 183C presents the same heights of the handles—the right hand (arm) 20/183C is high, and the handle 24/183C is low. In this position, there will be a rotation in the CCW direction because the disabled is turning left. Combining different positions of the handles (Y and Z) would provide combinations of forward/backward motion with combinations of CW/CCW rotations.

FIG. 184 is a schematic drawing of a riding system 10/184. This system is similar to the one shown in Drawing 178, but it is entirely different. This type of riding is important to the quadriplegics, but it can also be used by paraplegics or people with standing/walking disabilities as well as people that are not disabled. For example, the riding principle presented is based on a sensor that is built-in in a helmet with a sensor 16/184 (based on Gyroscope or others that are for vertical outputs). Turning the head in relation to the vertical constitutes the “Command” instruction as presented in drawing 182, but in this case, the commands are transmitted to the central computer 20/184. This method is mandatory for the quadriplegics. One of the qualities of this system is that it can function even without the signals that are caused by the contact of the shoes (or feet) in a system that does not require the turning of the entire body or part of it (in the helmet—the head only). The system presented in this FIG. 184 is used in this configuration or similar to it in a large number of robotic control systems or other systems, and therefore, I will only mention its components that are known in the control field. The two-direction arrows note commands and feedback between the units. Another way of attaching the sensor to the human body is by attaching it to the chest or lower, and then turning that part of the body initiates the riding. The role of the stabilizing computer 24/184 is to stabilize the handles rod 6/182A (in Drawing 182) in the direction of forward-backward in proximity to the vertical, the horizontal (in Drawing 182). Driver 30/184 activates the left wheel 34/184. Driver 40/184 activates the left wheel 44/184. The activations are the ones that stabilize the system and provide the assistance in riding for the disabled as well as for people that are not disabled.

A Number of Advantages for the Integration of Rogo-Way (on Two Wheels) as in the Principles Shown in Drawing 178, for the Disabled According to Drawings 33-35D. the Advantages are not Listed According to the Order of their Importance
1. The batteries attached to the walking device of the disabled do not consume an electrical current when the disabled is standing on the Rogo-Way, and therefore, the restriction to the riding range is to the distance/time of the Rogo-Way batteries and not to the batteries of the disabled.
2. Makes it possible to move fast from one place to another.
3. People suffering from spinal injuries, and those that cannot stand independently, need to be in a standing position of approximately one hour every day. The alternative provided by Rogo-Way saves/turns this task, which is considered to be a “punishment”, into a pleasant experience.
4. The body straightness required for using the Rogo-Way in turning the body (forwards, backwards, and to the sides) is the one that is achieved according to the explanation provided in this document.
5. A disabled who can maintain leg-body straightness would be able to ride with/without a pelvis support (FIG. 177, in 38/177 and 34/177). It is possible to keep the pelvis support to increase safety.
6. It can be used for all the disabled mentioned in Drawings 33-35D, including the quadriplegic.
7. It enables the disabled to have motion that does not include a wheelchair or another, while standing, and it does not disclose the fact that he/she is disabled.
8. The disabled skips a variety of psychological barriers and acquires self-confidence due to the fact that he/she is riding just as do other people, and he/she is doing so in a standing position.
9. In a building with an elevator, the disabled can go out to the street and back without requiring any help, and ride on the street going to any place, depending on the limitations of the Rogo-Way.
10. The disabled would be bale stop saying that “Everybody is looking down on me”.
11. It makes it possible to gain access to objects that are placed at a height at home and outside the home, grocery stores etc.
12. It minimizes dependency on other people.
13. The disabled can go out on trips in nature without causing any limitations to family members and friends that are due to his/her disability.
14. It makes it possible to move around fast at home, at the workplace etc.
15. The apartment should be designed to suit the disabled needs so that he/she would be able to use it and reach everything in the apartment, even if he/she is elevated by approximately 20 cm above the floor level. Example: the kitchen sink should be placed higher, and the upper part of the door (lintel) should be higher so that he/she would not be hurt.

### Features of the Invention

1. The first system for activating force on at least one first leg of the person during the stage of helping that leg for the purpose of walking as this first force is activated on about the lower part of the first leg. This first force is activated about in the direction intended for walking. The first rotation axis is the one in the pelvis area, whether it is the axis of the person himself at the pelvis or it is a mechanical axis connected to the person in proximity to the pelvis. When the extent of the second force is such that when the lower part of the first leg does not touch the ground, it is greater than the force required for the angular rotation of the first leg, and what is connected to it, around the first rotation axis, in the direction intended for walking for the purpose of taking at least one step. The system is such that it is impossible to have the first leg make a step due to the first force while half of the person's weight or a substantial part of his weight is transferred through the first leg to the ground. The step of the floating leg as the first leg will occur even when the person's leg is in contact with the ground and when the first force is greater than the sum of forces of the second force and the friction force of the lower part of the leg with the ground, which is the third force. When this condition of having the floating leg take a step, the stepping of the leg will take place in the direction that is close to the one of activating the first force.
0.2. According to claim 1, when the first leg straightening or close to straightening, from the area that is close to the pelvis up to the edge of the leg that is close to the ground, it helps the ability of the first leg to bear the person's weight.
0.3. According to claim 2, as the leg straightening makes it possible to walk under the following conditions as well: a dragging weak leg, a leg that all of its muscles or some of them cannot be activated, a “leg” that all of it or part of it is missing up to the pelvis, or two legs are missing, and are completed by an artificial leg, a “wooden leg” or similar in the quantity of one or two, depending on the case.
0.4. According to claim 1, for a person that at least one of his legs needs assistance in walking. In the transfer of the person's weight from one leg to the other, and when the condition of—the stepping of the floating leg—on the leg requiring the assistance, the stepping will be made possible.
0.5. According to claim 1, for a person who's both legs require assistance in walking in the transfer of the person's weight from one leg to the other, and when the condition of the stepping of the floating foot in the transfer from one leg to the other, the stepping will be achieved.
0.6. According to claim 3 regarding a person with both legs amputated up to his pelvis.
0.7. According to claim 1 that the transfer of weight from one leg to the other is assisted by the force activated by the hands on the auxiliary device for walking.
0.8. According to claim 1, that the force is activated by an element exerting force on the ground, wheel, chain etc.
0.9. According to claim 1 that the force is activated by an element that exerts direct force on the leg bottom or in proximity to it, such as a rigid or flexible cable in the direction of exerting the force on the leg bottom.
0.10. According to claim 1 that the force is exerted according to the logic and control that had been determined, with or without assisting sensors.
0.11. According to claim 1 that the force is exerted according to the logic and control that had been determined, with assisting sensors.
0.12. According to claim 1 that when there is no stepping, there is no consumption of electrical power for initiating the walking.
0.13. According to claim 1 the electrical moving system can be electrical, hydraulic or pneumatic, or a partial combination of them.
0.14. According to claim 1 the propulsion (moving) system is available as a modular option, and the moving module can be connected to a system that will help the disabled person walk, as a module rather than an integral part of the system that helps the disabled person. While the batteries are in the same device as an option.
0.15. According to claim 1 the system includes a component for the potential energy accumulation (a spring or otherwise) that is “recharged” by the disabled person (especially his arms), and is later on utilized as generating the power for walking.
0.16. According to claim 1 the disabled person's arms invest the potential energy when helped by a walker, crutches or the like, serving as the base for the element from which the force is exerted.
0.17. According to claim 1 the addition to the existing systems creates, jointly with these systems, comfortable walking for the disabled person.
0.18. According to claim 1 the coordination of both legs during walking can be independently achieved by the devices or as an option—in coordination of the devices with the help of an electrical cable or wireless communication of any known type.
0.19. According to claim 1 person's activity for walking, in the identification of logic with the help of sensors the conditions of “the stepping of the floating leg”, stepping will be achieved with the help of the control and drive.
0.20. According to claim 1 person's activity intended for walking, in the exertion of at least some of the power on the person's arms, with the help of his arms with the help of a walker or another assistive device, and when the condition of “stepping of the floating leg” stepping will be achieved.
0.21. According to claim 1 wheel or a “tank chain” or similar, with a spring system makes contact with the ground as well as when the leg is lifted off the ground.
0.22. According to claim 1 the wheel or a “tank chain” with a spring system causes the activation of force from the ground on the edge of the leg in the direction of walking.
0.23. According to claim 1 the “tank chain” with a spring system causes the activation of power from the ground to the lower edge of the leg.
0.24. According to claim 1 the spring system exerts force on the edge of the leg—force that is significantly lower than the half the weight of the person, and when the person is with some of his weight on that leg, the spring the lower edge of the leg surrenders and contact is established with the ground.
0.25. According to claim 1 person can use a walker, as part of the exertion of forces force for the purpose of stepping.
0.26. According to claim 1 the person uses crutch/crutches as part of the exertion of forces for the purpose of stepping.
0.27. According to claim 1 the person can use one of the options of a walker, crutch/crutches or another person for the purpose of balancing himself.
0.28. According to claim 1 the person can use the options of a walker or crutch/crutches as assisting in the generation and activation of at least part of the first force.
0.29. According to claim 1 the person can use charging systems that make it possible to continue walking even when the batteries are completely depleted. This ability is mainly due to the low consumption of the system during walking.
0.30. According to claim 1 the person can use charging system which is electro-mechanical, and in which the person activates a rotational handle for the purpose of recharging.
0.31. According to claim 1 during standing or lying down, the electrical consumption of the system is negligible, almost zero, and there is an option to have it neutralized.
0.32. According to claim 1 RGO system according to drawings 119-124 provides support for the back in the forward and backward motion and it can enter additional motions that had been determined in advance.
0.33. According to claim 1 RGO system according to Drawings 119-124 that does not require adjustment between a close axis to the pelvis and leg. The system will operate without an adjustment for major differences in the person's height of 20 cm and greater.

As an option, after measuring the distance in standing and seating position the distance between the close axis to the pelvis and leg is fixed to prevent changing of the distance.
0.34. According to claim 1 the RGO system according to Drawings 125-138 which is detachable and enables the disabled person make the transition from lying down to standing up without requiring the help of others.

The RGO system according to Drawings 125-138 is detachable and it makes it easier for the disabled person to move from the position of lying down to standing up, even when he is with friends so that the only assistance he would need is to be seated. Later on, assistance to stand up will enable the disabled person reach his bed, and once he gets there—get into the position of lying down, as the reverse process of the one mentioned earlier.

When the disabled person is sitting down, it is possible to pull apart all of the RGO system parts at his own choice. This way, people that do not know him and are unaware of his disability would be unable to notice that he is disabled, since his body above the pelvis would seem normal.
0.35. A mechanical walker with drives that assist in walking through the activation of force on legs
0.36. A walker in which the two upper handles are two-axes drive systems—up-down Z and forward-backward Y. The systems are electrically activated with help of control drives and the customary motion-dictation enable extremely handicapped to walk
0.37. A walker suitable to a disabled person's and Quadropleg walking
0.38. A crutch/crutches which are a single physical unit. The upper part is activated by both arms leaning and activation, and on the lower part, there are two contact endings with the ground. Due to the nature of the system, during regular activity, one ending always touches the ground.
0.39. A short telescopic auxiliary device that is not a crutch the end of which is under the armpit and its other end is at a location that is substantially high above the ground, and when it goes through elongation and shortening positions, it helps the disabled person stand up and sit.
0.40. Crutches that are stopped skidding when one or both start skidding.
0.41. System that intended mainly in sitting—for the integrated motion of the foot rotationally and the motion of the leg part around the knee rotational axis. This integrated motion generates the activation of the leg, providing better results than the single motions (to muscles/joints).
0.42. A system intended to help disabled persons with a system including algorithms. The algorithms that will be carried out will be the ones that will cause the optimization of dictating the continuation of future practice.

1.-3. (canceled)

4. A system for helping a person to walk, comprising:
a calf support member and a coupler configured to couple said calf support member to a calf of a person; and
a propulsion device coupled to said calf support member.

5. The system according to claim 4, further comprising a sensing system that senses shift in weight from leg to leg of the person, said sensing system being in communication with said propulsion device via a control system which is configured to control operation of said propulsion device in response to information sensed by said sensing system.

6. The system according to claim 5, further comprising a movable element is coupled to said calf support member, and a biasing device in operative communication with said movable element, said biasing device configured to urge said movable element towards a ground surface which is below a leg of the person.

7. The system according to claim 6, wherein said control system commands said propulsion device to cause said movable element with the leg to move in a walking direction when said sensing system senses a force between the leg and the ground surface is less than or equal to a predetermined amount.

8. The system according to claim 6, wherein said control system commands said propulsion device to cause said movable element with the leg not to move in a walking direction when said sensing system senses a force between the leg and the ground surface is greater than a predetermined amount.

9. The system according to claim 5, wherein said movable element comprises a wheel or tracks.

10. The system according to claim 6, wherein said biasing device is operative to help lift the leg above the ground surface.

11. A method for helping a person to walk, comprising connecting the system of claim 4 to a leg of a person and using the system of claim 1 to help the person walk.
